(19) United States
(12) Patent Application Publication
(10) Pub. No.: US 2024/0294759 A1
(43) Pub. Date: Sep. 5, 2024

(54) SILOXANE-BASED POLYMERIC MATERIALS FOR EFFICIENT REARRANGEMENT AND CURING REACTIONS AND WITH SPECIFIC DEGREE OF POLYMERIZATION

(71) Applicant: SILOXENE AG, Bruttisellen (CH)

(72) Inventors: Matthias KOEBEL, Bruttisellen (CH); Gabriel MCMANNIS PAGOTTI, Bruttisellen (CH); Silvia PAZ, Bruttisellen (CH); Lilli Corinn KURTEN, Zurichstrasse 38 (CH); Marek NEMEC, Bruttisellen (CH)

(21) Appl. No.: 18/571,110

(22) PCT Filed: Jun. 15, 2022
(86) PCT No.: PCT/EP2022/066408

§ 371 Date: Dec. 15, 2023

(30) Foreign Application Priority Data
Jun. 15, 2021 (WO) PCT/EP2021/066046

(51) Int. Cl. C08L 83/04; C08G 77/18; C08G 77/26; C08G 77/28; C08G 83/00; C08L 63/00; C08L 83/08; C09D 183/06; C09D 183/08; C09J 183/06; C09J 183/08

(52) U.S. Cl. CPC C08L 83/04; C08G 77/18; C08G 77/26; C08G 77/28; C08G 83/005; C08L 63/00; C08L 83/08; C09D 183/06; C09D 183/08; C09J 183/06; C09J 183/08

(57) ABSTRACT

The present invention pertains to a polymeric liquid polysiloxane material comprising non-organofunctional Q-type siloxane moieties and optionally mono-organofunctional T-type siloxane moieties, for efficient rearrangement and curing reactions. The present invention further pertains to associated uses of the material.

The present invention pertains to a polymeric liquid polysiloxane material comprising non-organofunctional Q-type siloxane moieties and optionally mono-organofunctional T-type siloxane moieties, for efficient rearrangement and curing reactions. The present invention further pertains to associated uses of the material.

In nanotechnology, organic/inorganic hybrid materials can be obtained through a rich variety of preparative techniques. Sol-gel based techniques for example operate in liquid solution, starting from a colloidal suspension of molecular or oligomeric precursors resulting in the spontaneous formation of nanoparticle building blocks. Sols are either prepared in situ from olation and condensation reactions of oligomeric polyhydroxymetallates or by hydrolysis of alkoxysilanes in water-alcohol mixtures. When a low degree of condensation is desired, only small amounts of water reactant are used which leads to branched siloxane compounds with low molecular weight. An example of such a preparation technique employing acid catalyzed hydrolysis in a neat system (solvent free) is described in EP 1510 520 A1. Generally, hydrolysis with such low amounts of water of monomeric alkoxysilane yields oligomers. Many of the single component compounds are commercial, for example, for the case of Q-type Tetraethoxysilane (TEOS) there exist ethylsilicate commercial oligomer mixtures with a silicate content of 40 or even up to 50%, commonly referred to as ethylsilicate 40, ethylsilicate 50 or also know by their brand names e.g. Dynasylan 40 or Dynasylan Silbond 50 (Evonik Industries).

Hyperbranched polyethoxysiloxanes (PEOS) are small molecular building blocks with typical molecular weights ranging from 500 to 50'000 Dalton, spanning a size range from several Angströms to single digit nanometers. The word hyperbranched also means that those compounds feature a significant fraction of linear species, although they also contain siloxane rings to different extents. Preferred synthetic routes are water-free or “non-hydrolytic” reaction conditions. This is why in general, the preparation of hyperbranched siloxane polymers is far more versatile and offers better control over the final reaction products than the above-mentioned hydrolytic routes because the condensation reactions can be controlled by stoichiometric addition of the reactants. Furthermore, the synthesis can be carried out “neat”, that means in absence of additional cosolvents such as alcohols. As a result of their highly dendritic structure, with a higher degree of polymerization in the center and a lower degree of the linear chain arms at their perimeter, PEOSs exhibit lower melt viscosities and a much greater solubility in themselves but also in other organic solvents than their linear chain siloxane analogues.

WO 2019/234062 A1 discloses a process for manufacturing a core-shell PEOS-core with an organofunctional silane shell material. WO 2019/234062 A1 describes the preparation of a hyperbranched ethylsilicate “core” by means of non-hydrolytic acetic anhydride condensation chemistry and then the grafting of a shell, made preferentially from a selection of organofunctional T-type trialkoxysilanes in a second temporally separated step to create a hybrid organofunctional core-shell molecular building block. Both steps are preferably carried out in the presence of a tetraalkoxytitanate rearrangement catalyst.

PCT/EP2020/075890 describes hyperbranched polyalkoxysiloxane materials comprising Q- and M-, D- and/or T-type functionality within the same macromolecule. WO2022/058059 discloses the manufacture of functionalized Q-T-siloxane-based polymeric materials with low siloxane ring content and specific degree of polymerization.

It is the objective of the present invention to provide polyalkoxysiloxane materials comprising Q- and optionally T-, M- and D-type functionality within the same macromolecule which allows for efficient rearrangement and curing chemistry.

In a first aspect, the present invention is directed to a polymeric liquid polysiloxane material comprising or consisting of:
(i) non-organofunctional Q-type siloxane moieties selected from the group consisting of:

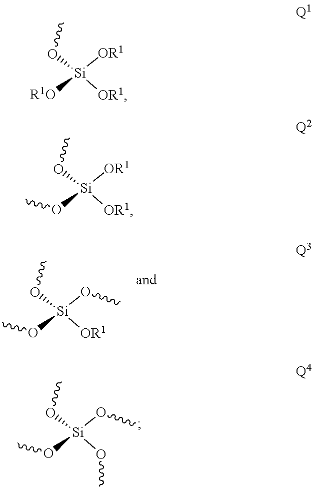

wherein
[symbol] indicates a covalent siloxane bond to a silicon atom of another siloxane moiety;
R¹ is selected from the group consisting of MC, methyl, ethyl and propyl, and R^{1′}
R^{1′} is selected from the group consisting of

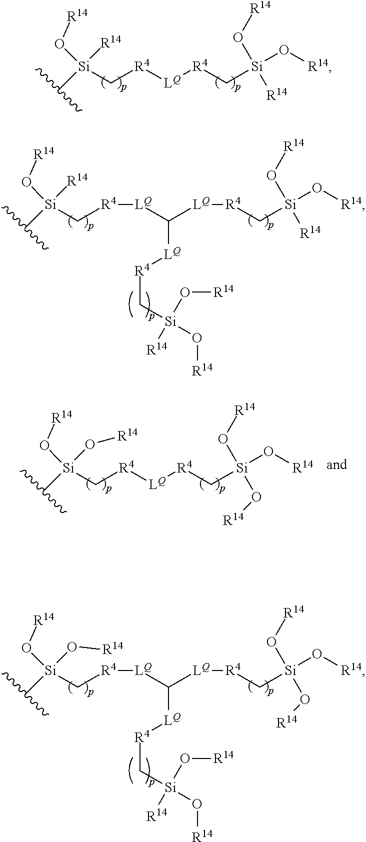

wherein p is an integer from 1 to 4;
R⁴ is absent, selected from a group defined for R^{4′} or

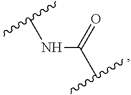 [SMILES: *NC(*)=O]

wherein the carbonyl is attached to the L^{Q} moiety,
R^{4′} is absent or selected from the group consisting of

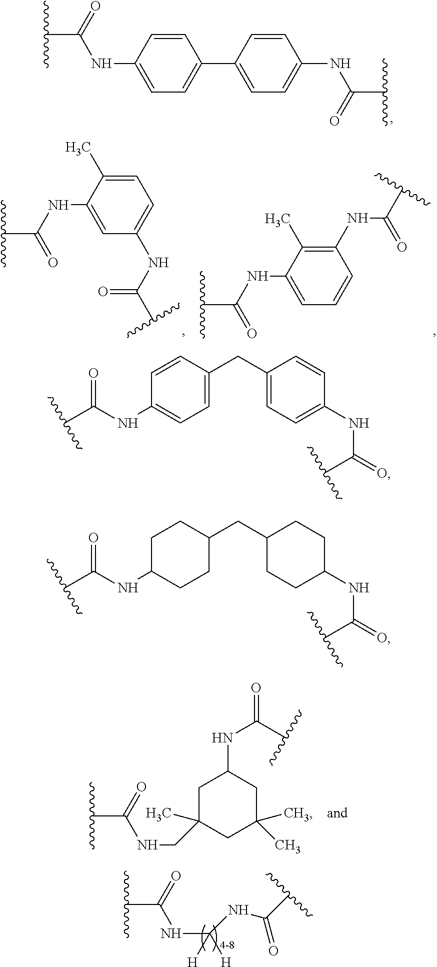

in monomeric, uretdione, biuret or tri-isocyanurate form;
R¹⁴ is methyl or ethyl, optionally propyl, or optionally a covalent bond to the silicon atom of another siloxane moiety;
L^{Q} is selected from the group consisting of

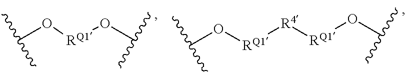

and L^{Q′}, optionally

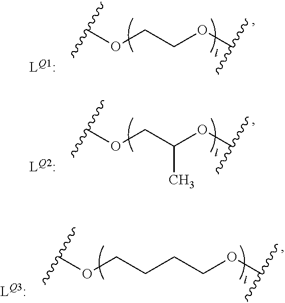

wherein I is an integer from 4 to 600;
R^{Q1′} is selected from the group consisting of polyols, optionally low molecular linear or branched polyols, polyether polyols, polyester polyols, acrylic polyols, polycarbonate polyols and natural oil based polyols;
L^{Q′} is selected from the group consisting of

-(L^{Q1})ₘ₁[(L^{Q1})ₘ₂-R^{4′}]ₘ₃-co-[(L^{Q2})ₘ₂-R^{4′}]ₘ₄-co-[(L^{Q3})ₘ₂-R^{4′}-]ₘ₅-(L^{Q1})ₘ₁-, and

-(L^{Q2})ₘ₁[(L^{Q1})ₘ₂-R^{4′}]ₘ₃-co-[(L^{Q2})ₘ₂-R^{4′}]ₘ₄-co-[(L^{Q3})ₘ₂-R^{4′}]ₘ₅-(L^{Q1})ₘ₁-,
wherein L^{Q′} is about or less than 40'000 g/mol, and
wherein m1 is an integer from 0 to 15, m2 is an integer from 3 to 200, and m3, m4 and m5 are each independently integers from 0 to 10, with the proviso that at least one of m3 to m5 is not 0;
MC is an alkali or earth alkali metal ion, optionally selected from the group consisting of Li, Na, K, Rb, Cs, Be, Mg, Ca, Sr, Ba, optionally Li, Na, K, Rb, optionally Li, Na, K;
   and wherein
the polysiloxane material comprises MC from 0.005 to 20 mol-% (mol MC/mol Si in the material), optionally 0.01 to 10 mol-%, 0.01 to 3 mol-%, 0.02 to 1.5 mol-%, 0.15 to 10 mol-% or 0.15 to 3 mol-%.
the material has a viscosity in the range of 2 to 100'000 cP, optionally about 5 bis 50'000 cP, optionally 5 to 2'000 cP;
the material comprises less than 5, 2.5, 2, 1.5, 1 or 0.5 mol-% silanol groups (Si—OH);
the degree of polymerization of the Q-type alkoxy-terminated moieties DP_{Q-type} is in the range of 1.3 to 2.7, optionally 1.5 to 2.7, 1.7 to 2.7 or 1.8 to 2.7;
   optionally further wherein
the polysiloxane material comprises less than 45, optionally less than 37, optionally less than 30 or less than 25 mol-% four-membered combined Q^{2r}-type and Q^{3s,d}-type siloxane ring species relative to the total Q-type siloxane species; and/or
the polysiloxane material comprises less than 70, optionally less than 63, optionally less than 56 or less than 50 mol-% four-membered combined Q^{3s,3d}-type siloxane ring species relative to all Q³-type siloxane species; and/or
the polysiloxane material comprises less than 4.5, optionally less than 4.0, optionally less than 3.5 or less than 3.0 mol-% double four-membered Q^{3d}-type siloxane ring species relative to the total Q-type siloxane species; and/or
the polysiloxane material comprises less than 25, optionally less than 20, optionally less than 17 or less than 14 mol-% double four-membered Q^{3d}-type siloxane ring species relative to all Q³-type siloxane species.

A covalent (siloxane) bond to a silicon atom of another siloxane moiety, as used herein, means a covalent siloxane bond to a silicon atom of another Q-, or optional M-, D- and/or T-type moiety as defined in (i) above, and in (ii), (iii) and/or (iv) below.

In the present invention, an amount of R¹ residues is MC that is alkali or earth alkali ions. The bonding topology of the Si—O group to R¹=MC is an ionic bond in the form of Si—O⁻ MC⁺ ion pairs. Specifically for the case where MC is a sodium alkali metal species, this corresponds to Si—O⁻ Na⁺ ion pairs (as observed for example in glasses or solid sodium silicate). The alkali or earth alkali metal MC component in the present invention can be added to the material of the present invention in the form of an inorganic base, e.g. a hydroxide. Alternatively, any salt of the alkali or earth alkali metal ions can be used as long as the salt is at least partially soluble in the material and leads to the Si—O—R¹ or more specifically the Si—O⁻ MC⁺ⁿ type of ion pair bonding.

The terminology of a double four membered siloxane ring species and Q^{2r}, Q^{3s}, as well as Q^{3d} is explained further below.

It will be apparent to the skilled person that the residues R^{1′} described herein are known in the art as silane terminated polymers (STP) or also referred to as silylated polyether or silyl terminated polyurethanes (SPUR).

In an embodiment, the polymeric liquid hyperbranched polysiloxane material of the present invention is one, wherein the polymeric liquid polysiloxane material described herein, further comprises
(ii) optionally tri-organofunctional M-type siloxane moieties selected from the group consisting

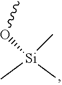

(iii) optionally di-organofunctional D-type siloxane moieties selected from the group consisting of:

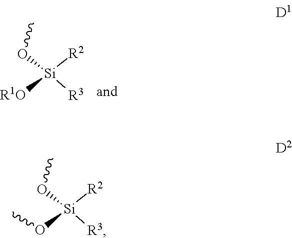

and
(iv) mono-organofunctional T-type siloxane moieties selected from the group consisting of:

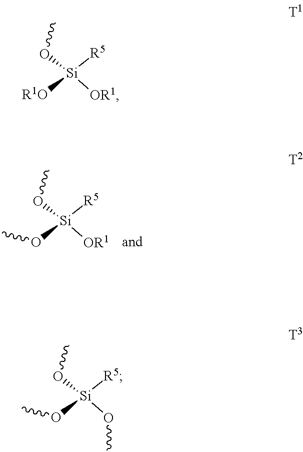

wherein
R² is selected from methyl, vinyl and phenyl;
R³ is selected from methyl, vinyl and phenyl;
R⁵ is selected from the group consisting of R^{5N}, R^{5U} and R^{5S},
   wherein
R^{5N} is selected from the group consisting of methyl, ethyl, n-propyl, isopropyl, n-butyl, t-butyl, linear, branched or cyclic C₅₋₁₆ alkyl residues, optionally linear or branched hexyl, octyl, optionally 2,4,4-trimethylpentyl, dodecyl, hexadecyl, (3,3,3-trifluoro)propyl, (1H,1H, 2H, 2H-perfluoro)octyl, cyclohexyl, cyclopentadienyl, cyclopentyl, (1H,1H, 2H, 2H-perfluoro)dodecyl and (1H,1H, 2H, 2H-perfluoro)hexadecyl;
R^{5U} is selected from -L-Z¹, -L-Z² and —Z³, wherein
   L is an aliphatic linker selected from the group consisting of —CH₂—, —CH₂CH₂—, —CH₂CH₂CH₂—, —C₆H4-, —C₆H4-CH₂—, and —CH₂—CH₂—C₆H₄—CH₂—;
   Z¹ is a moiety selected from the group consisting of —SH, —NH₂,

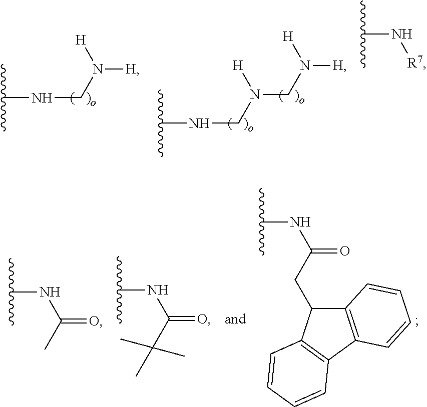

Z² is a moiety selected from the group consisting of

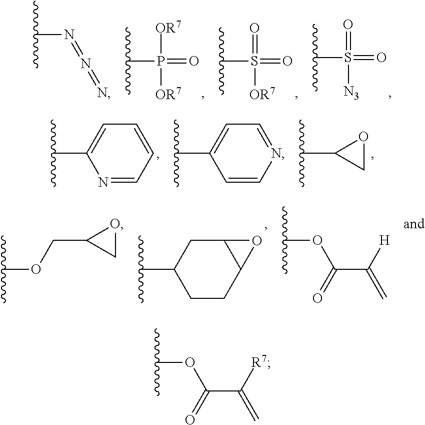

wherein
R⁷ is independently selected from the group consisting of methyl, ethyl, n-propyl and n-butyl and o is an integer from 1 to 3,
   and
Z³ is selected from vinyl, phenyl,

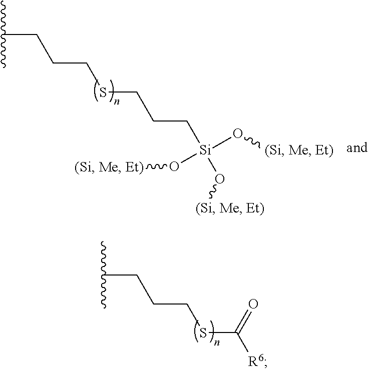

wherein
n is an integer selected from the group consisting of 1, 2, 3, 4 and 5, and
R⁶ is selected from the group consisting of methyl, ethyl, n-butyl, linear or branched C₅₋₁₄ alkyl residues, optionally —(CH₂)₅CH₃, —(CH₂)₆CH₃, —(CH₂)₇CH₃, —(CH₂)₈CH₃, —(CH₂)₉CH₃, —(CH₂)₁₁CH₃ and —(CH₂)₁₃CH₃;
R^{5S} is selected from the group consisting of -L′-Y¹, -L′-Y², and —Y³,
   wherein
   R⁸ is selected from the group consisting of —Cl, —Br, —I, —F, —CN, —SCN, —N₃, —NO₂, —OH, —SO₂OR⁷, and —O—C(═O)R¹²;
   R⁹ is selected from the group consisting of —Cl, —Br, —I, —F, —CN, —COOH, —COOR⁷, phenyl, o-, m-, and p-vinylphenyl;
   R^{9′} is selected from the group consisting of —COOH and —COOR⁷;
   L′ is an aliphatic linker selected from the group consisting of —CH₂—, —CH₂CH₂—, and —CH₂CH₂CH₂—; and
   Y¹ is a moiety selected from the group consisting of

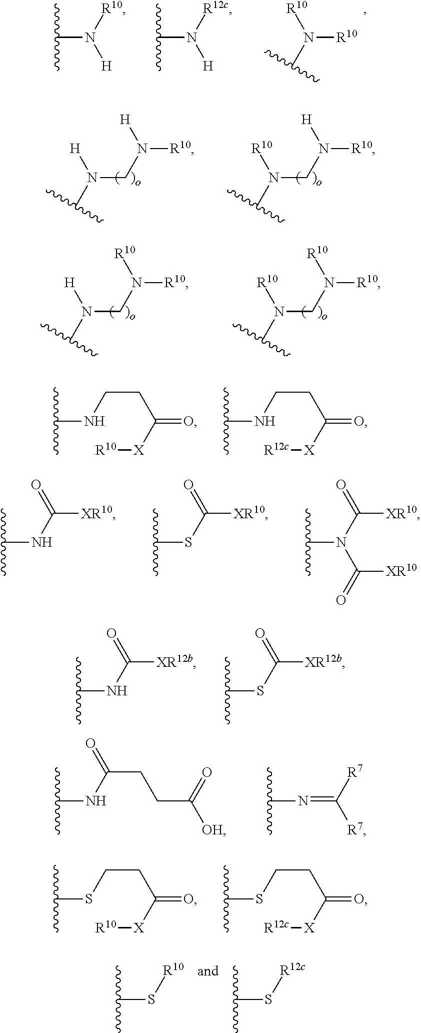

wherein o is an integer from 1 to 3;
X is absent, —(NH)— or —O—;
Y² is a moiety selected from the group consisting of

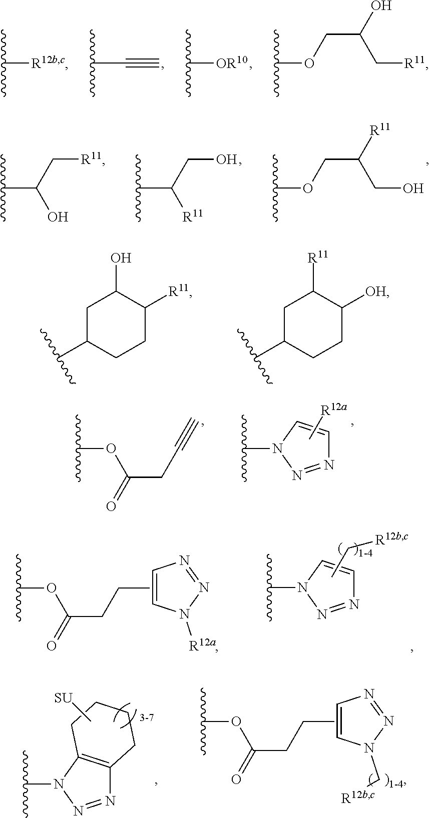

wherein SU indicates substituted or non-substituted;
Y³ is a moiety selected from the group consisting of

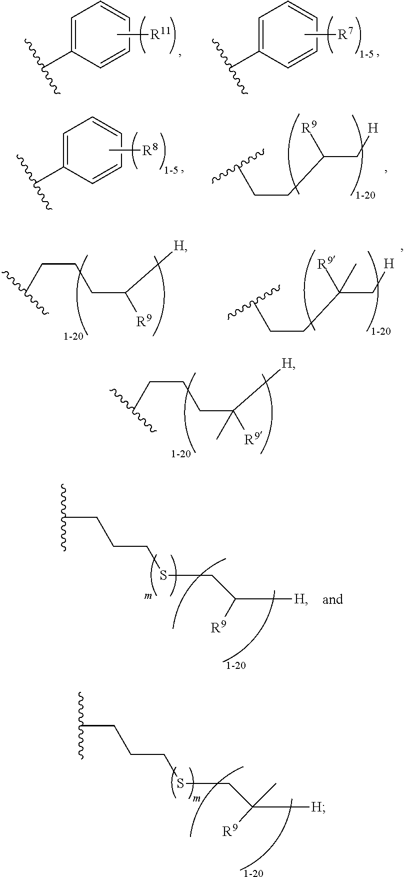

m is an integer selected from the group consisting of 1, 2, 3 and 4;
R¹⁰ is selected from the group consisting of R^{10a}, R^{10b}, R^{10c}, R^{10d}, R^{12a} and

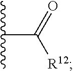

R^{10a} is selected from the group consisting of

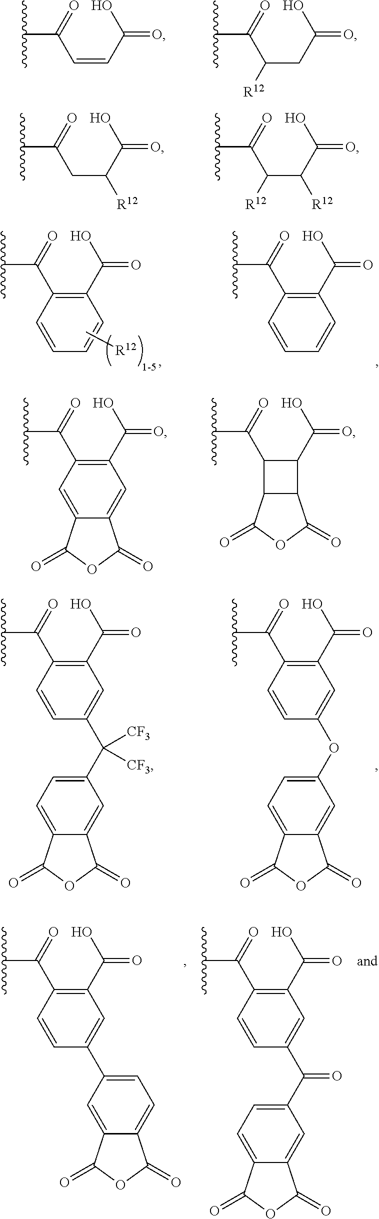

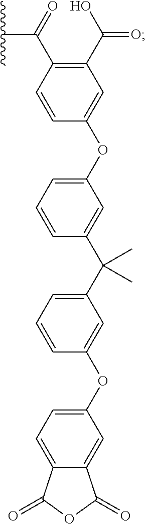 [SMILES: *C(=O)c1ccc(Oc2cccc(C(C)(C)c3cccc(Oc4ccc5c(c4)C(=O)OC5=O)c3)c2)cc1C(=O)O]

R^{10b} is selected from the group consisting of:

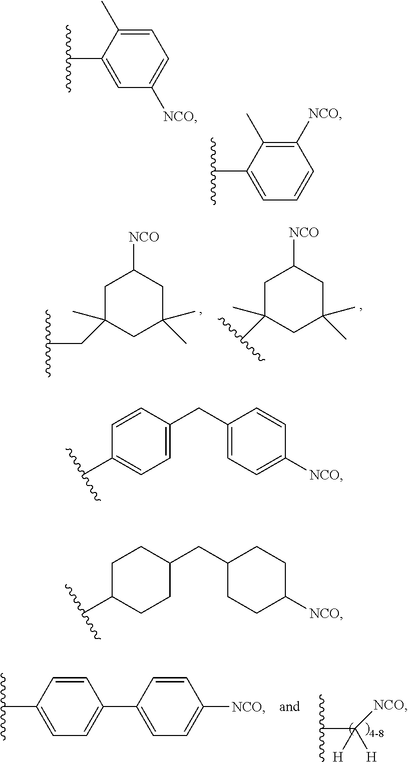

in monomeric, uretdione, biuret and triisocyanurate form;
R^{10c} is selected from the group consisting of:

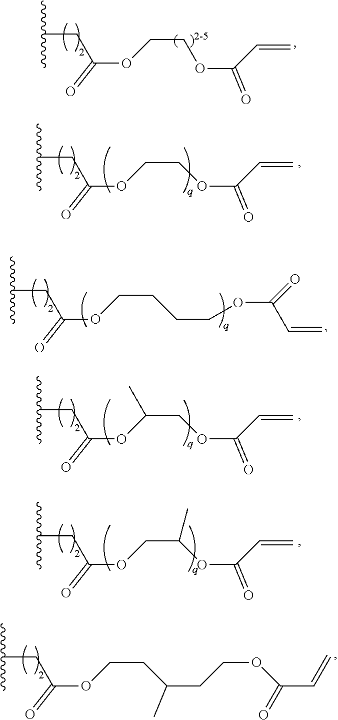

wherein q is an integer from 1 to 25,

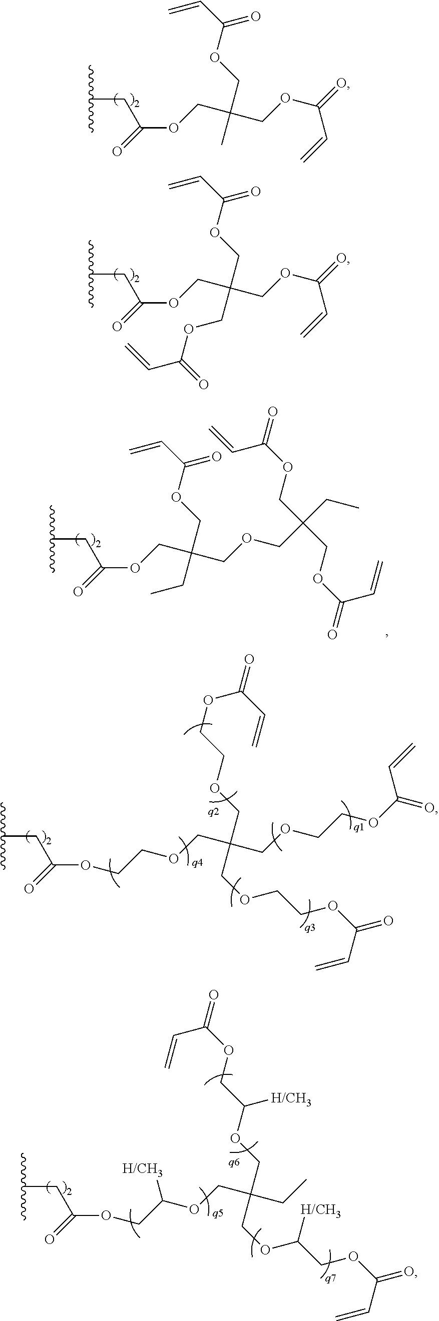

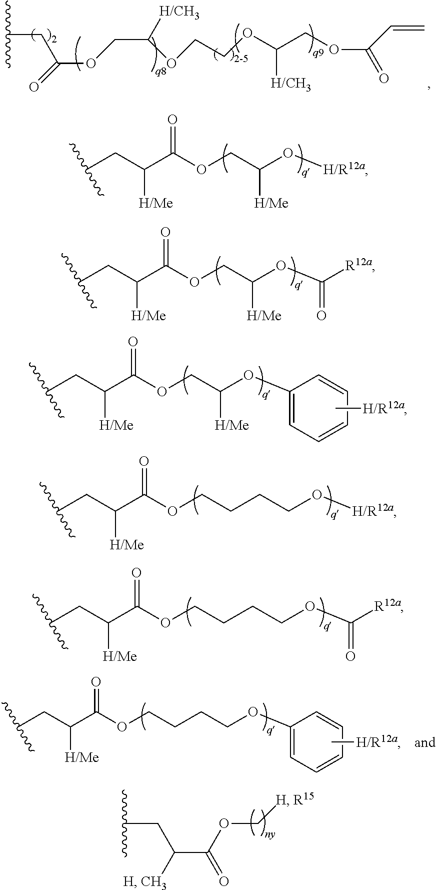

wherein ny is an integer from 0 to 4,
wherein q′ is an integer from 1 to 10, wherein each of q1 to q4 are integers from 0 to 8 and the sum of (q1+q2+q3+q4) is from 4 to 8, wherein each of q5 to q7 are integers from 0 to 24 and the sum of (q5+q6+q7) is from 3 to 24, wherein each of q8 and q9 are integers from 0 to 6 and the sum of (q8+q9) is from 2 to 6, and
wherein R¹⁵ is selected from the group consisting of

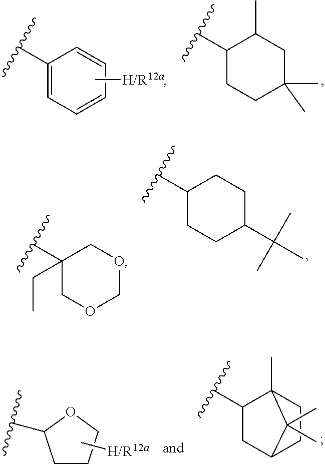

R^{10d} is selected from the group consisting of:

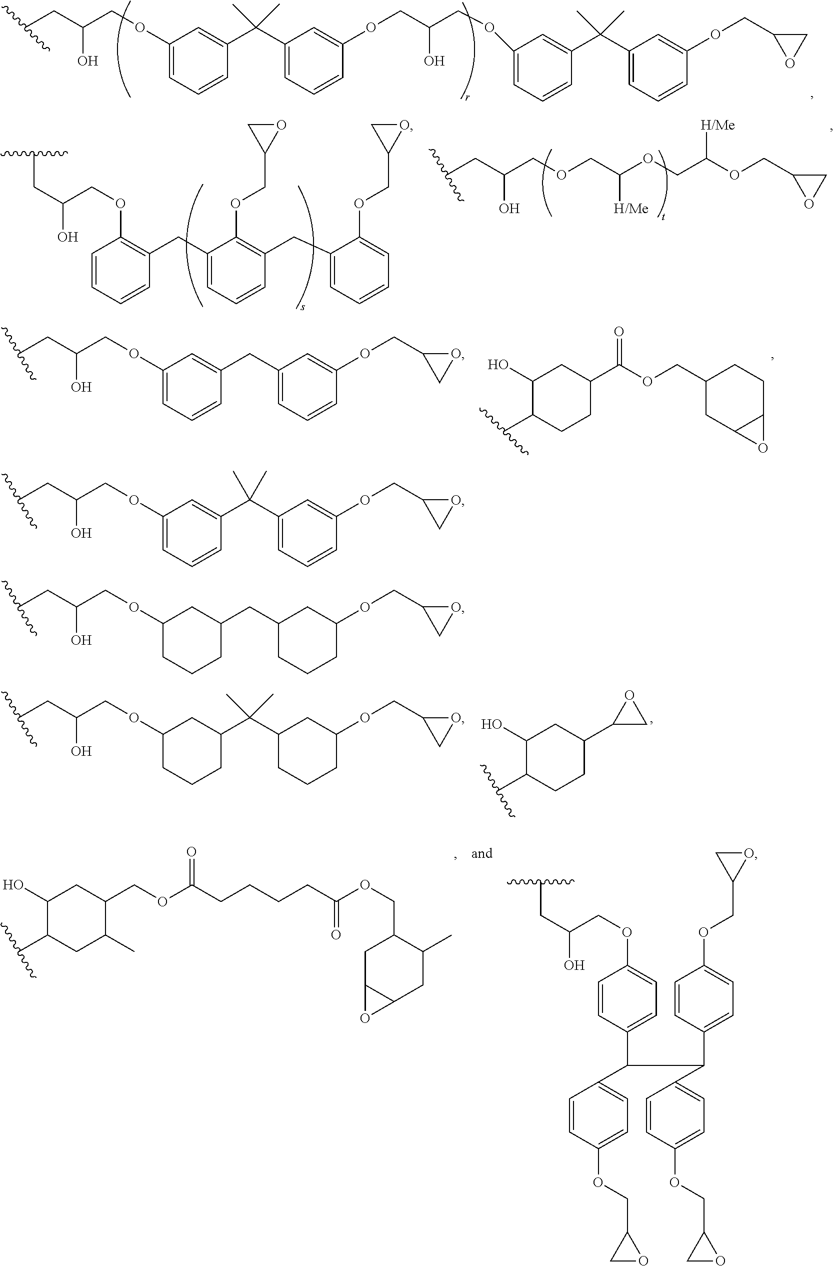

wherein r is an integer from 1 to 100, s is an integer from 1 to 15 and t is an integer from 1 to 10;
R¹¹ is selected from the group consisting of R⁸, —X—R⁷, R^{12c}, and for Y², R¹¹ is further selected from

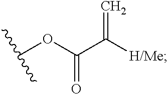

and
R¹² is selected from the group consisting of R^{12a}, R^{12b} and R^{12c}, wherein
R^{12a} is selected from the group consisting of linear or branched, substituted or non-substituted C₁₋₁₈ alkyl, C₂₋₁₈ alkenyl and C₂₋₁₈ alkynyl, and cyclic, substituted or non-substituted C₃₋₁₈ alkyl, C₅₋₁₈ alkenyl and C₈₋₁₈ alkynyl;
R^{12b} is selected from the group consisting of
   linear or branched, substituted or non-substituted alkyl ether, alkenyl ether, alkynyl ether up to a molecular weight of 5000 g/mol, and cyclic, substituted or non-substituted alkyl ether and alkenyl ether up to a molecular weight of 5000 g/mol, optionally substituted or unsubstituted poly(ethylene oxide), poly(propylene oxide) and polytetrahydrofuran;
   unsubstituted polydimethylsiloxane and polydivinylsiloxane; and
   poly- and oligosaccharides up to a molecular weight of 5000 g/mol, optionally poly D-glucose, Oligo-D-glucose, chitosan, deacetylated oligo-chitin, oligo-beta-D-galactopyranuronic acid, poly alginic acid, oligo-alginic acid, poly amylose, oligo amylose, poly-galactose, and oligo-galactose with a molecular weight up to 5000 g/mol; and
R^{12c} is selected from the group consisting of
   amino acids, oligo- and poly-peptides up to a molecular weight of 5000 g/mol; optionally oligo- and poly-peptides made of naturally occurring amino acids up to a molecular weight of 5000 g/mol; and
   C₁₂₋₂₄ fatty acids, optionally naturally occurring C₁₂₋₂₄ fatty acids, optionally naturally occurring unsaturated fatty acids, optionally C₁₂₋₂₄ naturally occurring unsaturated fatty acids with 1 to 3 double bonds, optionally epoxidized fatty acids, optionally epoxidized castor oil, soybean oil, sunflower oil, optionally ring opened epoxidized fatty acid based polyols, optionally natural oil based polyols (NOPs), optionally castor oil, soybean oil, or sunflower oil triglycerides.
      with the proviso that R^{5S} is not

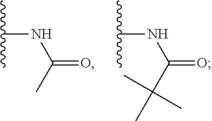

wherein
the degree of polymerization of the D-type alkoxy-terminated siloxane moieties DP_{D-type} is in the range of 1.0 to 1.9;
the degree of polymerization of the T-type alkoxy-terminated siloxane moieties DP_{T-type} is in the range of 1.1 to 2.7;
the degree of polymerization of the Q-type alkoxy-terminated siloxane moieties DP_{Q-type} is in the range of 1.1 to 2.7;
the total content of tri-organofunctional M-type siloxane moieties (ii) in the polysiloxane material does not exceed 20 mol-%, optionally does not exceed 10 mol-% optionally does not exceed 5 mol-%; and
the total content of di-organofunctional D-type siloxane moieties (iii) in the polysiloxane material does not exceed 5, 10, or 15 mol-%.

In an embodiment, the polymeric liquid hyperbranched polysiloxane material of the present invention is one, wherein when the sum of all R¹ residues in the material being MC and/or R^{1′} is ≥0.5 mol-% optionally ≥1 mol-% optionally ≥2 mol-%, the degree of polymerization of the Q-type alkoxy-terminated moieties DP_{Q-type} is in the range of 1.25 to 2.45.

For example, the polymeric liquid polysiloxane material described herein for all aspects can be of a core-shell structure, wherein the core is composed of a majority of Q-type moieties and has a different composition than the shell, which is composed primarily of T-type moieties, and optionally further comprises M- and D-type moieties. Herein, the core is also referred to as the “precursor (material)”. Alternatively, the polymeric liquid material can also comprise a “core-only” material, meaning that there is no shell and that Q- and T-type moieties are essentially randomly distributed within said core. The term “core-shell”, as used herein, is commonly understood in the art (see, e.g., Nanoscale, 2010, 2, 829-843 or Nanoscale, 2011, 3, 5120-5125). Concerning core-shell products, the interface between core and shell must be understood as a diffuse shell rather than a sharp boundary at which composition changes abruptly. This diffuse shell layer architecture, where the concentration of the functional shell species varies over a few bond lengths or Angströms, is a direct result of the condensation chemistry, that is, the grafting of a functional silane shell onto a preformed polysiloxane core. Because the outer arms of the dendritic polysiloxane core are highly permeable to smaller silane monomers and oligomers, it is clear that the extent of grafting of the shell is highest on the periphery but there is no sharp cutoff. Nevertheless, the term core-shell still applies as grafting in the center of the core is highly hindered for both, steric reasons and reduced availability of reactive alkoxy groups, because the average connectivity (number of bridging oxygen linkages (Si—O—Si bonds) per silicon center) in the center of the core is higher than at the core perimeter. Consequently, the term core-shell will be used in the context of polymeric liquid materials in the sense of a polysiloxane core with a diffuse shell as described herein.

If R⁵ comprises silane moieties, the resulting moieties are referred to as “bipodal silanes”.

For example, a typical material according to the present invention may also comprise Q-, T-, D- and/or M-type silane monomers (Q°, T°, D°, M°), e.g. in smaller molar quantities compared to the Qⁿ, Tⁿ, Dⁿ and Mⁿ, with n≥1, moieties, in other words, the total molar siloxane content must be higher than the total molar silane monomer content, excluding HMDSO which may be present in any amounts, also as a monomer, e.g. also as a solvent or co-solvent. Similarly, the material may optionally contain substantial fractions of smaller oligomers, for example a mixture of oligomers that spans a range from, e.g. dimer to pentamer polysiloxanes, optionally also featuring mixed Q-T and optionally Q-D bonding modes.

The material of the present invention comprises less than 5, 2.5, 2, 1.5, 1 or 0.5 mol-% silanol groups (Si—OH), this means that the OR¹ moieties of Q-, T- or D-type silanes are —OH groups to this extent.

It was surprisingly found that the material described herein can be efficiently used to for further grafting/rearrangement involving silanes and siloxanes and curing reactions of a variety of polymers and resins without the need for any rearrangement or active condensation reagents such as acetic anhydride or main group or transition metal salts or organometallic catalysts (e.g. organotin) or organic (e.g. aliphatic amine- or aminosilane-) bases.

Even in the absence of a rearrangement catalyst, silane-bearing compounds efficiently rearrange in the presence of a MC-containing Q-(T, D)-type precursor or core material in a nucleophilic substitution/condensation (“rearrangement”) reaction, essentially with significantly reduced reaction times and under milder reaction conditions compared to the use of typical, e.g. transition metal-based, rearrangement catalysts. The presence of R¹=MC also significantly accelerates the curing reactions of resins and binder chemistries which may or may not rely on moisture induced Si—O—Si siloxane condensation reactions and does so without negatively impacting storage stability and whilst imparting only minor caustic or corrosive properties and without the need for toxic organometallic (e.g. organotin) catalysts. Furthermore, MC-containing Q-(T, D)-type polysiloxanes also aid the formation of stable aqueous dispersions and emulsions without the need for surfactants and cosolvents. All these aspects are elaborated in more detail in the Examples below.

It was also found that the range of improved technical properties materialize within the disclosed and specific range of DP_{Qtype} or a minimum size/DP value of the “core” material. The combination of the MC in the material with the specific DP_{Qtype} values was surprisingly found to be synergistic for most cases, in particular for condensation reactions (see Examples below). The functional T-type moieties optionally grafted on or co-polymerized into the material give it additional organic functionality, however it is further surprising that the DP_{T-type} value in such cases is secondary in determining product properties. Rather, the stoichiometric ratio of Q-type non-organofunctional to T-type monoorganofunctional species and also MC concentration primarily determine the dendritic “macro”-crosslinking reactivity of these functional polymeric liquid materials in condensation reactions. The most effective MC amount within the indicated range of 0.005 to 20 mol-% can be determined by the skilled person, for example, empirically for each application or formulation in routine experiments to maximize its performance.

Regarding the effects of siloxane ring species, reference is made to the corresponding sections in WO2022/058059 (see, e.g. pages 13 to 16) which is incorporated by reference in its entirety.

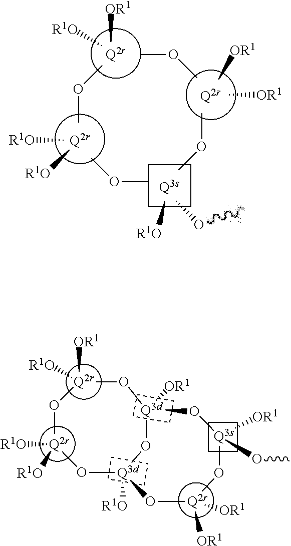

The term “four-membered” ring or polysiloxane ring or Q-type ring species as referred to herein always refers to an ensemble of all Q^{2r} and Q^{3s,d}-type moieties comprised in the material which are part of a four membered polysiloxane ring structure. Two representative examples of such typical configurations of moieties in single and double four-membered ring structures are shown in the above formulas. Q^{2r} ring moieties occur in both, “single” and “double” ring structures and comprise two siloxane bonds on each Q^{2r} which are both part of the ring structure and two alkoxy group (—OR¹) substituents. In the example on the left of a single four-membered siloxane ring, only Q^{2r} ring (circle) and “single ring” Q^{3s} (square) species are possible. In the second example of two connected four-membered siloxane rings (a bi-cyclic structure) shown on the right, in addition to Q^{2r} ring species (circle) and “single ring” Q^{3s} (square) species, also “double ring” Q^{3d}(rectangle, dashed line) moieties are possible, which are located at the bridge sites connecting the two rings. It is noted that in these Q^{3d} species, all siloxane bonds are part of the double ring network. Also, it is noted that the wiggly lines on the oxygen atoms connected to Q^{3s} moieties represent a siloxane bond to any other possible Qⁿ, Tⁿ, Dⁿ or Mⁿ moiety with n ≥=1. It must further be understood, that in the above examples for typical configurations, moieties are of Q-type but that these are only examples for assisting the skilled person's understanding but in reality there is no restriction to Q-type moieties. In fact it is within the scope of this disclosure and very much expected that in such four-membered polysiloxane ring structures also T-type and/or D-type moieties can be present.

Herein, Q² species in any four membered siloxane ring structures are termed “Q^{2r}” and “Q³” species in single ring structures and in double ring structures are termed “Q^{3s}” and “Q^{3d}”, respectively.

For quantification purposes, there are different indicators that can be used to define or constrict the above mentioned four membered polysiloxane ring species. A first indicator is to be defined as the total number of Q^{2r} and Q^{3s,d} ring species over the total Q species in the material:

$$\begin{matrix}\% ( {Q}^{2 r} \& {Q}^{3 s , d} ) ring species = 100 \cdot Σ ( {A}_{Q 2 r i n g s} + {A}_{Q 3 r i n g s} ) / Σ ( {A}_{Q n} ) \\ = 100 \cdot ( {A}_{Q 2 r} + {A}_{Q 3 s} + {A}_{Q 3 r} ) / ( {A}_{Q 0} + {A}_{Q 1} + {A}_{Q 2} + {A}_{Q 3} + {A}_{Q 4} ) ;\end{matrix}$$

A second indicator is to be defined as the total number of Q^{3s,d} ring species over all Q³ species in the material:

$$\begin{matrix}\% ( {Q}^{3 s , d} ) ring species within {Q}^{3} = 100 \cdot Σ ( {A}_{Q 3 r i n g s} ) / {A}_{Q 3} \\ = 100 \cdot ( {A}_{Q 3 s} + {A}_{Q 3 d} ) / {A}_{Q 3} \\ = 100 ( 1 - ( {A}_{Q 31} / {A}_{Q 3} ) )\end{matrix}$$

A third indicator is to be defined as the total number of Q^{3d} ring species over the total Q species in the material:

$$\begin{matrix}\% ( {Q}^{3 d} ) ring species = 100 \cdot {A}_{Q 3 d} / Σ ( {A}_{Q n} ) \\ = 100 \cdot {A}_{Q 3 d} / ( {A}_{Q 0} + {A}_{Q 1} + {A}_{Q 2} + {A}_{Q 3} + {A}_{Q 4} ) ;\end{matrix}$$

A fourth indicator is to be defined as the total number of Q^{3d} ring species over all Q³ species in the material:

$$\% ( {Q}^{3 d} ) ring species within {Q}^{3} = 100 \cdot {A}_{Q 3 d} / {A}_{Q 3} ;$$

All mol-% numbers described herein—unless specifically mentioned otherwise—are defined by the sum of all D-, M- or T-type silicon atoms divided by the sum of all silicon atoms in the material, e.g. as measured by means of quantitative ²⁹Si-NMR. The variable A is the spectral peak area as defined further below.

The mol-% of four-membered Q²-type and/or Q³-type siloxane ring species relative to the total Q-type siloxane species can be determined by ²⁹Si-NMR analysis, as explained in detail in WO2022/058059 (see, e.g. FIGS. 3 and 4 and the Examples) which is incorporated by reference in its entirety. The polysiloxane material described herein may comprise less than the stated mol-% four-membered (Q^{2r} & Q^{3s,d}) and/or (Q^{2r}) and/or (Q^{3s} single) and/or (Q^{3d} double) ring species relative to the total Q-type siloxane species. This means that the material may either comprise less than the stated mol-% four-membered Q^{2r}-type siloxane ring species, less than the stated mol-% four-membered Q^{3s,d}-type siloxane ring species and/or less than the stated mol-% four-membered Q^{2r}-type and Q^{3s,d}-type siloxane ring species, cumulatively. For all embodiments described herein, the four-membered Q^{3s,d}-type siloxane ring species includes Q^{3s,d}-type siloxane species, wherein one Q^{3s,d}-type siloxane is part of one or two four-membered rings.

It was further surprisingly found that beyond the degree of polymerization DP_{Qtype}, the T- to Q-type atomic ratio in a Q-Type material comprising further T (D,M) moieties are also key factors to determine the observed reactivity and properties aside from MC content. If the DP_{Qtype} value is chosen to be small (for example below the values disclosed herein), the average “core” is rather limited in size and a large amount of T-type silane would be needed to obtain a surface coverage with T-type moieties large enough to truly impart significant R⁵ functionality emanating from said grafted T-type units to the material. As the DP_{Q-type} increases (for example above a value disclosed herein), the surface to volume ratio is rapidly decreased, which means that a lower amount of T type moieties (a lower T:Q type molar ratio) is needed to impart significant R⁵ functionality to the material. This argument holds over the entire range of DP_{Qtype} above a certain minimum limit for essentially all materials and the macromolecular or dendritic character of the material (or in other words the efficiency of use for the T-type functional moieties) keeps increasing as the core size increases. With increasing DP_{Qtype}, however, the material viscosity increases in a steep, strongly non-linear manner and may lead to gelation or a significant viscosity increase which at some point makes practical use difficult. As it turns out, the DP_{Qtype} minimal and maximal values also depend on the type of T-type silane moieties which are grafted onto its periphery and depending on their nature also affects the ideal range of application relevant properties. Furthermore it is contrary to ones expectations that the atomic or molar ratio of T- to Q species in the material primarily determines its surface functional properties, and only to a lesser extent the DP_{Ttype}, as the latter does not correlate at all with an amount of T-type moieties in relation to Q but rather represents the grafting “efficiency”.

If a material exhibits M-type moieties, this generally leads to an increase in DP_{Qtype}. Therefore, the limit of DP_{Qtype} in all materials disclosed herein is to be raised by 0.05 or optionally 0.1 DP units if the amount of M-type modification exceeds 5 mol-% or optionally 10 mol-%.

In an embodiment, the polymeric liquid hyperbranched polysiloxane material described herein is one, wherein
when at least 65 mol-%, 75 mol-% or 85 mol-% of all R⁵ residues of the T-type siloxane moieties in the polysiloxane material are R^{5N}, the degree of polymerization of the Q-type alkoxy-terminated moieties DP_{Q-type} is in the range of 1.65 to 2.35, and the atomic ratio of T- to Q-species in the material is in the range of 0.05:1 to 0.45:1;
when the sum of all -L-Z¹ and -L′-Y¹ residues amounts to at least 80 mol-% of all R⁵ residues of the T-type siloxane moieties in the polysiloxane material, the degree of polymerization of the Q-type alkoxy-terminated moieties DP_{Q-type} is in the range of 1.75 to 2.25, and the atomic ratio of T- to Q-species in the material is in the range of 0.02:1 to 0.3:1;
when the sum of all Z³ and Y³ and/or the sum of all -L-Z² and -L′-Y² amounts to at least 50 mol-% of all R⁵ residues of the T-type siloxane moieties in the polysiloxane material, and the material optionally further comprises R⁵ residues being -L-Z¹, optionally the sum of R⁵ residues being -L′-Y¹ and -L-Z¹ being less than 20 mol-%, the degree of polymerization of the Q-type alkoxy-terminated moieties DP_{Q-type} is in the range of 1.85 to 2.2, and the atomic ratio of T- to Q-species in the material is in the range of 0.02:1 to 0.3:1;
when the sum of all -L-Z¹, -L′-Y¹ and R^{5N} amounts to at least 90 mol-% of all R⁵ residues of the T-type siloxane moieties in the polysiloxane material, optionally at least 30 mol-% of the R⁵ residues of the material being -L-Z¹ and/or -L′-Y¹ and at least 10 mol-% of the R⁵ residues of the material being R^{5N}, the degree of polymerization of the Q-type alkoxy-terminated moieties DP_{Q-type} is in the range of 1.8 to 2.4, and the atomic ratio of T- to Q-species in the material is in the range of 0.05:1 to 0.4:1; and
when the sum of all R^{5N}, Z³, Y³, -L′-Y² and -L-Z² amounts to at least 90 mol-% of all R⁵ residues of the T-type siloxane moieties in the polysiloxane material, optionally the sum of all Z³, Y³, -L′-Y² and -L-Z² amounts to at least 20 mol-% of the R⁵ residues of the material, optionally at least 20 mol-% of the R⁵ residues of the material being R^{5N}, the degree of polymerization of the Q-type alkoxy-terminated moieties DP_{Q-type} is in the range of 1.7 to 2.25, and the atomic ratio of T- to Q-species in the material is in the range of 0.05:1 to 0.25:1.

The atomic ratio of T- to Q-species in the material is the ratio between the silicon atoms of all T-type species (T⁰, T¹, T² and T³) and the silicon atoms of all Q-type species (Q°, Q¹, Q², Q³ and Q⁴).

The polymeric liquid polysiloxane material described herein is optionally R^{5S}-functionalized, e.g. at least 1 mol-%, optionally at least 3 mol-%, optionally at least 5 mol-% optionally at least 7 mol-% of the sum of all R^{5U} and R^{5S} moieties in the material are R^{5S} moieties, wherein R^{5S} is considered a functionalized moiety. The R^{5S}-functionalization may be introduced into the polysiloxane material by either selecting T-type silane or siloxane moieties which are already R^{5S}-functionalized (i.e. are pre-R^{5S}-functionalized T⁰ or T-type oligomer precursors used for rearrangement grafting) for the manufacture of the polysiloxane material, i.e. T-type monomer or oligomer compounds which comprise R^{5S} moieties, e.g. to the extent as defined herein, or alternatively to a lesser extent, i.e. less than 1 mol-%. If the T-type siloxane or silane moieties in a material otherwise corresponding to that disclosed herein comprise no or less than 1 mol-% R^{5S} (relative to the total mol number the sum of all R^{5U} and R^{5S} T-type substituents), the T-type siloxane moieties can be R^{5S}-functionalized either by functionalizing R^{5U} on already grafted T-type siloxane moieties or by grafting further, pre-R^{5S}-functionalized T-type silanes or oligomers comprising R^{5S} moieties. The functionalization of R^{5U} moieties can be done by known chemical methods and is described in the context of the present method. It is noted that the R^{5S}-functionalization, as described herein, is a specific form of functionalization, whereas the general term “organofunctional silane or siloxane” refers to a silane/siloxane generally bearing an organic residue directly bound to the silicon atom.

Optionally for all aspects and embodiments described herein, 0 mol-% of all R⁵ moieties in the material are R^{5S} moieties.

In the context of R^{5U} being selected from -L-Z¹, it is understood that the following residues may have to be deprotected by standard chemical reaction if a functionalization thereof is desired:

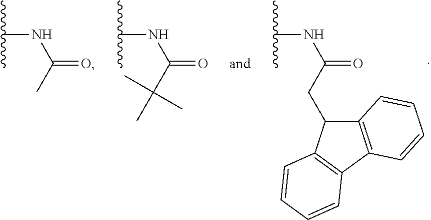

If R^{5U} moieties of grafted T-type siloxanes are functionalized, it is within the scope of the present invention that in cases where some reactivity or comparable reactivity or even no chemical selectivity difference between R^{5U} and R², R³, Z³ substituents can be expected, some, e.g. 5 to 95 mol-% or e.g. 25 to 90% of R², R³ and/or Z³ moieties relative to R^{5U} are functionalized if R², R³ and/or Z³ are selected from phenyl and vinyl. The functionalization of R², R³ and/or Z³ moieties may lead to the following exemplary chemical entities:

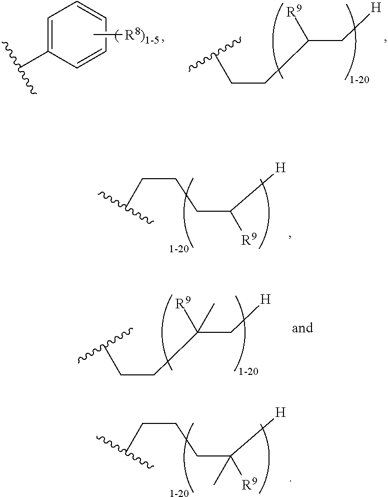

The functionalization of R², R³, Z³ and R⁵ can be identified and quantified by known spectroscopic means, e.g. by nuclear magnetic resonance spectroscopy, e.g. by ¹H-, ¹³C-, and optionally ¹⁵N or ³³S or ³¹P -NMR, optionally with isotope enrichment for analytical verification of these functionalization reactions. Specifically, during these types of organic reactions, e.g. addition or substitution or radical reactions, proton and carbon signatures experience a shift in their NMR response due to the change in electronic structure and structural environment and its resulting impact on the magnetic couplings. Typically, a signature from a proton or group of protons or carbon(s) will disappear when such an organic reaction takes place and a new peak appears further up or downfield in the spectrum depending on how the functionalization reaction impacted the magnetic couplings of these species in question. Thus, both the disappearance of the old chemical signature and the appearance of the new signature can be followed quantitatively with NMR spectroscopy. Quantitative reaction monitoring of organic reactions in this way is common general knowledge and does not need further description.

The term “in monomeric, uretdione, biuret or tri-isocyanurate form” means that the depicted chemical entities from which R^{10b} is chosen may be in their monomeric form, i.e. correspond to the entity depicted, in their uretdione form, i.e. in their dimerized form, in their biuret form, i.e. correspond to three or optionally up to five, of the depicted monomers coupled by the diamide formed from isocyanate functionalities, or in their tri-isocyanurate from, i.e. correspond to three of the depicted monomers coupled by a cyclic isocyanurate group formed from isocyanate functionalities.

Generally, the biuret form is as shown below:

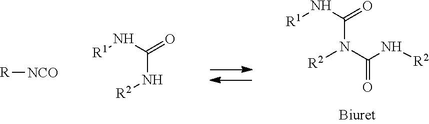

For example, the biuret form of the monomer

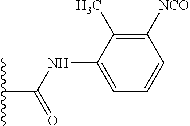

is

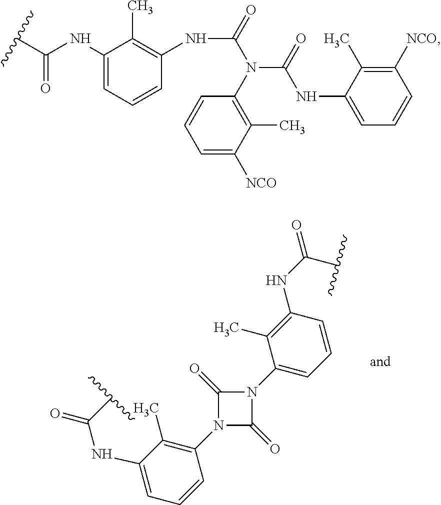

the uretdione form is

the corresponding tri-isocyanurate form is

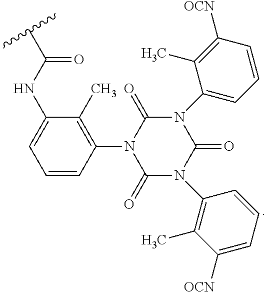

The same applies independent of whether the isocyanate-bearing entity is attached to the siloxane moiety via a —NC(═O)N—

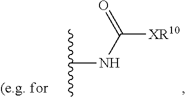

X=N and R¹⁰=R^{10b}), —NC(═O)O—

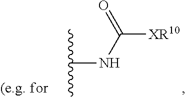

X=O and R¹⁰=R^{10b}), or —NC(═O)C—

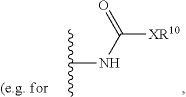

X=absent and R¹⁰=R^{10b}) bond or directly, e.g. via a N—C-bond (e.g. for

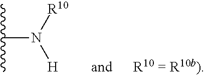

The term “non-substituted” as used herein shall mean substituted only with hydrogen. The term “substituted” as used herein, means that any one or more hydrogens on the designated atom or group is replaced, independently, with an atom different from hydrogen, optionally by a halogen, optionally by fluorine, chlorine, bromine, iodine, a thiol, a carboxyl, an acrylato, a cyano, a nitro, an alkyl (optionally C₁-C₁₀), aryl (optionally phenyl, benzyl or benzoyl), an alkoxy group, a sulfonyl group, by a tertiary or quaternary amine or by a selection from the indicated substituents, provided that the designated atom's normal valence is not exceeded, and that the substitution results in a stable compound, i.e., a compound that can be isolated and characterized using conventional means. Optionally, the substitution occurs on the beta position or the omega (opposite terminal hydrocarbon, if the R^{5S} substituent linkage is through the alpha position) of the hydrocarbon chain or optionally on the beta or gamma position of the hydrocarbon chain (next or next-next neighboring carbons from substituent attachment carbon). In the case of unsaturated hydrocarbons, the substitution occurs optionally on the beta or omega position of the hydrocarbon chain or optionally on the carbon being part of a double or triple bond or on its directly adjacent carbon.

In the context of the present invention it is understood that antecedent terms such as “linear, branched or cyclic”, “substituted or non-substituted” indicate that each one of the subsequent terms is to be interpreted as being modified by said antecedent term. For example, the scope of the term “linear, branched or cyclic, substituted or non-substituted alkyl, alkenyl, alkynyl, carbocycle” encompasses linear, branched or cyclic, substituted or non-substituted alkyl; linear, branched or cyclic, substituted or non-substituted alkenyl; linear, branched or cyclic, substituted or non-substituted alkynyl; linear, branched or cyclic, substituted or non-substituted alkylidene; and linear, branched or cyclic, substituted or non-substituted carbocycle. For example, the term “C₁₋₁₈ alkyl, C₂₋₁₈ alkenyl and C₂₋₁₈ alkynyl” indicates the group of compounds having 1 or 2 to 18 carbons and alkyl, alkenyl or alkynyl functionality.

The expression “alkyl” refers to a saturated, straight-chain or branched hydrocarbon group that contains the number of carbon items indicated, e.g. linear, branched or cyclic “(C₁₋₁₈)alkyl” denotes a hydrocarbon residue containing from 1 to 18 carbon atoms, e.g. a methyl, ethyl, propyl, iso-propyl, n-butyl, iso-butyl, sec-butyl, tert-butyl, n-pentyl, iso-pentyl, n-hexyl, 2,2-dimethylbutyl, cyclopropane, cyclobutane, cyclopentane, cyclohexane, cycloheptane, cyclooctane, cyclononane, cylcodecane, etc.

If an alkyl chain is characterized by a name that allows for linear or branched isomers, all linear or branched isomers are encompassed by that name. For example, “butyl” encompasses n-butyl, iso-butyl, sec-butyl and tert-butyl.

The expression “alkenyl” refers to an at least partially unsaturated, substituted or non-substituted straight-chain or branched hydrocarbon group that contains the number of carbon atoms indicated, e.g. “(C₂₋₁₈)alkenyl” denotes a hydrocarbon residue containing from 2 to 18 carbon atoms, for example an ethenyl (vinyl), propenyl (allyl), iso-propenyl, butenyl, iso-prenyl or hex-2-enyl group, or, for example, a hydrocarbon group comprising a methylene chain interrupted by one double bond as, for example, found in monounsaturated fatty acids or a hydrocarbon group comprising methylene-interrupted polyenes, e.g. hydrocarbon groups comprising two or more of the following structural unit —[CH═CH—CH₂]—, as, for example, found in polyunsaturated fatty acids.

The expression “alkynyl” refers to at least partially unsaturated, substituted or non-substituted straight-chain or branched hydrocarbon groups that may contain, e.g. from 2 to 18 carbon atoms, for example an ethinyl, propinyl, butinyl, acetylenyl, or propargyl group.

The expressions “alkyl ether” refers to a saturated or non-saturated, straight-chain or branched hydrocarbon group that contains the number of atoms that result in a molecular weight of up to 5000 g/mol. Alkyl ether groups as used herein, shall be understood to mean any linear or branched, substituted or non-substituted alkyl chain comprising an oxygen atom as an ether motif, i.e. an oxygen bound by two methylene groups. Exemplary alkyl ethers are polyethylene glycol (PEG), poly(propylene oxide) or poly-propylene glycol (PPG) and polytetrahydrofuran chains. The ether residue is attached to the formula provided in the present invention via the oxygen atom of the ether residue. Optionally, if the ether residue is substituted at a carbon atom with a nucleophilic substituent, e.g. an amine or a thiol, the ether residue can be attached to the Formula provided in the present invention via the nucleophilic substituent.

As used herein, a wording defining the limits of a range of length such as, e. g., “from 1 to 5” or “(C₁₋₅)” means any integer from 1 to 5, i.e. 1, 2, 3, 4 and 5. In other words, any range defined by two integers explicitly mentioned is meant to comprise and disclose any integer defining said limits and any integer comprised in said range.

As used herein, when referring to a polyol residue, the skilled person is aware that the attachment of, e.g., a linear diol to the polysiloxane material will effectively lead to said diol becoming a “mono-ol” residue because one of the alcohol functionalities forms the coupling bond. In other words, the term polyol as used herein also includes diol reactants that form a “mono-ol” residue once bound to the polysiloxane material. With multiple such groups being grafted onto a polymeric liquid polysiloxane material, still a multifunctional macro-polyol is obtained.

The scope of the present invention includes those analogs of the compounds as described above and in the claims that feature the exchange of one or more carbon-bonded hydrogens, optionally one or more aromatic carbon-bonded hydrogens, with halogen atoms such as F, Cl, or Br, optionally F.

If a residue or group described herein is characterized in having two further residues of the same name, e.g. in R^{10a} being

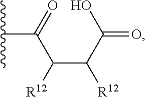

each of these further residues (in this example R¹²) can be independently selected from the definitions of this residue (in this example R¹²) given herein.

The skilled person is aware that any combination of residues or moieties, e.g. MC, R⁸, R⁹, R^{9′}, L′, Y, X, R¹⁰, R¹¹ and R¹², for forming R^{5S} must lead to a stable compound, i.e., a compound that can be isolated and characterized using conventional means. The skilled person can determine from his common general knowledge which compound, i.e. combination of the residues or moieties, e.g. R⁸, R⁹, R^{9′}, L′, Y, X, R¹⁰, R¹¹ and R¹², is not stable and specifically which linker chemistries are possible and do not interfere with other chemical functionalities in the polymeric liquid material. Any combination of moieties or residues, e.g. R⁸, R⁹, R^{9′}, L′, Y, X, R¹⁰, R¹¹ and R¹², that would result in a not stable compound is excluded from the scope of the present invention.

For example, poly- and oligosaccharides in the context of R^{12b} are connected to the respective moiety (e.g. to R⁸, Y, R¹⁰, or R¹¹) via an oxygen atom or optionally via a nitrogen atom (e.g. chitosan).

For example, amino acids, oligo- or polypeptides in the context of R^{12c} are connected to o the respective moiety (e.g. to R⁸, Y¹⁻³, R¹⁰, or R¹¹) via their amine or via the carbonyl carbon, or via a thiol (e.g. in the case of cysteine containing R^{12b})

Fatty acids in the context of R^{12c} are, for example, connected to o the respective moiety (e.g. to R⁸, Y¹-3, R¹⁰, or R¹¹) via a hydroxyl group (e.g. for castor oil) or via the carboxylic acid functionality or optionally for unsaturated fatty acids through the double bond group(s), e.g. via radical polymerization chemistry. Also, the fatty acids may be connected by ring opening reaction with an epoxide in the case of, e.g., epoxidized fatty acids or epoxidized fatty acid based polyols.

Triglycerides or polyols derived from fatty acids by epoxidation and ring opening with for example an alkali hydroxide base can also be connected via the hydroxyl functionality, either directly by means of ether linkages or esterification or optionally by secondary substitution e.g. by brominating or oxidation to the ketone and e.g. subsequent further substitution or optionally by reaction with isocyanate terminated R^{5S} groups.

In an embodiment, the polymeric liquid hyperbranched polysiloxane material of the present invention is one, wherein
R^{5N} is selected from the group consisting of methyl, ethyl, n-propyl, isopropyl, n-butyl, t-butyl, linear, branched or cyclic C₅₋₁₆ alkyl residues, optionally linear or branched hexyl, octyl, dodecyl, hexadecyl, (3,3,3-trifluoro)propyl, cyclohexyl, cyclopentadienyl, and cyclopentyl;
Z¹ is a moiety selected from the group consisting of —SH,

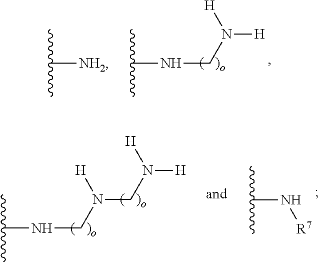

R⁸ is selected from the group consisting of —Cl, —Br, —I, —CN, —SCN, and —N₃;
Y¹ is selected from the group consisting of

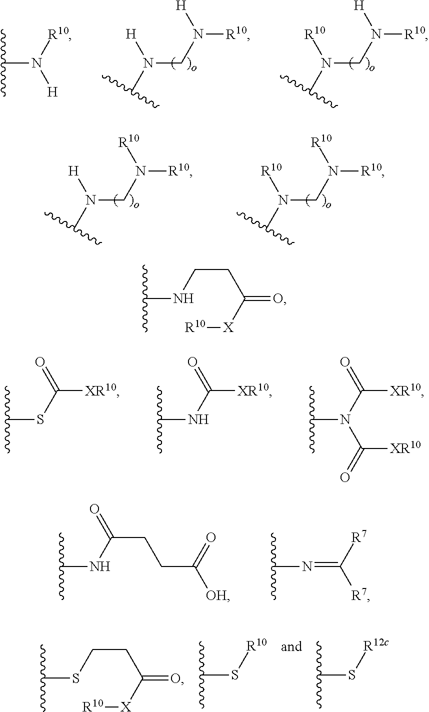

wherein o is an integer from 1 to 3;
Y² is a moiety selected from the group consisting of

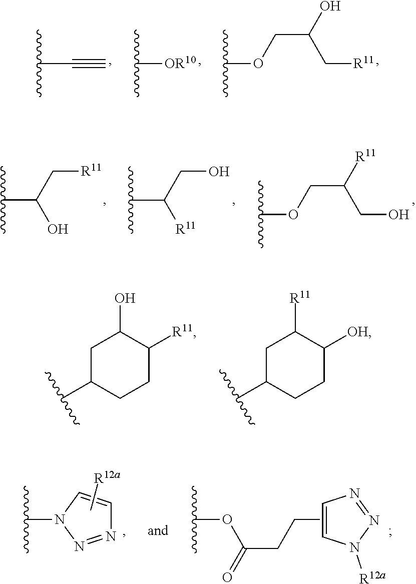

Y³ is a moiety selected from the group consisting of

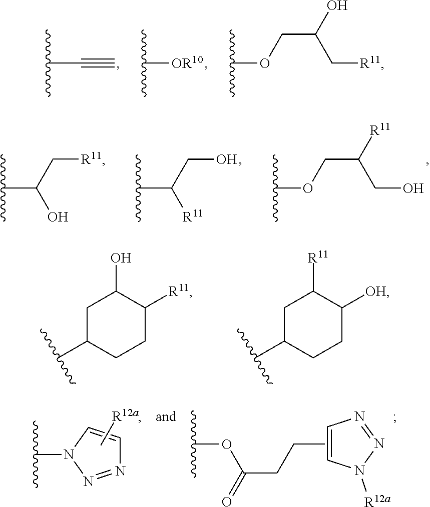

X is absent, —(NH)— or —O—;
R¹⁰ is selected from the group consisting of R^{10a}, R^{10b}, R^{10c}, R^{10d} and R^{12a};
R^{10a} is selected from the group consisting of

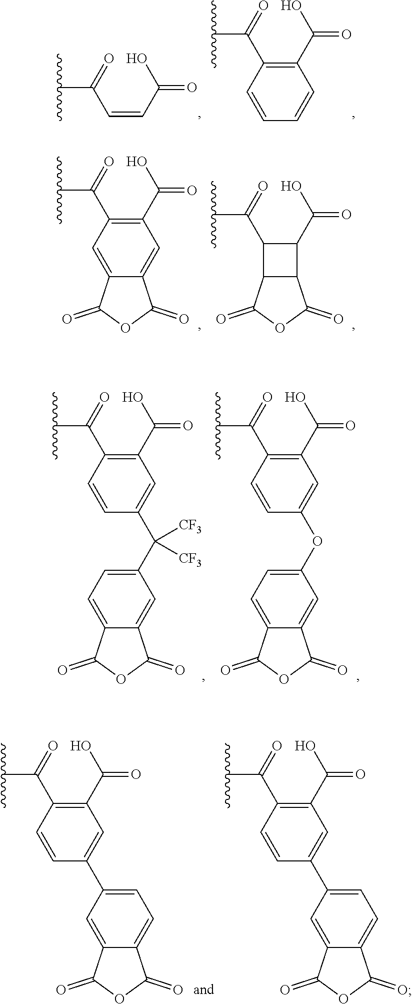

R^{10b} is selected from the group consisting of

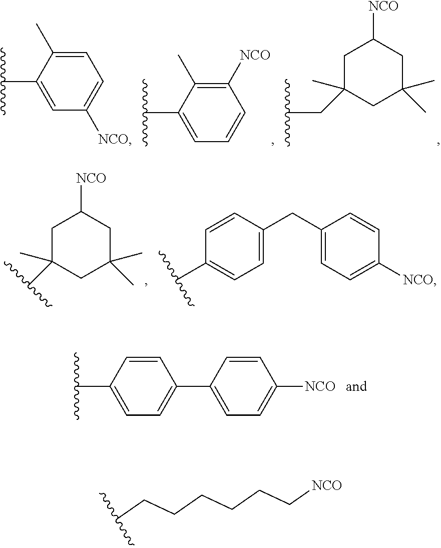

in monomeric, uretdione, biuret and triisocyanurate form;
R^{10c} is selected from the group consisting of

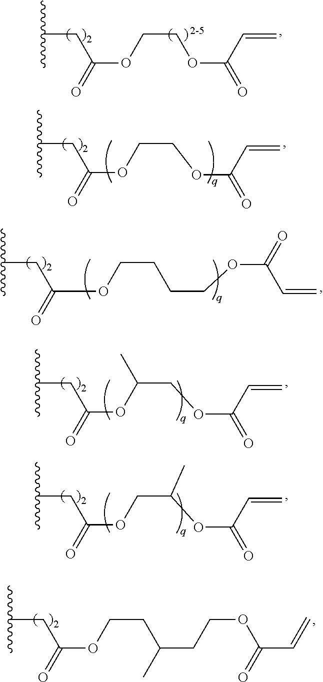

wherein q is an integer from 1 to 10,

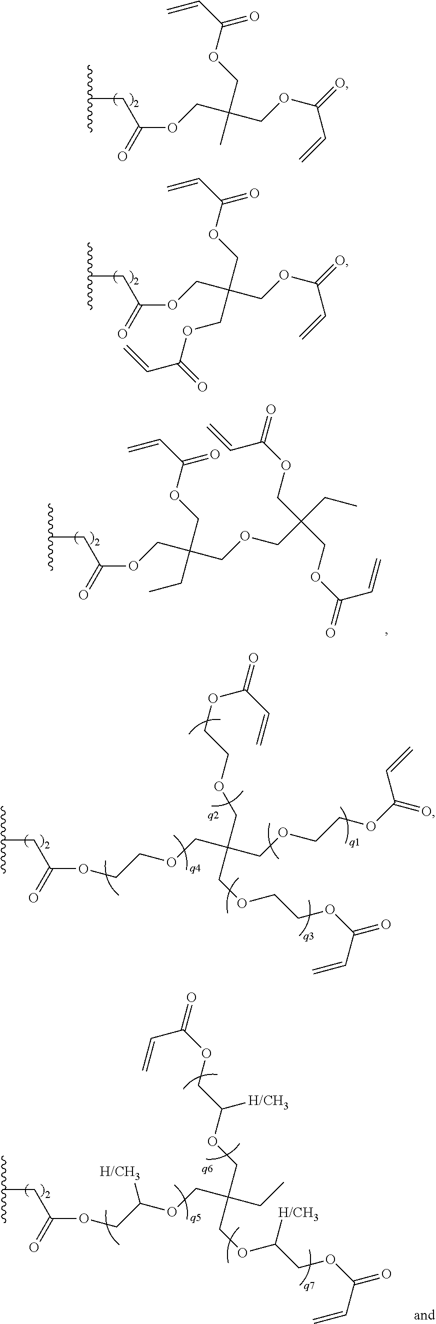

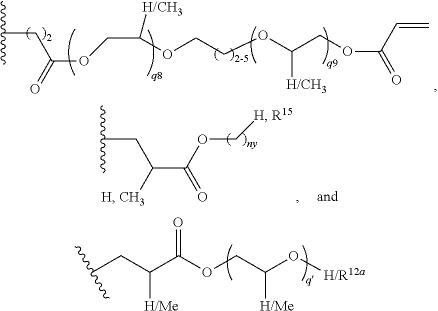

wherein ny is an integer from 0 to 4,
wherein q′ is as defined above,
wherein each of q1 to q4 are integers from 0 to 8 and the sum of (q1+q2+q3+q4) is from 4 to 8, wherein each of q5 to q7 are integers from 0 to 24 and the sum of (q5+q6+q7) is from 3 to 24, wherein each of q8 and q9 are integers from 0 to 6 and the sum of (q8+q9) is from 2 to 6 and
wherein R¹⁵ is selected from the group consisting of

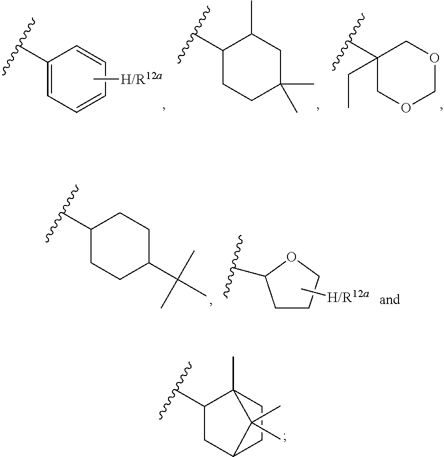

R^{10d} is selected from the group consisting of

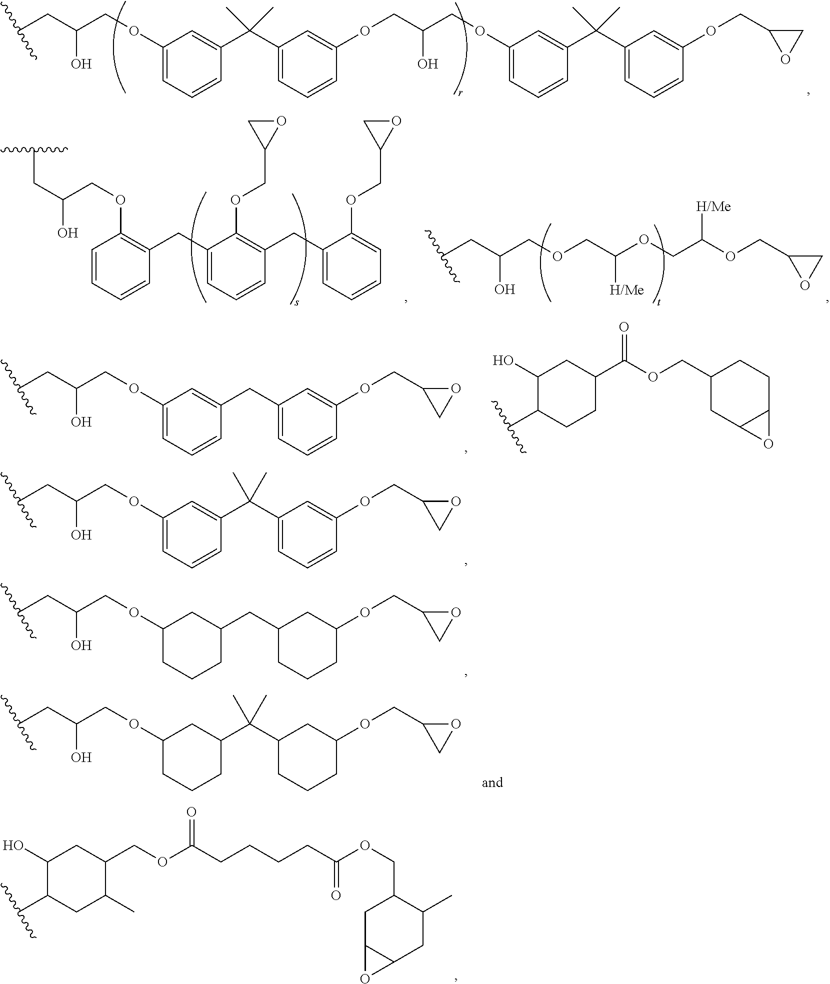

wherein r is an integer from 1 to 25, s is an integer from 1 to 10 and t is an integer from 1 to 10;
R¹¹ is selected from R⁸ and optionally R^{12c}, and for Y², R¹¹ is further selected from

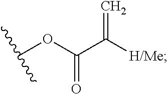

and
R¹² is selected from the group consisting of R^{12a}, R^{12b} and R^{12c}, wherein
   R^{12a} is selected from the group consisting of linear or branched, substituted or non-substituted C₁₋₁₈ alkyl and C₂₋₁₈ alkenyl;
   R^{12c} is selected from the group consisting of
      amino acids and oligo- or poly-peptides up to a molecular weight of 2000 g/mol; optionally oligo- and poly-peptides made of naturally occurring amino acids up to a molecular weight of 2000 g/mol; and
      C₁₂₋₂₄ fatty acids, optionally naturally occurring C₁₂₋₂₄ fatty acids, optionally naturally occurring unsaturated fatty acids, optionally C₁₂₋₂₄ naturally occurring unsaturated fatty acids with 1 to 3 double bonds, optionally epoxidized fatty acids, optionally epoxidized castor oil, soybean oil, sunflower oil, optionally ring opened epoxidized fatty acid based polyols, optionally natural oil based polyols (NOPs), optionally castor oil, soybean oil, or sunflower oil triglycerides.

In another embodiment, the polymeric liquid hyperbranched polysiloxane material according to the present invention is one, wherein
R¹ is selected from the group consisting of MC, methyl, ethyl, and propyl;
R^{5N} is selected from the group consisting of methyl, ethyl, n-propyl, isopropyl, n-butyl, t-butyl, linear, branched or cyclic C₅₋₁₆ alkyl residues, optionally linear or branched hexyl, octyl, dodecyl, and hexadecyl;
L is an aliphatic linker selected from the group consisting of —CH₂—, —CH₂CH₂—, —CH₂CH₂CH₂—, and —C₆H₄—;
Z¹ is a moiety selected from the group consisting of —SH,

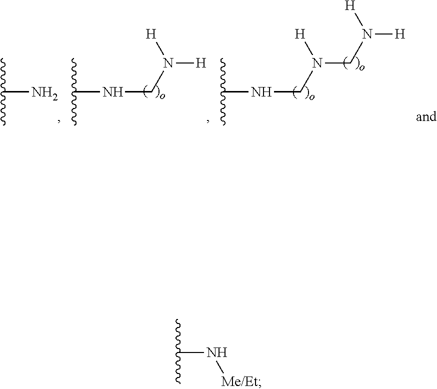

Z² is a moiety selected from the group consisting of

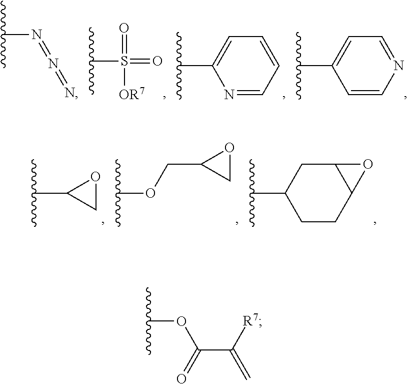

wherein R⁷ is independently selected from the group consisting of methyl, ethyl;
Z³ is selected from vinyl, phenyl;
R⁸ is selected from the group consisting of —Cl, —Br, —I, —CN, —N₃;
R⁹ is selected from the group consisting of —Cl, —CN, —COOH, —COOR⁷ and phenyl;
Y¹ is selected from the group consisting of

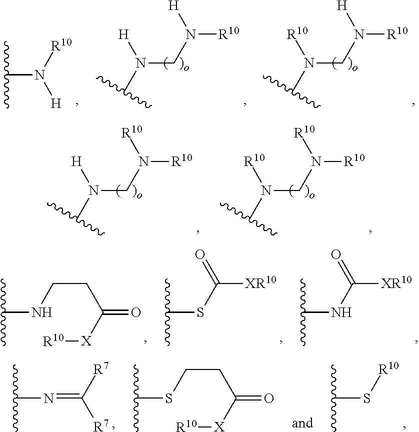

wherein o is an integer from 2 to 3;
Y² is a moiety selected from the group consisting of

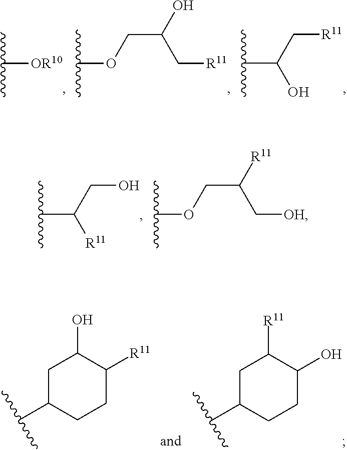

Y³ is a moiety selected from the group consisting of

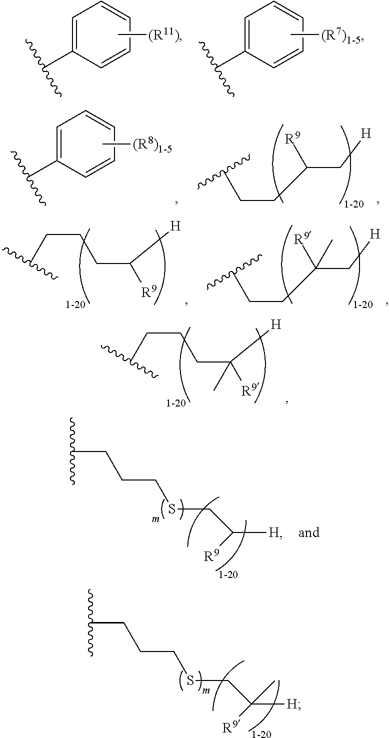

wherein
X is absent, —(NH)— or —O—;
R¹⁰ is selected from the group consisting of R^{10a}, R^{10b}, R^{10c}, and R^{10d};
R^{10a} is selected from the group consisting of

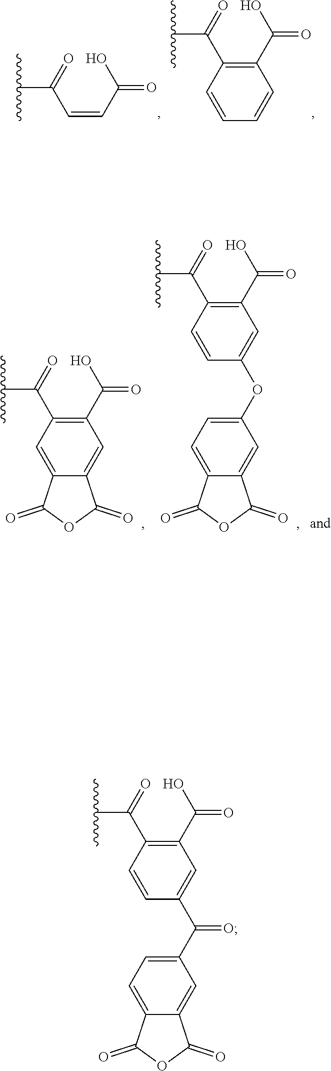

R^{10b} is selected from the group consisting of

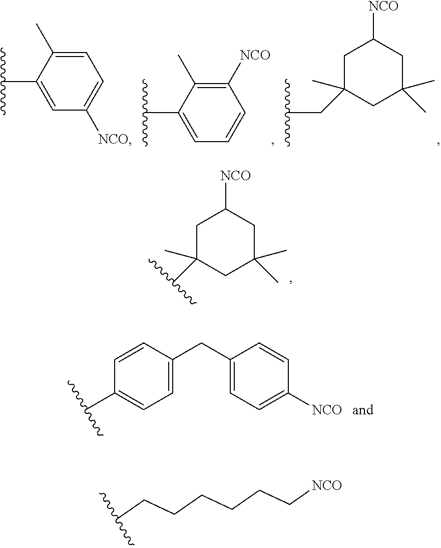

in monomeric, uretdione, biuret and triisocyanurate form;
R^{10c} is selected from the group consisting of

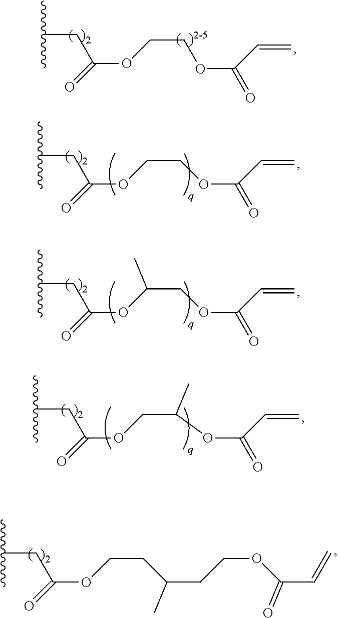

wherein q is an integer from 1 to 6,

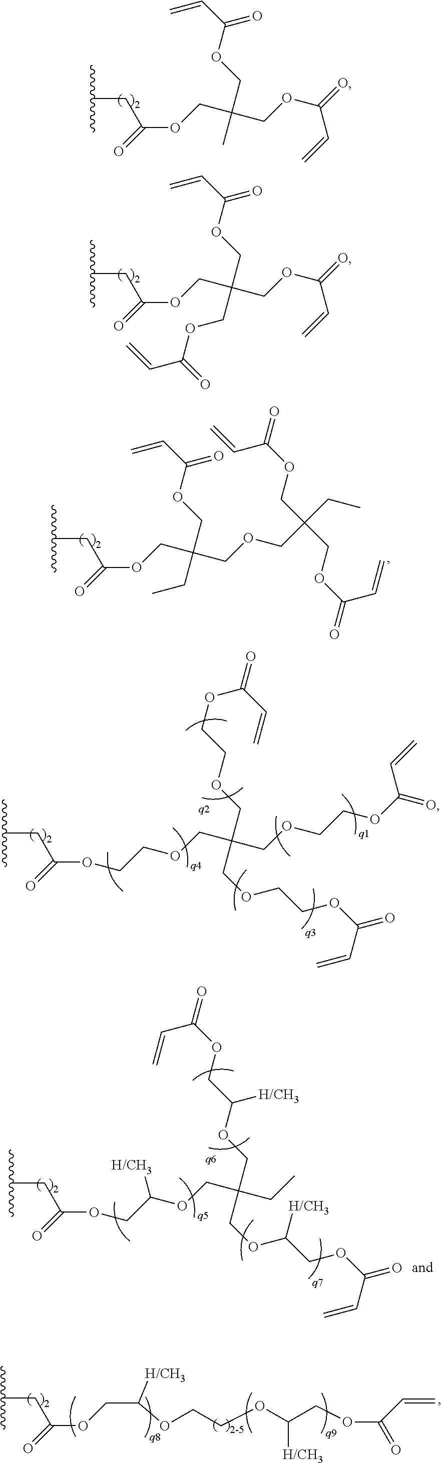

wherein each of q3 to q4 are integers from 0 to 8 and the sum of (q+q2+q3+q4) is from 4 to 8, wherein each of q5 to q7 are integers from 0 to 8 and the sum of (q5+q6+q7) is from 3 to 12, wherein each of q8 and q9 are integers from 0 to 4 and the sum of (q8+q9) is from 2 to 4; and
R^{10d} is selected from the group consisting of

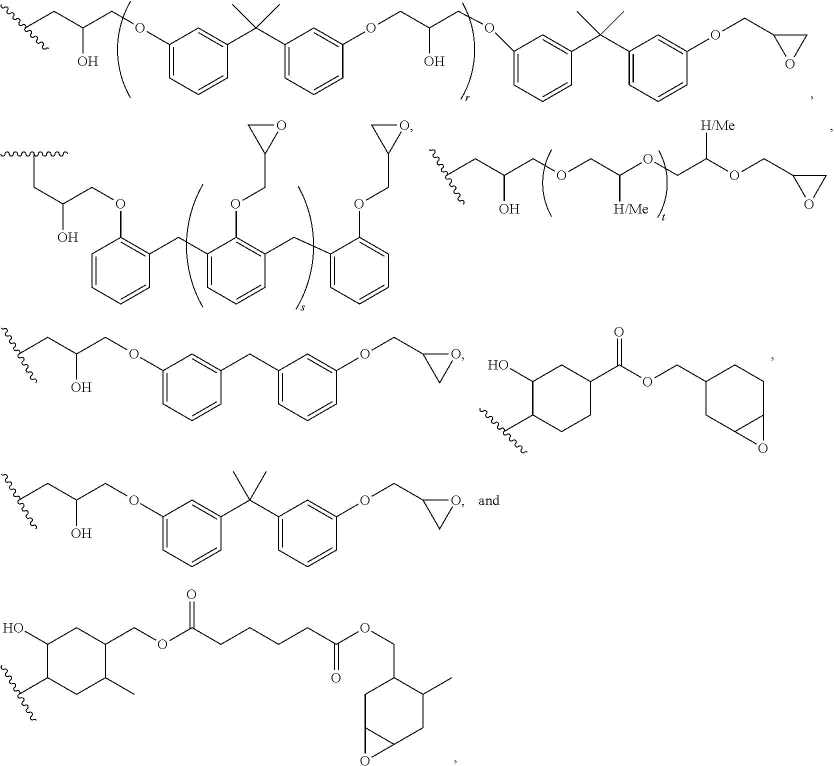

wherein r is an integer from 1 to 20, s is an integer from 1 to 8 and t is an integer from 1 to 10;
R¹¹ is selected from R⁸ and optionally R^{12c}, and for Y², R¹¹ is further selected from

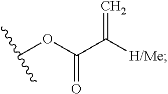

R^{12c} is selected from the group consisting of
   amino acids and oligo- or poly-peptides up to a molecular weight of 1000 g/mol; optionally oligo- and poly-peptides made of naturally occurring amino acids up to a molecular weight of 1000 g/mol; and
   C₁₂₋₂₄ fatty acids, optionally naturally occurring C₁₂₋₂₄ fatty acids, optionally naturally occurring unsaturated fatty acids, optionally C₁₂₋₂₄ naturally occurring unsaturated fatty acids with 1 to 3 double bonds, optionally epoxidized fatty acids, optionally epoxidized castor oil, soybean oil, sunflower oil, optionally ring opened epoxidized fatty acid based polyols, optionally natural oil based polyols (NOPs), optionally castor oil, soybean oil, or sunflower oil triglycerides.

In a further embodiment, the polymeric liquid hyperbranched polysiloxane material of the present invention is one, wherein the material comprises
(v) at least two non-identically R⁵-substituted mono-organofunctional T-type alkoxy-terminated siloxane populations, each population making up at least 3 mol-% of all mono-organofunctional T-type moieties in the material; and/or
(vi) chiral mono-organofunctional T¹-type moieties in an amount of at least 3 mol-% relative to all mono-organofunctional T-type moieties in the material.

The term “population”, as used herein, refers to a collection of moieties or a given organofunctional T-Type or D-type or, optionally M-Type moiety in the polymeric material. As an example, grafting or heterocondensation of two dissimilar T-type trialkoxysilanes such as vinyltrimethoxysilane and methyltriethoxysilane as two randomly chosen examples onto a Q-type polysiloxane precursor leads to two distinct populations (T⁰=unreacted monomer), T¹, T² and T³ bearing -methyl and -vinyl as organofunctional R⁵ substituents, respectively, which can be resolved in a ²⁹Si-NMR spectrum because of the R⁵ substituent effect on the respective T-type central Si atom.

The at least two non-identically R⁵-substituted mono-organofunctional T-type alkoxy-terminated siloxane populations described herein encompass any combination of R^{5N}, R^{5U} and R^{5S} for R⁵, optionally with the condition that at least 1 mol-%, optionally at least 3 mol-%, optionally at least 5 mol-% optionally at least 7 mol-% of the sum of all R^{5U} and R^{5S} moieties in the polymeric liquid hyperbranched polysiloxane material are R^{5S} moieties and optionally with the further condition that one of the conditions noted on the DP_{Q-type} is met.

The first condition (v) shall be understood in the sense that the material comprises at least two populations of mono-organofunctional (T-type) alkoxy terminated siloxane moieties (T¹, T², T³) which differ by their organofunctional substituent R⁵. This means that the material features at least two different R⁵ functionalities and that the minority species is present in a detectable amount (e.g. by ²⁹Si-NMR).

The second condition (vi) is met by a T¹-type grafted siloxane moiety having four different substituents on its silicon atom, namely one Si—O—Si bond, one Si—C bond linking to the R⁵ organofunctional group, and two different alkoxy substituents R¹, e.g. one ethoxy and one methoxy. This occurs already when only one population of R⁵-functionalized T-type species is present in the material. Generally, non-identical R¹ alkoxy-groups can ligand-exchange among Q-type and T-type moieties.

In another embodiment, the polymeric liquid hyperbranched polysiloxane material according to the present invention is one, wherein
(vii) the degree of polymerization of the Q-type alkoxy-terminated moieties DP_{Q-type} is in the range of 1.6 to 2.4 and the atomic ratio of T- to Q-species in the material is in the range of 0.02:1 to 0.4:1;
(viii) if the material comprises about or more than 5 mol-% M-type moieties, the degree of polymerization of the Q-type alkoxy-terminated moieties DP_{Q-type} is in the range of 1.7 to 2.5 and the atomic ratio of T- to Q-species in the material is in the range of 0.02:1 to 0.4:1;
(ix) the degree of polymerization of the D-type alkoxy-terminated siloxane moieties DP_{D-type} is in the range of 1.25 to 1.75; and/or
(x) the degree of polymerization of the T-type alkoxy-terminated siloxane moieties DP_{T-type} is in the range of 1.3 to 2.2.

The degree of polymerization DP for any non-crystalline silicon oxide material (for the polysiloxane material and for the corresponding methods and uses described herein) is defined here as the ratio of bridging oxygens BO (# of Si—O—Si bonds) to the total number of metal atoms Siₜₒₜ in the system.

The term “alkoxy-terminated” for the Q-, T- and D-type siloxane moieties is understood to refer to the residual substituents of said moieties which are essentially alkoxy groups, because the polymeric liquid material is derived from alkoxy (ethoxy/methoxy) containing silane precursors in monomeric or oligomeric form. This implies that for a Q⁰ monomer and Q¹, Q², Q³ and Q⁴ moiety, said “alkoxy termination” is comprised of 4, 3, 2, 1 and 0 alkoxy groups, respectively, and for a T° monomer and T¹, T² and T³ moiety, said “alkoxy termination” is comprised of 3, 2, 1 and 0 alkoxy groups, respectively. Analogously, for a D° monomer and D¹ and D² moiety, said “alkoxy termination” is comprised of 2, 1 and 0 alkoxy groups, respectively.

DP_{Q-type}, DP_{T-type} and DP_{D-type} of the material can be directly obtained from quantitative ²⁹Si-NMR data according to:

$$D {P}_{Q - type} = Σ ( n {A}_{Q n} ) / Σ ( {A}_{Q n} ) = ( {A}_{Q 1} + 2 {A}_{Q 2} + 3 {A}_{Q 3} + 4 {A}_{Q 4} ) / ( {A}_{Q 0} + {A}_{Q 1} + {A}_{Q 2} + {A}_{Q 3} + {A}_{Q 4} ) ;$$

$$D {P}_{T - type} = Σ ( n {A}_{T n} ) / Σ ( {A}_{T n} ) = ( {A}_{T 1} + 2 {A}_{T 2} + 3 {A}_{T 3} ) / ( {A}_{T 0} + {A}_{T 1} + {A}_{T 2} + {A}_{T 3} ) for general T - type silanes ;$$

$$D {P}_{T - type , bipodal silanes} = 2 \cdot Σ ( n {A}_{T n} ) / Σ ( {A}_{T n} ) = 2 ( {A}_{T 1} + 2 {A}_{T 2} + 3 {A}_{T 3} ) / ( {A}_{T 0} + {A}_{T 1} + {A}_{T 2} + {A}_{T 3} ) for bipodal T - type silanes ; and$$

$$D {P}_{D - type} = Σ ( n {A}_{D n} ) / Σ ( {A}_{D n} ) = ( {A}_{D 1} + 2 {A}_{D 2} ) / ( {A}_{D 0} + {A}_{D 1} + {A}_{D 2} ) .$$

In the above equation for DP_{Q-type}, the terms A_{Qn} denote the quantitative ²⁹Si-NMR peak area related to that Qⁿ moiety (spectral signature), which is a Si atom coordinated by n siloxane bonds through bridging oxygen (BO) atoms, that connect it to its next-nearest-neighbor Si atoms and (4-n) non-bridging oxygen (NBO) atoms which are linked to terminal alkoxy groups Si—OR as defined herein. Analogously, A_{Tn} and A_{Dn} denote the ²⁹Si-NMR peak areas corresponding to the respective T-type and D-type moieties (spectral signatures).

For the above definition of DP, Q² and Q³ refer to all types of Q² and Q³ species, including linear and single ring as well as double ring species.

Regarding the equation for DP_{T-type} it is necessary to differentiate between the class of bipodal T-type silanes and all the other, “general” T-type silanes. The latter constitute the majority of commercially available T-type silanes and comprise only a single Si atom connected to three alkoxy and one organofunctional group. In contrast, bipodal silanes, which can be represented as (RO)₃Si—(CH₂)—X—(CH₂)—Si(OR)₃ contain a further trialkoxysilyl unit attached to the first one through a suitable linker group “X” and each spaced by at least one methylene (—CH₂—) group. The introduction of a modified definition for the degree of polymerization of bipodal silanes takes into account that a single connectivity to the polysiloxane network is sufficient to covalently attach the functional group and develop its targeted interface functionality. For example, simultaneous grafting through both trimethoxysilyl residues of a bipodal silane is counterproductive in a sense that it quickly leads to branching and attachment from one macromolecule to another, leading to unwanted gelation even at low surface coverage of dipodal T-type silanes. Hence it makes more sense to reference DP_{T-type, bipodal silanes} in terms of single trialkoxysilyl-attachment modality, leading to the definition given above.

For organofunctional T type tri- and D-type di-alkoxysilanes, the ²⁹Si spectral fingerprint regions are shifted progressively further downfield allowing a clear separation of the different non-organofunctional Qⁿ from organofunctional T^{m} and D^{I} moieties.

Optionally, the total silicon to free hydrolysable alkoxy molar ratio in the material described herein is in the range of 1:1.0 to 1:3.0, optionally 1:1.2 to 1:2.5, optionally 1:1.3 to 1:2.2 if the total content of di-organofunctional D-type siloxane moieties (iii) in the polysiloxane material does not exceed 10 mol-%.

Optionally, the molar number of ethoxy terminating units (—OCH₂CH₃) in the material described herein is at least twice the number of methoxy terminating units (—OCH₃) and the material is essentially free of propoxy terminating units (—OCH₂CH₂CH₃), e.g. less than 3% of all alkoxy terminating units are propoxy terminating units.

Optionally, the molar number of methoxy terminating units (—OCH₃) in the material described herein is at least twice the number of ethoxy terminating units (—OCH₂CH₃) and the material is essentially free of propoxy terminating units (—OCH₂CH₂CH₃), e.g. less than 3% of all alkoxy terminating units are propoxy terminating units.

For any polymeric liquid material described herein, there exist different modes of interconnections, namely i) siloxane bonds with two Q-type partners (Q-Q homocondensation), ii) siloxane bonds with two T-type partners (T-T homocondensation), iii) siloxane bonds with two D-type partners (D-D homocondensation), and iii) Siloxane bonds with non-identical partners (Q-T, Q-D, T-D, Q-M, T-M, D-M heterocondensation).

The concept of heterocondensation applies to bonding states of both, statistical mixtures in core-only as well as in core-shell materials, respectively, and is exemplified in the equation below for Q-T-type siloxane bonding:

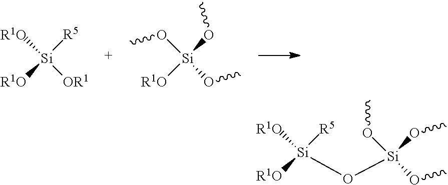

In the above example of a Q-T heterocondensation, the organofunctional trialkoxysilane is converted from T⁰ to T¹ while the Q-type alkoxysilane on the left-hand side of the reaction (symbolized by the three wavy siloxane bonds) from Q³ to Q⁴, illustrating that each siloxane bond formed simultaneously increases DP_{Q-type} and DP_{T-type}. There are obviously all sorts of other combinations of possible grafting reactions e.g. a T² species grafting onto a Q² yielding T³ and Q³, respectively, or T¹ species grafting onto a Q² yielding T² and Q³ and similar combinations involving D-Type dialkoxysiloxane moieties.

DP_{Q-type}, DP_{T-type} and DP_{D-type} are the primary parameters that define the polymeric liquid material described herein, together with the atomic ratio of T-type to Q-type and, optionally, the total molar content of D-type species in the material. These parameters can all be determined from quantitative ²⁹Si-NMR spectroscopy data with the special provisions given above for the calculation of DP_{T-type} for bipodal silanes.

For materials comprising more than one T-type subgroup with non-identical R⁵ organofunctional substituents, the quantification of those two T-type chemical species within the material can be done either directly from quantitative analysis of ²⁹Si-NMR spectra, if the T-type moieties belonging to the two non-identical R⁵ subgroups within the T-spectral window can be sufficiently resolved. Alternatively, e.g. when both methoxy/ethoxy R¹ groups are present in the material, non-identical R⁵ bearing T-type subgroups can be analyzed independently by means of ¹H- or ¹³C-NMR data, e.g. with fewer resolution restrictions compared to ²⁹Si-NMR data.

Generally, parameters that define the polymeric liquid material described herein can be measured using standard analytical tools: The content of hydroxy groups in the material can be determined, e.g., using ²⁹Si- and/or ¹H-NMR spectroscopy and Karl Fischer titration. The molar ratio of ethoxy and methoxy terminal alkoxy units in the material are directly accessible from ¹³C-NMR and independently from ²⁹Si-NMR data. The characterization of the reaction products in terms of viscosity is readily analyzed by means of standardized viscosity measurements such as a cylindrical rotation viscometer according to, e.g., ASTM E2975-15: “Standard Test Method for Calibration of Concentric Cylinder Rotational Viscometers”. Other viscosity test methods are also possible such as, e.g., Staudinger-type capillary viscometers or modern, dynamic viscometry methods. The sample preparation is generally relevant in determining the true viscosity of the polymeric liquid material as already low percentage amounts of monomers and/or solvent residues significantly impact the measured values. For this purpose, a viscosity measurement is typically done on a polymeric liquid sample material, i.e. a material essentially consisting of a polymeric material, which has previously been purified. Purification can be done, e.g. by means of a thin film evaporator setup at, e.g. 150° C., with a vacuum, e.g. <10⁻¹ mbar, which separates monomers and low molecular oligomers from the polymeric liquid material itself (see Macromolecules 2006, 39, 5, 1701-1708).

To determine, if a material is itself or comprises a polymeric liquid material as described herein, the following exemplary method of analysis can be used. First a sample of a material to be tested is subjected to a thin film evaporator purification step at 150° C. at 10⁻¹ mbar vacuum level until the amount of low molecular volatiles no longer changes by more than 1%. The resulting purified material is then analyzed by means of ²⁹Si NMR spectroscopy. The corresponding DP_{Qtype} and DP_{Ttype} values are then calculated from the measured spectra as well as the Q:T atomic ratio and used to determine if they fall within the range specified herein. If this is the case the material at least comprises such a polymeric liquid material. Analysis of the native sample prior to the thin film evaporator purification step can then be taken and analyzed side by side. If the difference in measured DP_{Qtype} values between original and purified samples is less than 5%, for the sake of this rapid test, the original sample itself shall qualify as a polymeric liquid material as described herein.

Also disclosed herein is the polymeric liquid hyperbranched polysiloxane material according to the present invention is one, wherein the total content of di-organofunctional D-type siloxane and/or the total content tri-organofunctional M-type siloxane moieties is zero.

Optionally, the polymeric liquid hyperbranched polysiloxane material according to the present invention is one, wherein the optional mono-organofunctional T-type siloxane moieties comprise
(xi) a first population of mono-organofunctional T-type alkoxy-terminated siloxane moieties, wherein R⁵ is R^{5N}, and either
(xii) a second population of mono-organofunctional T-type alkoxy-terminated siloxane moieties, wherein R⁵ is R^{5N}, wherein the R⁵ groups of the first and second populations are not identical,
(xiii) mono-organofunctional T-type alkoxy-terminated siloxane moieties, wherein R⁵ is R^{5U}, or
(xiv) mono-organofunctional T-type alkoxy-terminated siloxane moieties, wherein R⁵ is R^{5S}

The above option is directed to a tailorable hydrophobic material for the combination of (x) and (xi) and a mixed hydrophobic/functional material for the combination of (x) and (xii).

For example by combining (x) and (xi), a polymeric liquid material can be created by using multiple hydrophobic R⁵-organofunctional T-type moieties, which allows to control steric accessibility and hydrophobic properties of the material and thus its solubility and compatibility with polymers, solvents, inorganic and hybrid phases alike. This allows, e.g., tailoring of the polymeric liquid material to virtually any application specific formulation with a degree of freedom not attainable by today's commercial silane monomer and prehydrolysate systems.

For example, the combination of (x) and (xii) or (xiii), the combination of R⁵ moieties bearing both hydrophobic properties and specific functionalities (see feature (xii)) then allows tailoring of the overall compatibility with an application-specific matrix while also introducing further chemical connectivity options. For example, a material exhibiting both hydrophobic R⁵ selected from feature (x) while simultaneously bearing radical polymerizable groups such as methacrylate groups (selected from feature (xii)) could then control its interaction/compatibility through the hydrophobic component and its radical crosslinking reactivity essentially independently through the loading of said methacrylate component. The division of application-relevant system compatibility by selecting of a first type and loading of hydrophobic R⁵ functionality and the selection of a second R⁵ group to introduce a specific chemical function is expected to greatly improve performance and cost effectiveness of silane and siloxane technology. The advantage of this approach seems to further benefit from a core-shell type architecture, while different combinations are possible and could individually be selected depending on the application:
R⁵ being as defined in feature (xii) within the core with a hydrophobic T-type siloxane (feature x) forming a shell, thus combining system compatibility with the ability to incorporate specific functions in the core. The Extension of such functionality options through R⁵-substitution further extends the range of functionality considerably.
Hydrophobic (feature (x)) and functional (feature (xii)) R⁵ moieties both present in a shell, creating an interplay between hydrophobic/matrix compatibility tailoring and functional group density and activity.
Hydrophobic (feature (x)) moieties distributed inside the core and functional (feature (xii)) moieties in the shell.
Additional combinations involving R^{5S} (feature (xiii)).

For example, an advantage of the polymeric liquid materials according to the present invention is the fact that they are essentially free of silanol species (Si—OH). Specifically, their molar content with respect to the total number of Si atoms present in the material is less than about 5, 2.5, 2, 1.5, 1 or 0.5%, optionally less than about 0.2%. This provides, e.g., greatly improved stability and shelf life over conventional sol-gel (e.g. hydrolytically prepared) based hybrid materials and substantially more structural control. In practical applications, they can be used “as is” in non-polar organic solvents, blends etc. or directly incorporated into hydrophobic matrices such as polymer melts.

The term “mol-ppm” or just “ppm” as used herein stands for a content of one millionth of the total molar amount of silicon (Si) in a material (given by the sum of all Q, T, D,M type moieties and monomers).

In another aspect, the present invention is directed to a hydrolysate or emulsion precursor comprising at least one polymeric liquid material described herein and optionally an acid, a base, buffer, an oil and/or a co-emulsifier.

Suitable buffers for the hydrolysate or emulsion precursor described herein can be, e.g., organic carboxylate/sulfonate/ammonium type buffers such as acetate, formate or citrate buffer, 3-(N-morpholino)-propane sulfonate or 2-(N-morpholino)-ethane sulfonate, 4-(2-hydroxyethyl)-1-piperazineethane-sulfonate, tris(hydroxymethyl)aminomethane, glycylglycine etc. Note that many buffered systems are commonly used as an aqueous preparation, however in this case, anhydrous, free acid form variants of these buffer systems are the preferred use form for the present application.

The hydrolysate or emulsion precursor including the optional acid, base or buffer is optionally essentially water-free. This essentially water-free precursor is can be diluted in water in order to obtain the hydrolysis or emulsion product. The essentially water-free nature of the precursor has the advantage of a lower volume and weight, e.g. for shipping, and e.g. a longer shelf-life.

The oil for use in the directly emulsifiable formulation can be a natural oil or a synthetic oil such as, e.g., a silicone oil based on polydimethoxysiloxane, an oil based on hydrocarbons or petroleum products such as, e.g., mineral oil, and/or fatty acids, specifically fatty acid triglycerides such as, e.g., soybean oil, canola oil, tripalmitin, avocado oil, sunflower oil, coconut oil, safflower oil etc.

The co-emulsifier for use in the directly emulsifiable formulation can be any emulsifier or surfactant active on its own, specifically ionic surfactants such as saponified fatty acids (sodium linoleate, potassium palmitate etc.), long chain hydrocarbon trialkylammonium salts (quats) such as cetyltrimethylammonium bromide, potassium cetyl phosphate and also non-ionic surfactants such as polyethylene/polypropylene oxide polymers and block copolymers (e.g. BASF Pluronic product series) and also natural emulsifiers based on glycol(phospho)lipids which are often used in the food industry such as soy Lecithin, glycerin monostearate, sodium stearoyl lactylate, sodium stearoyl glutamate, glycerol triacetate, polyglycerol polyricinoleate, sorbitan stearate, poly-ethylyleneglycol (PEG) sorbates and -stearates.

In another aspect, the present invention is directed to a hydrolysis or emulsion product obtainable by reacting at least one polymeric liquid material described herein, e.g. the hydrolysate or emulsion precursor described above, with a predetermined amount of water or with a predetermined amount of a water-solvent mixture, optionally in the presence of at least one co-emulsifier

The optional co-emulsifier in the hydrolysis or emulsion product may already be present in the hydrolysate or emulsion precursor.

Exemplary methods for hydrolyzing or emulsifying include the following steps of
optionally premixing at least one polymeric liquid material according to the present invention with at least one of the following
   an acid or a base,
   a polymer resin, an oil, a polyol or an oligosaccharide
hydrolyzing and/or emulsifying said polymeric liquid material comprising mixture with
   a predetermined amount of water or with a predetermined amount of a water-solvent mixture, optionally in the presence of at least one co-emulsifier (e.g. a surfactant) for the hydrolysis product, or
   a predetermined amount of water, optionally in the presence of at least one co-emulsifier (e.g. a surfactant) for the emulsion product.

Suitable polymer resins, include, e.g., water soluble polymers such as PVP, poly-acrylic acid, polyethylene glycol, polyacrylamide, polyvinyl alcohol etc.. Oils include natural oil or a synthetic oil, e.g. as described above. Polyols or oligosaccharides include, e.g., low molecular weight polyols such as ethylene glycol, propylene glycol, glycerol, glyceraldehyde, butylene glycol, C4-C8 linear and branched hydrocarbon diols and triols, glucose, fructose, allose, galactose, mannose and other monosaccharides, disaccharides and polysaccharides from said compounds, with a molecular weight not exceeding 2500 Da such as e.g. kestose, maltotriose, acarbose, alginate, oligo-N-acetyl-d-glucosamine.

The predetermined amount of water or water-solvent mixture for hydrolysis or for emulsifying is determined, e.g. by the molar amount of water to total molar amount of Si in the system confined in typical formulations by upper and lower bound limits. A lower bound value defining the water to total Si molar ratio can be 0.02:1, optionally 0.1:1 or 0.5:1. An upper bound value defining the water to total Si molar ratio can be 5'000:1, optionally 500:1 or 50:1. The amount of cosolvent can be chosen independently and technically without limitation imposed by the water to Si molar ratios.

For example, solvents for hydrolysis or emulsion can be selected from the group consisting of water-soluble organic solvents such as low-molecular weight alcohols, ethers, carboxylic acids, e.g.:
alcohols of formula Rₓ—OH with Rₓ being selected from the group consisting of —CH₃, —C₂H₅, —C₃H₇, —C₄H₉, —C₅H₁₁, and —C₆H₁₃;
ketones of formula Rₓ, R_{y}—(C═O) with Rₓ, R_{y} independently selected from the group consisting of —CH₃, —C₂H₅, and —C₃H₇;
carboxylic acids of formula Rₓ—COOH with Rₓ being selected from the group consisting of —CH₃, —C₂H₅, —C₃H₇, —C₄H₉, —C₅Hu, and —C₆H₁₃;
low-molecular weight organic esters such as ethyl acetate, methyl acetate or ethyl formate, methyl formate; and/or
ethers of formula Rₓ—O—R_{y} or Rₓ—O—(R_{y}—O)ₙₙ—Rₓ with Rₓ, R_{y} being independently selected from the group consisting of —CH₃, —C₂H₅, and —C₃H₇ or cyclic ethers such as tetrahydrofuran and nn=1-3.

The skilled person can routinely identify the solvents best used for each type of hydrolysate or emulsion system based on its contents. Together with the solvent, also an acid or a base can be used as a hydrolysis/condensation catalyst. Typical acids to be used are mineral inorganic acids and low-molecular organic carboxylic acids. Typical bases are alkali hydroxides, ammonia or aliphatic/aromatic primary, secondary or tertiary amines.

For example, surfactants for hydrolysis and/or emulsification can be selected from the group consisting of
non-ionic surfactants such as polyethylene-oxide/polypropylene oxide block copolymers or similar polyether block copolymer surfactants;
carboxylic acid based ionic surfactants, particularly fatty acids and related saturated or unsaturated linear and or branched aliphatic hydrocarbon-carboxylates such as lauric acid, stearic acid, oleic acid etc. and their corresponding alkali salts;
sulfonic acid or phosphonic acid based ionic surfactants, particularly saturated or unsaturated linear and or branched aliphatic hydrocarbon-sulfonates such as dodecylsulfonic acid (SDS) and their corresponding alkali salts; and/or
trialkylammonium salt based ionic surfactants such as cetyltrimethylammonium bromide (CTAB) or cetyltrimethylammonium chloride (CTAC).

In another aspect, the present invention is directed to a glass fiber sizing formulation comprising
the polymeric liquid polysiloxane material as described herein, optionally in the form of the hydrolysate or emulsion precursor or in the form of the hydrolysis or emulsion product described herein, wherein the material optionally comprises T- and/or D-type siloxane moieties with R⁵ being R^{5U} and/or R^{5N} wherein optionally at least 10 mol %, or at least an amount between 10 to 75 mol-% of all R⁵ in the material are R^{5U} and/or R^{5N}, and, wherein the material optionally comprises Q-type, T-type and/or D-type siloxane moieties with R¹ being R^{1′}, wherein optionally at least 0.1 mol %, or at least an amount between 0.1 to 3.0 mol-% of all R¹ of the material are R^{1′}, and
at least one component selected from the group of a silane hydrolysate, a lubricant, a polymer resin, a biopolymer, a film former, and an emulsifier.

Suitable silane hydrolysates include, e.g., hydrolysates of T-type organofunctional silanes such as vinyltrimethoxysilane, 3-aminopropyltrimethoxysilane, 3-glyycidoxypropyltriethoxysilane, 3-mercaptopropyltrimethoxysilane propyltriethoxysilane, 3-(2-aminoethylamino)-propyltrimethoxysilane, phenyltrimethoxysilane, methltrimethoxysilane etc. which are commonly prepared by hydrolysis in water/alcohol mixtures with stoichiometrically limited amounts of water and in the presence of a (acid) catalyst.

Suitable lubricants include, e.g. polymer dispersions, (microcrystalline) wax dispersions, polyelectrolyte polymer dispersions, specifically quaternary ammonium salts based on alkoxylated and/or epoxidized amines such as lauryl amine, dodecyl amine, oleyl amine, cottonseed oil amine, and palmityl amine, and other natural fatty acid amine analogues.

Suitable biopolymers include, e.g., mono-, oligo- and poly-saccharides, starch, lignin, poly D-glucose, Oligo-D-glucose, pectin, chitosan, deacetylated oligo-chitin, oligo-beta-D-galactopyranuronic acid, ketose, maltotriose, acarbose, alginate, oligo-N-acetyl-d-glucosamine, poly-alginic acid, oligo-alginic acid, poly amylose, oligo amylose, poly-galactose, and oligo-galactose, oligo-glucose, oligo-fructose, oligo-allose, oligo-galactose, oligo-mannose, mono- and disaccharides of basic natural sugars, oligopeptides, reaction products of natural proteins obtained by saponification (gelatin) of biological protein sources.

Suitable film formers include, e.g., polymers such as polyvinyl acetate, polyester resin, polyamide, polyvinyl chloride, polyolefins (preferably polypropylene), polycarbonate, epoxy resin, polyurethane, etc. typically in the form of polymer dispersions as well as other state of the art polymers/polymer dispersions typically used in fiber sizing preparations.

Suitable emulsifiers include those (co-) emulsifiers described above.

In another aspect, the present invention is directed to a 2K curable epoxy resin formulation comprising at least one resin, one hardener and at least one of the polysiloxanes (I.), (II.), (IV.) and (V.) as defined below,
wherein the hardener is selected from:
(I.) a polysiloxane material as described herein, wherein optionally at least 1 mol-%, optionally at least 3 mol-% at least 10 mol-% of all R⁵ of the material are R^{5U} with R_{5U}=L-Z¹;
(II.) a polysiloxane material as described herein, wherein at least 1 mol-%, optionally at least 3 mol-% at least 10 mol-% of all R⁵ of the material are R^{5S} with R^{5S}=L′-Y¹ wherein optionally Y¹ is functionalized by R^{10a};
(III.) an amine hardener, a mercapto hardener, an amide hardener, and amidoamine hardener, a carboxylic hardener, or an anhydride hardener.
wherein the resin comprises:
(IV.) a polysiloxane material as described herein, wherein at least 1 mol-%, optionally at least 3 mol-% and optionally at least 10 mol-% of all R⁵ of the material are R^{5U} being

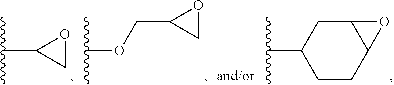

(V.) a polysiloxane material as described herein, wherein at least 50 or 80 mol-% of all R⁵ of the material are R^{5S} being L′-Y¹, wherein Y¹ comprises R^{10d} functionalization, optionally at least 30, 50 or 80 mol-% R^{10d} functionalization, wherein R^{10d} is bonded through a nitrogen or a sulfur atom to Y¹,
(VI.) an epoxy resin,
and the formulation optionally further comprises a catalyst and/or a filler

Suitable epoxy resins include aromatic (e.g. bisphenol A/F type) epoxy resins, aliphatic epoxy resins (e.g. epoxidized glycols, diols, and polyols, cycloaliphatic epoxy resins), Novolac-type epoxy resins, glycidylamine resins such as e.g. triglycidyl-p-aminophenol (TGPAP) or triglycidyl-4-(4-aminophenoxy)phenol (TGAPP).

The catalyst in the context of the 2K curable epoxy resin formulation is a catalyst which catalyzes the curing of the epoxy resin with the hardener. Such catalysts are known in the art and the skilled person can routinely choose a suitable catalyst.

In another aspect, the present invention is directed to a humidity curing formulation comprising
the polymeric liquid polysiloxane material as described herein, wherein the material optionally comprises Q-type, T-type and/or D-type siloxane moieties with R¹ being R^{1′}, wherein optionally at least 0.1 mol %, or at least an amount between 0.1 to 3.0 mol-% of all R¹ of the material are R^{1′}; and
optionally at least one of component selected from the group consisting of an aminosilane curing catalyst, an organometallic curing catalyst, an amine-based curing catalyst, a water scavenger, a plasticizer or softener, a filler, a stabilizer and a silane terminated polymer (STP) resin.

Typical amine curing catalysts for use in the present invention are C1-C8 aliphatic mono or diamines, di or tricyclic aliphatic diamines, such as DABCO, BDU, etc.

In another aspect, the present invention is directed to a binder, adhesive, sealant, elastomer or coating comprising the polymeric liquid polysiloxane material as described herein, optionally comprising at least one, optionally more than one type of R^{5N}, R^{5U}, R^{5S}, R^{1′}-functionality, optionally more than one type of R^{5N}, R_{5S}, R^{1′}-functionality in the same formulation

In another aspect, the present invention is directed to a cosmetics, personal care or (protective) coating formulation comprising the polymeric liquid polysiloxane material as described herein, optionally in the form of a hydrolysis or emulsion product described herein, wherein the material optionally comprises T- and/or D-type siloxane moieties with R⁵ being R^{5U} and/or ^{R5N} and wherein the material optionally comprises Q-type, T-type and/or D-type siloxane moieties with R¹ being R^{1′}.

The term “formulation”, as used herein, refers to any product comprising the polymeric liquid material described herein, e.g. as a crosslinker or as any other functional entity. The formulation may be a liquid, a paste or an emulsion or slurry. Such a formulation typically comprises, e.g., other compatible radical polymerizable monomers, oligomers or prepolymers or silane terminated polymeric building block moieties, fillers as well as performance or lifetime enhancing additives and stabilizers such as: UV and light stabilizers, antioxidants, rheology modifiers, tack modifiers, film forming additives, gloss additives, antistatics, nucleation agents etc. If thermally activatable, such a formulation will also typically contain, e.g., a radical starter molecule chosen to meet the designed curing onset temperature.

In another aspect, the present invention is directed to a silicone elastomer formulation comprising
the polymeric liquid polysiloxane material as described herein, wherein the material optionally comprises T- and/or D-type siloxane moieties with R⁵ being R^{5U} and/or R^{5N} wherein optionally at least 10 mol %, or at least an amount between 10 to 75 mol-% of all R⁵ in the material are R^{5U} and/or R^{5N}, and, wherein the material optionally comprises Q-type, T-type and/or D-type siloxane moieties with R¹ being R^{1′}, wherein optionally at least 0.1 mol %, or at least an amount between 0.1 to 3.0 mol-% of all R¹ of the material are R^{1′},
a silicone OH fluid and/or a silicone vinyl fluid and/or a silicone hydrido fluid, and
optionally a filler, a catalyst, and/or a moisture scavenger.

Silicone OH or vinyl fluids are linear polydimethylsiloxanes with terminal silanol groups/terminal or “in chain” vinyl groups used as base polymers in the silicone elastomer industry. OH or vinyl fluids are commercial materials classified by viscosity. Typical OH fluid are available in viscosities from 10-2'000'000 Centistokes (cSt). Commercial vinyl fluids have viscosities in the range of 5 to 500'000 cSt. Hydrodo fluids are Si—H terminated polydimethylsiloxanes used in conjunction with vinylsiloxanes in RTV 2K resins as hardeners. The catalyst in the context of the silicone elastomer formulation is a catalyst which catalyzes the silicon elastomer curing reaction. Such catalysts are known in the art and the skilled person can routinely choose a suitable catalyst.

Also disclosed is a method for preparing a polymeric liquid material of the present invention, comprising the following steps:
providing a polymeric liquid material as described herein, wherein at least 1 mol-%, optionally at least 3 mol-%, optionally at least 5 mol-%, optionally at least 10 mol-% optionally at least 20 mol-% of all R⁵ moieties in the material are R^{5U} moieties;
functionalizing the R^{5U} residues of the polymeric liquid material to obtain at least 1 mol-%, optionally at least 3 mol-%, optionally at least 5 mol-% optionally at least 7 mol-% R^{5S} residues relative to the sum of all R^{5U} and R^{5S} residues;
retrieving, optionally isolating and optionally purifying the polymeric liquid material.

The term modifying or R^{5S}-functionalizing as used herein for obtaining R^{5S} residues means that a chemical reaction is performed which is suitable for converting an R^{5U} residue into an R^{5S} residue. The suitable chemical reactions are known to the skilled person and are routinely chosen to obtain the desired R^{5S} residue.

Suitable non-limiting chemical reactions are, for example, as listed below.

Michael additions, aza-Michael additions (e.g. amine or thiol with acrylates, alkenes, alkynes, carbonyl isocyanates, or unsaturated carbonyls); reactions with anhydrides (e.g. amine with maleic anhydride); reactions with acid chlorides (e.g. amine with a suitable —C(═O)Cl moiety); epoxide ring opening (e.g. with amines, thiols, CN—, or halogens); imine formation (primary amine with ketone); thiol substitution with a halogenoalkane; various nucleophilic substitutions (e.g. S_{N}2) on halogenoalkanes; elimination on a halogenoalkane to form a double bond; reaction of a halogenoalkane with sodium azide to form an alkyl azide, optionally followed by the reaction of the alkyl azide, e.g. in a click-chemistry reaction (azide-alkyne cycloaddition) or through conversion to an isocyanate; various functionalization reactions with di- and trisisocyanates; reaction of alkenes, such as a “thiol-ene” reaction with thiols, electrophilic addition of a halogen onto an alkene, e.g. vinyl, followed by elimination to the alkyne; tetrasulfide- or thiol or unsaturated compounds (e.g. vinyl, methacrylate) reactions with unsaturated aromatic or unsaturated aliphatic compounds in the presence of a radical source (e.g. radical initiator), organic and inorganic peroxides or in the presence of aliphatic or aromatic, linear or cyclic epoxides; Friedel-Crafts-alkylation or -acylation on aromatic rings, e.g. phenyl rings; or peptide bond formation through amine or carboxylic groups.

The skilled person know which type of reactions and/or reaction conditions are compatible with the presence of (small amounts) water and/or silanol groups. The skilled person will choose a suitable protocol for carrying out the individual synthesis steps in order to minimized undesired side reactions with water and/or silanol groups. R^{5S}-Functionalization reactions that are not compatible with the presence of water and/or silanol groups and must be carried out in their presence are optionally excluded from the scope of the present invention. A preferred protocol for R^{5S}-functionalization reactions that are sensitive to water and/or silanol groups includes to first carry out the functionalization on a T⁰ monomer followed by grafting of the T⁰ monomer onto the siloxane core, thus circumventing reactions in the presence of water and/or silanol groups by temporal separation of the R^{5S}-functionalization.

The polymeric liquid polysiloxane material prepared by the method described herein is optionally R^{5S}-functionalized, e.g. at least 1 mol-%, optionally at least 3 mol-%, optionally at least 5 mol-% optionally at least 7 mol-% of the sum of all R^{5U} and R^{5S} moieties in the material are R^{5S} moieties, wherein R^{5S} is considered a R^{5S}-functionalized moiety. The starting material for the method may be non-R^{5S}-functionalized (essentially 100 mol-% of the sum of all R^{5U} and R^{5S} moieties in the material are R^{5U} moieties) or partly R^{5S}-functionalized (at least 3 mol-% of the sum of all R^{5U} and R^{5S} moieties in the material are R^{5S} moieties). R^{5S}—Functionalization of the starting material may be done by functionalizing R^{5U} of grafted T-type siloxane moieties or optionally by grafting further, pre-R^{5S}-functionalized T-type silanes comprising R^{5S} moieties in mono- or oligomeric form. The R^{5S}-functionalization of R^{5U} moieties can be done by known chemical methods. Retrieving, optionally isolating and optionally purifying the polymeric liquid material can be done as outlined in the context of step (g) of the method below.

Also disclosed is a method for preparing a polymeric liquid material as described herein, comprising the following steps:
(a) providing a Q-type polymethoxy, polyethoxy, polypropoxy or mixed poly(methoxy/ethoxy/propoxy) polysiloxane precursor, optionally Q-type material described herein, e.g. in appended claim 1, optionally comprising
   (a1) di-organofunctional D-type siloxane moieties; and/or
   (a2) mono-organofunctional T-type siloxane moieties, wherein R⁵ is selected from R^{5N}, R^{5U} and R^{5S};
   optionally comprising less than 12 mol-% of (a1) and (a2) combined relative to the total amount of all Q-type species;
   optionally further comprising a rearrangement catalyst and/or tri-organofunctional M-type siloxane moieties;
   wherein the precursor optionally comprises at least 28, optionally at least 35, optionally at least 42 mol-% four-membered combined Q^{2r}-type and Q^{3s,d}-type siloxane ring species relative to the total Q-type siloxane species; and/or
   wherein the precursor optionally comprises at least 60%, optionally at least 67%, optionally at least 75% four-membered combined Q^{3s,3d}-type siloxane ring species relative to all Q³-type siloxane species; and
   wherein degree of polymerization of the Q-type polysiloxane DP_{Q-type} is in the range of 1.5 to 2.5, optionally 1.6 to 2.4, optionally 1.65 to 2.35;
(b) adding at least one of a
   (b1) tri-organofunctional M-type silane Si(OR¹)(Me)₃; and/or
   (b2) di-organofunctional D-type silane Si(OR¹)₂(R²)(R³); and/or
   (b3) mono-organofunctional T-type silane Si(OR¹)₃(R⁵), wherein R⁵ is selected from R^{5N}, R^{5U} and R^{5S};
   in mono- or oligomeric form to the polysiloxane of (a);
(c) optionally adding a rearrangement catalyst to the mixture of step (b);
(d) heating the mixture of (c), optionally in the absence of water:
(e) optionally repeating steps (b) to (d) at least once;
(f) optionally functionalizing the R^{5U} residues of the polymeric liquid material to obtain at least 1 mol-%, optionally at least 3 mol-%, optionally at least 5 mol-% optionally at least 7 mol-% R^{5S} residues relative to the sum of all R^{5U} and R^{5S} residues;
(g) retrieving, optionally isolating and optionally purifying the polymeric liquid material; with the proviso that at least one of steps (a2) or (b3) is carried out, and with the optional proviso that a rearrangement catalyst is present in at least one of steps (a) or (c).

The Q-type polymethoxy, polyethoxy, polypropoxy or mixed poly(methoxy/ethoxy/propoxy) polysiloxane precursor of step (a) can be any, e.g. commercially available, Q-type polymethoxy, polyethoxy, polypropoxy or mixed poly(methoxy/ethoxy/propoxy) polysiloxane as long as it comprises the non-organofunctional Q¹- to Q⁴-type siloxane moieties defined for the polysiloxane material herein, wherein optionally at least 28, optionally at least 35, optionally at least 42 mol-% of all Q-type species are part of four-membered Q²-type and Q³-type siloxane ring species (including single and double rings), and/or wherein optionally at least 60%, optionally at least 67%, optionally at least 75% of all Q³-type species are part of four-membered Q^{3s,3d}-type siloxane rings, and as long as the degree of polymerization of the Q-type polysiloxane DP_{Q-type} is in the range of 1.5 to 2.5, optionally 1.5 to 2.7, optionally 1.7 to 2.4. In the context of the present method, the four-membered Q³-type siloxane ring species are those Q³-type siloxane species which are part of one or two four-membered rings, respectively. The term “all Q-type species” in the context of the present method includes all Q¹ to Q⁴ siloxane species as well as Q⁰ silane monomer(s).

The Q-type polymethoxy, polyethoxy, polypropoxy or mixed poly(methoxy/ethoxy/propoxy) polysiloxane of step (a) constitutes the precursor material as described herein. If a core-shell architecture is targeted, typically a pure Q-type precursor material is used as the core.

For example, the following Q-type polymethoxy, polyethoxy or mixed poly(methoxy/ethoxy) polysiloxane can be used in step (a): commercial oligomers of TEOS or TMOS, e.g. ethylsilicates with 40% by mass of total SiO₂ equivalent content such as Dynasylan 40 (Evonik Industries), Wacker Silicate TES 40 WN (Wacker), TEOS-40 (Momentive) or simply “ethylsilicate-40” as referred to by many non-branded Asian suppliers. Also, oligomers with higher silicate content such as Dynasylan Silbond 50 or equivalent products with up to 50% equivalent SiO₂ solids content can be used. The same holds for TMOS oligomers such as “Tetramethoxysilane, oligomeric hydrolysate” (Gelest Inc.) or “MKC silicate” (Mitsubishi Chemicals) which exist in variations with up to 59% SiO₂ equivalent content can be used as a source for methylsilicates. Comparable propoxy-silicates, if available commercially, can also be used.

Alternatively, the Q-type polymethoxy, polyethoxy, polypropoxy or mixed poly(methoxy/ethoxy/propoxy) polysiloxane of step (a) can be synthesized according to known protocols in the art, including hydrolytic and non-hydrolytic methods, e.g. as described in the examples below, in WO 2019/234062 A1, EP1576035 B1, Macromolecules 2006, 39, 5, 1701-1708, Macromol. Chem. Phys. 2003, 204(7), 1014-1026, or Doklady Chem., Vol. 349, 1996, 190-19.

The definitions of chemical substituents in the tri-organofunctional M-type silane Si(OR¹)(Me)₃, the di-organofunctional D-type siloxane moieties Si(OR¹)₂(R²)(R³) and the mono-organofunctional T-type siloxane moieties Si(OR¹)₃(R⁵) in the context of the present method correspond to the definitions given in the context of the polysiloxane material described herein.

The term “in mono- or oligomeric form”, as used herein, means that the M-, D- and T-type silanes are not highly polymerized when used as a precursor, i.e. are either monomers or small oligomers of, e.g., common mixtures with less than ten monomer units in a typical oligomer.

A rearrangement catalyst can be additionally used in the present method and this catalyst can be any catalyst that accelerates the grafting of T-, D- and M-type monomers or oligomers by nucleophilic substitution leading to the polymeric liquid material described herein. However, due to the composition of the present polysiloxane material, no rearrangement catalyst is required for efficient grafting. Additional rearrangement catalyst concentrations can be in the range from 0.01 mol-% to 1.5 mol-% based on the total molar silicon content in the prepared material. The additional rearrangement catalyst may be present in step (a) or (c), or both optionally with the proviso that it is present in at least one of steps (a) or (c).

The rearrangement catalyst, as used herein can be positively identified for example as described in Example 4 of WO2022/058059 which is incorporated by reference in its entirety. Any catalyst that elicits at least 75% grafting of T⁰ (less than 25% residual T⁰ monomer) for the MTES model compound defined in the protocol of Example 4 is an (additional) rearrangement catalyst for use in the present invention.

The optional catalyst for use in the present method can be selected from a group of compounds with the sum formulae

| | |
|---|---|
| M(II)L₁L₂ | for metal ions in the oxidation state +2 such as Zn⁺² or Fe⁺² |
| M(III)L₁L₂L₃ or O═M(III)L₁ | for metal ions in the oxidation state +3 such as Ce⁺³ or Fe⁺³ |
| M(IV)L₁L₂L₃L₄ or O═M(IV)L₁L₂ | for metal ions in the oxidation state +4 such as Ti⁺⁴ or Hf⁺⁴ |
| M(V)L₁L₂L₃L₄L₅ or O═M(V)L₁L₂L₃ | for metal ions in the oxidation state +5 such as V⁺⁵ or Nb⁺⁵ |

wherein M(II, III, IV, IV) is a main group or transition metal ion in an oxidation state +2 to +5 and bonded by covalent, ionic or coordination bonds or a combination thereof to identical or non-identical coordinating counterions and/or ligands L₁ to L₅, where at least one of these ligands is selected from the group of halides (e.g. F⁻, Cl⁻, Br⁻, I⁻), pseudohalides (e.g. SCN⁻, N₃⁻, CN⁻), chalcogenides, mineral acid counterions, organic carboxylates, organic alcoholates, acetylacetonates, organic sulfonic or phosphonic acid counterions, where preferably the main group or transition metal ion is selected from the group of elements Fe, Al, Sc, Y, Ti, Zr, Hf, V, Nb, Ta, Zn, Ce, Co, Fe and Mn in their naturally occurring oxidation states.

“In the absence of water” as noted in step d) optionally does not apply to reactions, e.g. grafting and/or rearrangement reactions, with tri-organofunctional M-type silanes as defined in the present method. In the present method, the reaction step with tri-organofunctional M-type silanes may be performed in the presence of water, e.g. in the presence of an aqueous acid/co-solvent mixture (e.g. EtOH, water, ketones etc.) as commonly used in the art. Optionally the M-type silane grafting is temporally separated from D-Type and/or T-type grafting, either being carried out before or after.

In order to allow sufficiently fast kinetics to yield reasonable reaction times, the use of elevated temperature in conjunction with a catalyst are typically required at least in step (d), optionally in steps (b) to (e) as described herein.

Each reaction step may be carried out for, e.g. half an hour to several hours or several days, depending on the rearrangement catalyst type and concentration used. Alternatively, if a radiofrequency-assisted heating method is used, the reaction times may be shortened significantly.

All of steps (b) to (f) are optionally carried out under stirring. Optionally stirring is continued in steps d) and/or (f) for at least 30 minutes after the M-, D- or T-type silane was added.

For example, during step (d) and/or (f), the total degree of polymerization remains essentially constant if the reaction is carried out in the absence of water. As noted herein, the degree of polymerization always refers to the that of the siloxane material.

Optionally, in step (d) and/or (f), low-molecular reaction products and/or residual starting materials in the reaction mixture can be removed by vacuum distillation, e.g. through gradually lowering the pressure inside the reaction vessel and holding a final pressure in the range of, e.g. about 5 to 250 mbar for a period of time between, e.g. 2 and 60 minutes. Optionally, residual volatile organic compounds, solvent residues and/or low molecular starting products (VOC) can be further removed at any stage in the workup procedure by bubbling a purge gas through the preferably still warm or hot reaction mixture.

For example, each of steps (a) through (e) of the present method are carried out essentially in the absence of any chemical reagent and/or any chemical reagent and a rearrangement catalyst for promoting the rearrangement and/or grafting reaction. For example, all of steps (a) through (e) are carried out essentially in the absence of acetic anhydride, acetic acid or other anhydrides or alphatic or aromatic carboxylic acids or water optionally in the absence of chlorosilanes, chlorosiloxanes, acetoxysilanes or acetoxysiloxanes and/or reararrangement catalysts as defined herein. “Essentially in the absence” means that there may be traces or catalytic amounts of the aforementioned substances present, however, “essentially in the absence” means that the amounts are not sufficient to promote a detectable or significant polymerization reaction by means of these substances.

The proviso that at least one of steps (a2) or (b3) is carried out means that at the product of the present method is a polymeric liquid polysiloxane material as described herein comprising mono-organofunctional T-type siloxane moieties as described herein, hence, the T-type silanes of formula Si(OR¹)₃(R⁵) must be added in monomeric or oligomeric form in at least one step of the present method. This is synonymous with saying that the product must contain T-type moieties.

When step (e) is optionally performed, the repetition of step (b) encompasses that the materials added during that or a further repetition step are not necessarily the same materials compared to the previously performed step. For example, if for the first performance of step (b3), R^{5U} is chosen for R⁵, then R^{5U}, R^{5S}, R^{5N}, or any combination thereof can be chosen for R⁵ when repeating step (b3). The same applies to all other repeated steps, e.g. regarding whether M-, D- or T-type silanes are added and/or which type of R¹, R² and R³ are chosen, as well what type and amount of catalyst are added during the repetition.

For the mono-organofunctional T-type siloxane moieties and silanes of step (a2) and (b3), R⁵ is selected from R^{5N}, R^{5U} and R^{5S}. This means that the T-type siloxane moieties/silanes may be non-R^{5S}-functionalized (essentially 100 mol-% of all R^{5U} moieties of all T-type siloxane moieties/silanes in the material are R^{5N} or R^{5U} moieties), fully R^{5S}-functionalized (essentially 100 mol-% of the sum of all R^{5U} and R^{5S} moieties of all T-type siloxane moieties/silanes in the material are R^{5S} moieties) or partly R^{5S}-functionalized (the T-type siloxane moieties/silanes comprise R^{5S} together with R^{5U} and/or R^{5N} moieties in any possible ratio). Optionally, R⁵ of the mono-organofunctional T-type siloxane moieties in step (a2) of the present method is R^{5N} or R^{5U}

Step (f) is optional to the extent that no functionalization of the R^{5U} residues is mandatory if the T-type siloxane moieties and silanes of step (a2) and/or (b3) are chosen, for example and optionally such that in the product of the method at least 1 mol-%, optionally at least 3 mol-%, optionally at least 5 mol-% optionally at least 7 mol-% of the sum of all R^{5U} and R^{5S} moieties are R^{5S} moieties in the absence of step (f). Of course, and for example, step (f) can be carried out even if the T-type siloxane moieties and silanes of step (a2) and/or (b3) already lead to a product wherein at least 1 mol-% of the sum of all R^{5U} and R^{5S} moieties in the material are R^{5S}, e.g. to increase the molar percentage of functionalized R⁵ residues.

Optionally, step (f) can also be performed between steps (d) and (e) and the sequence of steps (e) and (f) are optionally interchangeable.

In a further embodiment, the method described herein is one, wherein
in step (a), the R⁵ of the T-type siloxane moiety is R^{5N} and/or R^{5U};
in step (b), the R⁵ of the T-type silane is R^{5N} and/or R^{5U}; and
the method comprises the step (f) of functionalizing the R^{5U} residues of the polymeric liquid material to obtain at least 1 mol-%, optionally at least 3 mol-%, optionally at least 5 mol-% optionally at least 7 mol-% R^{5S} residues relative to the sum of all R^{5U} and R^{5S} residues.

In another embodiment, the method described herein is one, wherein
in step (a), the R⁵ of the T-type siloxane moiety is R^{5U};
in step (b), the R⁵ of at least one T-type silane is R^{5S}; wherein in optional step (e) the R⁵ of the T-type silane is selected from R^{5U} and R^{5S}, and
the method optionally does not comprise the step (f).

It is within the purview of the skilled person to routinely implement any permutations in the choice of starting materials and further functionalization reaction in the context of R⁵ moieties.

The concept of the R^{5S}-functionalization protocol variability can be illustrated by NMR spectroscopic investigations where the reactants and products are first identified by ¹H and ¹³C NMR spectroscopy. The degree of R^{5S}-functionalization can then be assessed by standard spectral interpretation/reaction monitoring as it is a standard process in preparative organic chemistry.

The product of the present method is retrieved in step (g) by collection of the material from the reaction vessel. The product may optionally be isolated and purified by standard methods known in the art, e.g. by distillation, optionally using a thin film evaporator, VOC removal by stripping with a purge gas etc.

In an embodiment, the method described herein further comprises before step (b) or after step (d) or (e), the method further comprises the step of adding a tri-organofunctional M-type silane or M-type siloxane and optionally a di-organofunctional D-type silane in mono- or oligomeric form as described in step (b2) in the presence of water, a suitable co-solvent and an acid catalyst, followed by heating the mixture, optionally to reflux. If the addition takes place before step (b), residual water, if any, and optionally alcohol or other cosolvents are removed before step (b) is initiated.

For example, solvents for adding a tri-organofunctional M-type silane and/or optionally a di-organofunctional D-type siloxane can be selected from the group consisting of ethanol, methanol, n-propanol, isopropanol, acetone, methyl-ethyl ketone, dimethyl ether, methyl-ethyl ether, diethyl ether.

For example, an acid catalyst can be selected from of strong acids with a negative pKa value, preferably selected from the group consisting of hydrochloric acid, nitric acid, sulfuric acid, hydrobromic or hydroiodic acid or organosulfonic acids (methane-, amido- or benzene-sulfonic acid).

In another embodiment, the reaction temperature for steps (c) through (e) of the method described herein is in the range from 30 to 170, optionally 50 to 150 or 70° C. to 120° C., and the pressure during steps (c) through (e) is in the range of 0.1 bar to 2 bar, optionally in the range of 0.5 bar to 1.4 bar or in the range of 0.6 bar to 1.2 bar.

The step of optionally functionalizing (f) is not necessarily performed at elevated temperatures, even if the step is performed before step (e). It is common general knowledge which reaction temperatures are necessary for which type of R^{5S}-functionalization reaction in step (f).

A rearrangement catalyst for use in the present method can be selected from the group consisting of
Ti(IV)(OR¹³)₄ and Zr(IV)(OR¹³)₄;
Ti(IV)X₄ and Zr(IV)X₄;
O═Ti(IV)X₂ and O═Zr(IV)X₂);
Ti(IV)X₂(OR¹³)₂ and Zr(IV)X₂(OR¹³)₂;
Ti(IV)X₂(OAcAc)₂ and Zr(IV)X₂(OAcAc)₂;
Ti(IV)(OSi(CH₃)₃)₄ and Zr(IV)(OSi(CH₃)₃)₄;
(R¹³O)₂Ti(IV)(OAcAc)₂ and (R¹³O)₂Zr(IV)(OAcAc)₂;
O═Ti(IV)(OAcAc)₂ and O═Zr(IV)(OAcAc)₂;
Ti(IV)(OAc)₄ and Zr(IV)(OAc)₄;
Ti(IV)(OAc)₂(OR¹³)₂ and Zr(IV)(OAc)₂(OR¹³)₂; and
O═Ti(IV)(OAc)₂ and O═Zr(IV)(OAc)₂;
   wherein R¹³ is selected from the group consisting of —CH₃, —CH₂CH₃, —CH(CH₃)₂, —CH₂CH₂CH₃, —C(CH₃)₃, —CH₂CH₂CH₂CH₃ and CH₂CH₂CH(CH₃)₂ and wherein X is a halide, a pseudohalide, nitrate, chlorate or perchlorate anion, and
   wherein the optional catalyst amount in each of steps (a) or (c) is optionally between 0.01 and 5 mol-%, optionally between 0.05 or 0.1 to 3 mol-%, based on the total molar silicon content present in said step.

In another aspect, the present invention is directed to a product obtained or obtainable by any of the methods described herein.

The following Figures and Examples serve to illustrate the invention and are not intended to limit the scope of the invention as described in the appended claims. For simplicity, Si central atoms are drawn as Q, T, D M types not as Si in the chemical formulas, referring to their central atom connectivity (Q-type, T-type etc.)

### FIGURES

FIG. 1 shows exemplary 2D molecular structure representations of exemplary Q-type polysiloxane materials as described herein (e.g. according to appended claim 1) comprising R₁=MC units. In FIG. 1a, an exemplary Q-type precursor is shown featuring representative R¹ substituents ethyl and MC only. In FIG. 1b, an exemplary Q-type polysiloxane material is shown featuring ethyl and Na as exemplary R¹ substituents, where the MC=Na is drawn in its ion pair (SiO⁻ Na⁺) form.

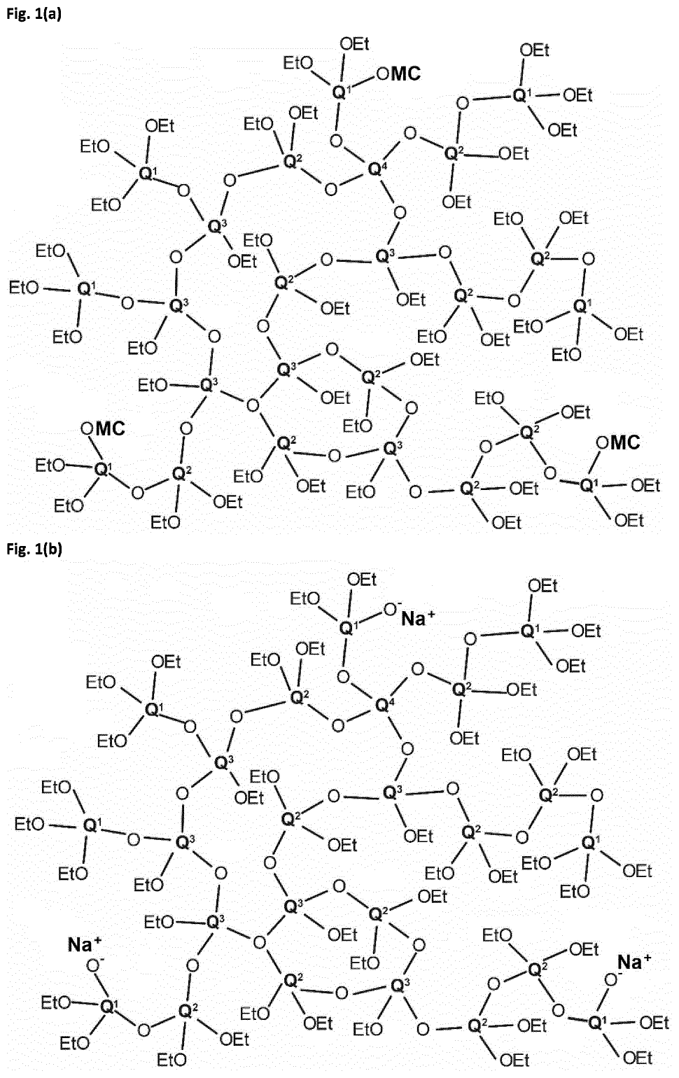

FIG. 2 shows exemplary 2D molecular structure representations of typical Q-T core-shell type polysiloxane materials described herein (e.g. according to appended claim 2) comprising R¹=MC units. In FIG. 2a, material comprising grafted T-type moieties is shown with R^{5U} and exemplary R^{5S} (-L′-Y¹—R^{10d}) functionality. In FIG. 2b, a polymeric liquid material comprising grafted T-type moieties with R^{5U} functionality and STP functionalities as well as MC=K residues drawn in the ion pair (SiO⁻ K⁺) form is shown. The representations are for illustration purposes only and do not represent any limitation in further T (R^{5N}, R^{5S} and R^{5U}), D, M-Type grafting and functionalization combinations.

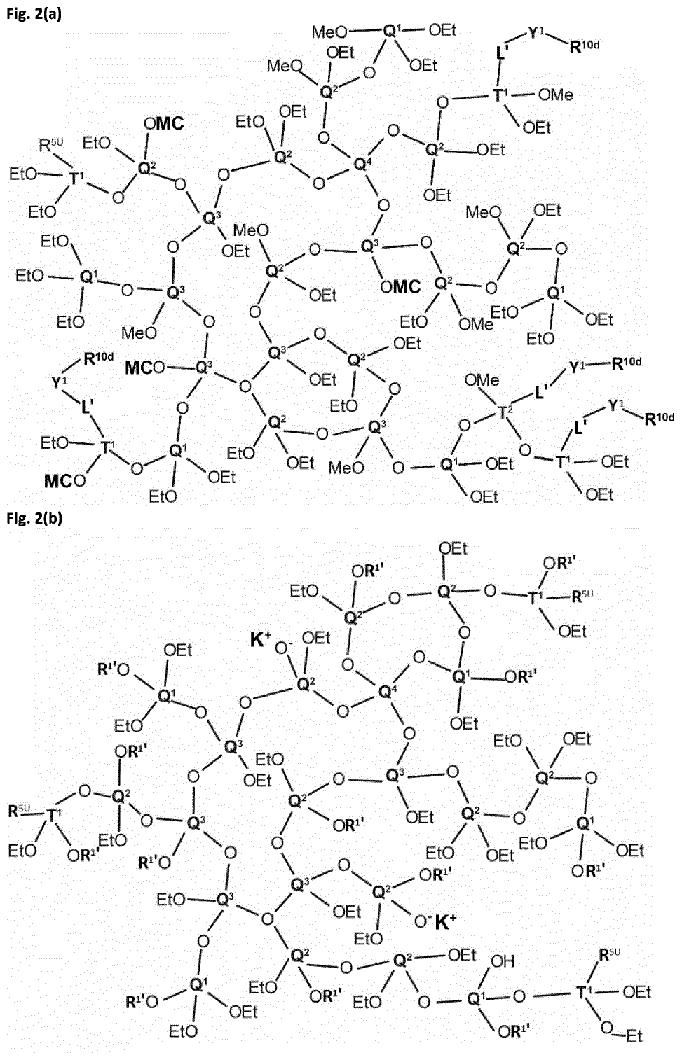

FIG. 3 shows ²⁹Si NMR spectra comparing MC=Na (FIG. 3b 0.05 mol-%, FIG. 3c 0.7 mol %) against a standard titanium(IV)-isopropoxide (TIP) rearrangement catalyst (FIG. 3e 0.54 mol-% TIP, FIG. 3d 0.27 mol-%). All percentages are mol-%. One can clearly see the lack of any grafting reaction in the absence of catalysts (FIG. 3a) and the high activity of the MC=Na catalyst system even at low concentrations. The data is based on Example 2e shown below.

### EXAMPLES

In all examples, the mol-percentage of (tetrasiloxane) ring species refers to the sum of all Q² and Q³ ring species relative to the total number of Q species also referred herein as %(Q^{2r}&Q^{3s,d}) ring species unless specifically mentioned otherwise.

In all examples, the mol-percentage of (tetrasiloxane) ring species refers to the sum of all Q² and Q³ ring species relative to the total number of Q species also referred herein as %(Q^{2r}&Q^{3s,d}) ring species unless specifically mentioned otherwise. Examples are structured as follows:

Example 1 describes selected preparation protocols of MC containing Q-type polysiloxane materials using various MC combinations.

Example 2 describes the preparation of R^{5N}, R^{5U} and R^{5S}-functionalized materials comprising both Q-type and T-type moieties by rearrangement grafting using MC type catalyst systems.

Example 3 illustrates the effect of MC in various applications and formulations (emulsions, hybrid STPs, silicone elastomer) involving both MC catalyzed rearrangement and curing reactions.

### Example 1a: Synthesis of a MC-Qtype Polysiloxane Material with a DP_{Qtype}=2.12 and an MC=Na Content of 0.3% Mol (MC)/Mol (Si)

A Q-type precursor was prepared from a commercial ethylsilicate oligomer (Evonik Dynasylan 40) by controlled hydrolysis adding a mixture comprising ethanol and water and a catalytic amount of oxalic acid at 65° C. for 8 hours in a round bottom flask with distillation bridge. Next, the heater temperature was set to 95° C. and residual solvent was distilled off over the course of 90 minutes. Next, an amount of sodium hydroxide (MC) catalyst corresponding to the desired final concentration in the material was added and residual solvent removed by vacuum (140 mbar/25 minutes). ²⁹Si NMR analysis confirmed that the product contained less than 1.0% of total Q⁰-monomer (Tetraethoxysilane) measured by the total amount of Q-type moieties, respectively as well as less than 24.8% of Q-type tetrasiloxane ring species and a DP_{Qtype} value of 2.12.

### Example 1b: Synthesis of a MC-Qtype Polysiloxane Material with a DP_{Qtype}=1.92 and an MC=Na Content of 1.8% Mol (MC)/Mol (Si)

A similar synthesis procedure as in Example 1 above was used to prepare the material, with the key difference that tetramethoxysilane (TMOS) was used as a raw material and the condensation was carried out using the silanol route (Macromol. Chem. Phys, 2003, 204(7), 1014-1026). Following an initial purification of the material, a desired amount of NaOH was added and mixture distilled under vacuum at 75° C. ²⁹Si NMR analysis confirmed that the product contained less than 1.6% of total Q⁰-monomer (Tetramethoxysilane) measured by the total amount of Q-type moieties, respectively as well as less than 21.2% of Q-type tetrasiloxane ring species and a DP_{Qtype} value of 2.12 and a MC=Na content of 1.8% mol (MC)/mol (Si).

### Example 1c: Synthesis of a MC-Qtype Polysiloxane Material with a DP_{Qtype}=1.85 and an MC=Li Content of 0.6% Mol (MC)/Mol (Si)

A material was produced exactly like in example 1a, with the main difference, that instead of Sodium Hydroxide, Lithium oxide (Li₂O) was used as a MC source and a different DP value was targeted. Comparable results regarding ring species were obtained.

### Example 1d: Synthesis of a MC-Qtype Polysiloxane Material with a DP_{Qtype}=1.85 and an MC=Li Content of 0.08% Mol (MC)/Mol (Si)

A material was produced exactly like in example 1a, with the main difference, that instead of Sodium Hydroxide, Lithium amide (LiNH₂) was used as a MC source and a different DP value was targeted. Comparable results regarding ring species were obtained.

### Example 1e: Synthesis of a MC-Qtype Polysiloxane Material with a DP_{Qtype}=2.33 and an MC=K Content of 18% Mol (MC)/Mol (Si)

A material was produced exactly like in example 1a, with the main difference, that instead of Sodium Hydroxide, Potassium hydroxide (KOH) was used as a MC source and a different DP value was targeted. Comparable results regarding ring species were obtained.

### Example 1f: Synthesis of a MC-Qtype Polysiloxane Material with a DP_{Qtype}=1.58 and an MC=Mg Content of 0.06% Mol (MC)/Mol (Si)

A material was produced exactly like in example 1a, with the main difference, that Tetraemethoxysilane (TMOS) was used as a precursor and instead of Sodium Hydroxide, Magnesium hydroxide Mg(OH)₂ was used as a MC source and a different DP value was targeted. Comparable results regarding ring species were obtained.

### Example 1g: Synthesis of a MC-Qtype Polysiloxane Material with a DP_{Qtype}=1.75 and an MC=K Content of 0.022% Mol (MC)/Mol (Si)

A material was produced exactly like in example 1a, with the main difference, that instead of Sodium Hydroxide, Sodium Superoxide (NaO₂) was used as a MC source and a different DP value was targeted. Comparable results regarding ring species were obtained.

2a: Synthesis of a R^{5U} Non-Functionalized Ethylsilicate Q-Type/(PTMS+APTMS) Polycondensate Material with nQ-Type:(nT-Type)=1:(0.08+0.11)

First a Q-type precursor according to example 1a with MC=Li was prepared and heated to 90° C. in a stirred glass reactor. Next, a mixture of two T-type precursors PTMS (propyltrimethoxysilane) and APTMS (3-aminopropyltrimethoxysilane) was added and the mixture stirred for 16 h. ²⁹Si NMR analysis confirmed that the product contained less than 11% of total T⁰-monomer measured by the total amount of T-type moieties, respectively as well as less than 25.7% of Q-type tetrasiloxane ring species. The final MC=Li content was 0.25% mol (MC)/mol (Si).

2b: Synthesis of a R^{5S}-Functionalized Q-Type Polycondensate/(3-MPTMS) Polycondensate Material with nQ-Type:(nT-Type)=1:(0.17) and L′-Y1-R^{10d} Functionalization

First a Q-type precursor according to example 1a but without any MC content (leave MC addition step out) was prepared and heated to 90° C. in a stirred glass reactor. Next, a T-type precursors 3-MPTMS (3-mercapto-propyltrimethoxy-silane) was added and the mixture stirred for 16 h for MC induced rearrangement grafting. Next a quantity of a material from example 1b to yield a final concentration of MC=Na of 0.41% mol (MC)/mol (Si) in the mixture was added. Rearrangement grafting in the presence of MC=Na was then carried out for a period of 12 h at 100° C. The resulting product was R's functionalized on its mercapto (-L-SH) groups by direct “on polysiloxane” modification with an epoxide precursor (Bisphenol A diglycidyl ether—BADGE) leading to L′-Y¹ epoxy (R^{10d}) functionalization with grafted BFDGE units. A 1:3.6 molar ratio based on —SH to BADGE molar ratio was used and the reaction was carried out neat overnight at 90° C. with 0.3% of a dimethylbenzylamine catalyst. The reaction product was identified and confirmed by NMR analysis. ²⁹Si NMR analysis confirmed that the product contained less than 11% of total T⁰-monomer measured by the total amount of T-type moieties, respectively as well as less than 25.7% of Q-type tetrasiloxane ring species. The final MC=K content was 0.25% mol (MC)/mol (Si).

2c: Synthesis of a R^{5N} Non-Functional Ethylsilicate Q-Type/(OTES) Polycondensate Material with nQ-Type:(nT-Type)=1:(0.14)

A Q-type precursor according to example 1a was prepared, but simultaneously with the addition of the MC source (NaOH, molar amount=0.2% mol (MC)/mol (Si)) an amount of a T-type precursor OTES (octyltriethoxysilane)—taken into account in the total Si mol amount—was added and the mixture stirred at 100° C. for 16 h. ²⁹Si NMR analysis confirmed that the product had a DP_{Qtype} value of 1.92 and contained less than 21% of total T⁰-monomer measured by the total amount of T-type moieties, respectively as well as less than 25.7% of Q-type tetrasiloxane ring species. The final MC=Na content was 0.2% mol (MC)/mol (Si).

### Example 2d: Synthesis of a R^{5U} Non-Functionalized Ethylsilicate Q-Type/(APTES) Polycondensate Material with nQ-Type:(nT-Type)=1:(0.10)

A preparation protocol identical to the one described in Example 2a was used with the exception that only APTES was used as T-type precursor and a MC=Na content of 0.15% mol (MC)/mol (Si) was used for rearrangement grafting. The material had a DP_{Qtype} value of 2.02 and contained less than 9% of total T⁰-monomer measured by the total amount of T-type moieties, respectively as well as less than 23.1% of Q-type tetrasiloxane ring species.

### Example 2e: Use of MC-Comprising Polysiloxane Materials as Rearrangement Catalyst for Q-T-Rearrangement Grafting

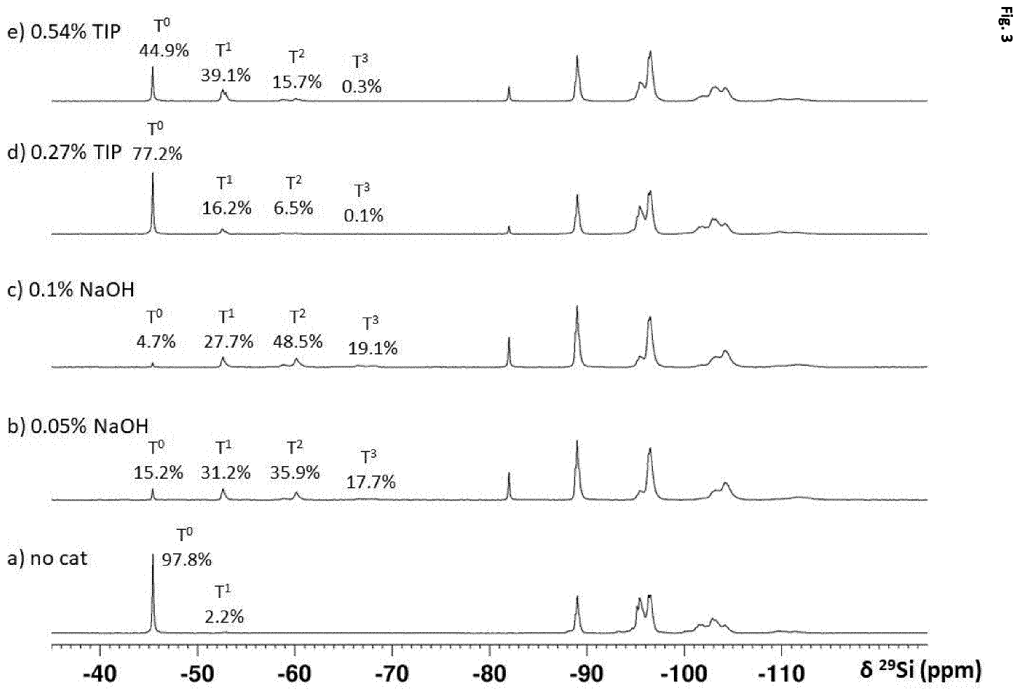

A material according to example 2c was prepared Na from a pure Q-type core material (DP_{Q-type}=2.24) using MC=Na as rearrangement catalyst and Ti(IV)-isopropoxide (TIP) as a comparative model rearrangement catalyst. Grafting was carried out at 100° C. for 8 h at two catalyst concentrations for each catalyst and the conversion (DP_{T-type}) as well as residual ungrafted OTES monomer (% T°) characterized using standard protocols from ²⁹Si NMR data. Results are tabulated below and clearly show that MC=Na is a much more effective rearrangement catalyst than standard Ti systems. The corresponding ²⁹Si NMR Spectra are shown in FIG. 3, exemplifying the high activity of the MC type rearrangement catalyst.

| Rearrangement | | | |
|---|---|---|---|
| catalyst/ | % | | |
| concentration | T⁰ | DP_{T-type} | DP_{Q-type} |
| none/— | 97.8 | 0.02 | 2.24 |
| NaOH/0.05% | 15.2 | 1.56 | 2.09 |
| NaOH/0.1% | 4.7 | 1.82 | 2.04 |
| TIP/0.27% | 77.2 | 0.29 | 2.24 |
| TIP/0.54% | 44.9 | 0.71 | 2.17 |

### Example 3a: Effect of DP_{Q-type} and MC=Na Concentration on the Stabilization of Emulsions Made from Q_{type} Polysiloxanes with Varying DP and Monomeric Octyltriethoxysilane T_{type} Precursors

The example aims to demonstrate the influence of MC content on the water-in-oil emulsion stability from Q-type precursors and monomeric octyltriethoxysilane. For each test sample, four aliquots of 20 g of a Q-type polyethoxysilanes with respective DP_{Qtype} values of 0 (pure TEOS), 1.32, 1.68, 1.97 and 2.28) were combined with 6.55 g of monomeric octyltriethoxysilane and the desired amount of MC=Na added in the form of a material according to example 1b to reach 0 (no addition), 0.05, 0.1 and 0.15 mol % MC/total Si. Next, 10 mL of each mixture was combined with 5 mL distilled deionized water and briefly shaken. Each sample was then emulsified with a homogenizer for 20 seconds and then left undisturbed until phase separation occurred. The time at which two distinct phases became clearly identifiable was recorded as the phase separation time which is tabulated below.

| mol % | Q-type precursor effect on emulsion stability | | | | |
|---|---|---|---|---|---|
| MC/ | DP = 0 | | | | |
| total Si | (TEOS) | DP = 1.32 | DP = 1.68 | DP =1.97 | DP = 2.28 |
| 0 | 30 s | 2 mmin | 5 min | 7 min | 10 min |
| 0.05% | 2 m | 15 min | 2 h | 10 h | 10 h |
| 0.10% | 2 h | 12 h | 12 h | 24 h | 26 h |
| 0.20% | 4 h | 20 h | 20 h | >8 d | >12 d |

### Example 3b: Comparative Example Water/Oil Emulsions Using Grafted R^{5U} Materials

A grafted OTES Q-T polysiloxane material according to example 2c was first prepared separately with a DP_{Qtype} values of 1.92 and emulsified in the same way as described above in example 3a (20 ml with 10 ml water, no extra MC addition). The respective water in oil emulsion had a nearly unlimited shelf-life. No phase separation/change in viscosity were observed over the course of 4 months storage under ambient conditions. This clearly shows, that MC assisted rearrangement-grafted hydrophobic Q-T octyl-polysiloxanes offer far superior emulsion stability compared to the reference systems made from Q-polyethoxysiloxane/OTES monomer mixtures.

### Example 3c: MC Catalyzed Grafting and Reactivity of Q-T Polysiloxane/STP Hybrid Resins

Various commercial PPG-polyol based STP resins and an aminopropyl-functionalised Q-T polysiloxane comprising up to 0.35% mol MC=Na based on total Si in the polysiloxane material were combined at 1:1 equivalent mass ratios to create Q-T polysiloxane/STP hybrid resins. The MC concentration was adjusted to the desired level by starting with a material according to example 2d and adding additional MC when needed. MC free samples (MC concentration=0) were prepared using a MC-free analogous Q-T polysiloxane precursor which had been prepared separately (DP_{Qtype}=1.99, less than 11% of total T⁰-monomer, less than 21.2% of Q-type tetrasiloxane ring species.

Mixtures comprising Q-T polysiloxanes and commercial STP resins A-G were shaken and left to react under ambient conditions in closed containers for two hours at room temperature. Directly after preparation and mixing, the mixture had a phase separated turbid emulsion like appearance. The ability to react at room temperature to form a stable homogeneous R^{1′} functionalized hybrid STP reaction product was confirmed by the mixture turning translucent. Similarly, an identical set of samples was placed in a heating cabinet at 100° C. For all samples (with and without MC addition) until translucent, for a maximum of 24 hours.

From the table it becomes evident, that MC-free hybrid resin STP mixtures do not react at room temperature at all (not a single hybrid resin mixture turns clear/forms a stable hybrid resin), whereas MC additions of up to 0.35% are leading for all of the above STPs to form clear transparent hybrid resins with the aminofunctional Q-T polysiloxane.

Finally, 10 ml aliquots of “100° C. heating cabinet” prepared hybrid STP resins (only the ones which gave a clear reaction product) were poured on a polyethylene foil substrate and a 1 mm thick film drawn using a doctor blade setup. The films were then allowed to cure simultaneously at room temperature and the skin formation time as well as full curing times (final, dry thickness approximately 650 m). We observe from the skin formation time (SFT) and full curing (peel-off) time (FCT), that there is also a noticeable increase in speed of the formulations, although the effect is less pronounced than for the resin preparation. For the curing times, the typical speed increase is between 10% and 30%, however there are large differences depending on the STP resin type. Clearly, these results shows the effect of the MC addition on hybrid STP resin formation (preparation) and reactivity (curing).

| | | | | Reac- | 100° | Reac- | | |
|---|---|---|---|---|---|---|---|---|
| STP | | | RT | tion | C. | tion | | |
| resin | MC = Na | | reac- | time at | reac- | time at | SFT | FCT |
| type | conc. | | tion | RT | tion | 100° C. | [min] | [h] |
| A | 0 | | No | n/a | Yes | 1440 | 3.3 | 3 h 50′ |
| B | 0 | | No | n/a | No | n/a | — | — |
| C | 0 | | No | n/a | Yes | 1440 | 4.8 | 5 h 00′ |
| D | 0 | | No | n/a | No | n/a | — | — |
| E | 0 | | No | n/a | Yes | 960 | 3.1 | 3 h 25′ |
| F | 0 | | No | n/a | No | n/a | — | — |
| G | 0 | | No | n/a | No | n/a | — | — |
| A | 0.16 | mol % | Yes | 20 | Yes | 5 | 3 | 2 h 50′ |
| B | 0.16 | mol % | Yes | 360 | Yes | 60 | 5.8 | 5 h 15′ |
| C | 0.16 | mol % | Yes | 25 | Yes | 6 | 4.3 | 4 h 35′ |
| D | 0.35 | mol % | Yes | 300 | Yes | 100 | 6.7 | 6 h 00′ |
| E | 0.16 | mol % | Yes | 15 | Yes | 3 | 2.8 | 3 h 20′ |
| F | 0.2 | mol % | Yes | 60 | Yes | 10 | 4.5 | 3 h 55′ |
| G | 0.16 | mol % | Yes | 120 | Yes | 20 | 7 | 4 h 55′ |

### Example 3d: Tin-Free Curing of a Silicone Resin Elastomer Formulation

A RTV 1K silicone formulation was prepared from a silicone oil (100'000 cSt, Wacker Chemie) and a low viscosity OH fluid (250 cSt, BRB silicones) was mixed together with a hydrophobic silica filler (Aerosil R8200, Evonik Industries) and 0.50 pHr (per hundred rubber) of a crosslinker (methyl tris(methylethylketo-xime)silane) as well as 0.50 pHr of a material from Example 2d were mixed together in a speedmixer.

The formulation was spread onto a glass substrate as a 1 mm thick film and cured at 23° C./45% relative humidity. The material was fully cured in 13 minutes, while the skin formation time was 3-4 minutes. Shore A hardness of the fully cured formulation was 91. In comparison with the comparative Example 3e below, the curing time was greatly reduced and the formulation is free from organotin compounds. The silicone elastomer also shows significantly higher peel strength compared to Example 3e below.

### Example 3e: Curing of a Comparative Reference Silicone Resin Elastomer Formulation

A RTV 1K silicone formulation was prepared in an identical manner as the above Example 3d, however without the use of a material from Example 2d. Instead, 0.5 pHr of an organotin based curing catalyst (TIB KAT 223, organotin compound) was used.

The formulation was again spread onto a glass substrate as a 1 mm thick film and cured at 23° C./45% relative humidity. The material was fully cured in 42 minutes, while the skin formation time was 12-15 minutes. Shore A hardness of the fully cured formulation was 83.

1.-16. (canceled)

17. A polymeric liquid polysiloxane material comprising:
(i) non-organofunctional Q-type siloxane moieties selected from the group consisting of: 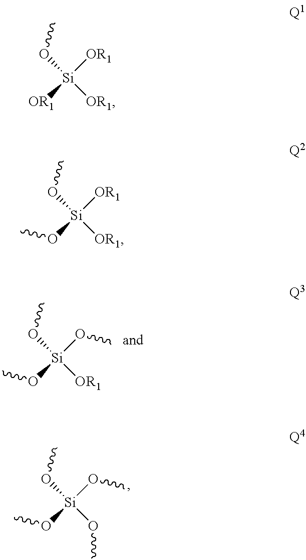
wherein [symbol]
indicates a covalent siloxane bond to a silicon atom of another siloxane moiety;
R¹ is selected from the group consisting of MC, methyl, ethyl, propyl, and R^{1′};
R^{1′} is selected from the group consisting of 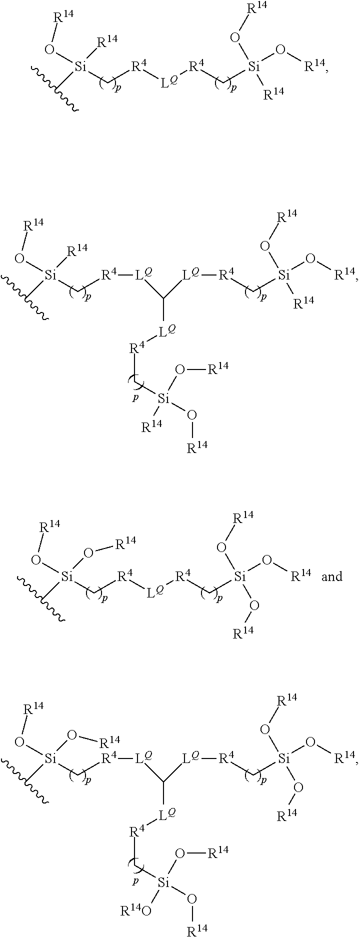
wherein p is an integer from 1 to 4;
R⁴ is absent, R^{4′}, or 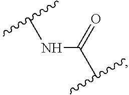 [SMILES: *NC(*)=O]
wherein the carbonyl is attached to the L^{Q} moiety;
R^{4′} is absent or selected from the grope consisting of 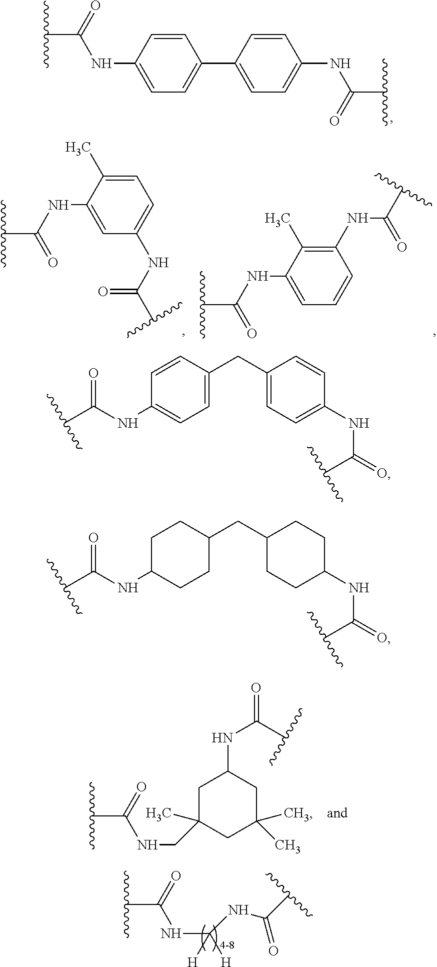
in monomeric, uretdione, biuret or tri-isocyanurate form;
R¹⁴ is methyl, ethyl, propyl, or a covalent bond to the silicon atom of another siloxane moiety;
L^{Q} is selected from the group consisting of 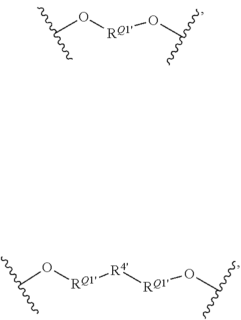
and L^{Q′};
R^{Q1′} is a polyol;
L^{Q′} is selected from the group consisting of
-(L^{Q1})ₘ₁[(L^{Q1})ₘ₂-R^{4′}]ₘ₃-co-[(L^{Q2})ₘ₂-R^{4′}]ₘ₄-co-[(L^{Q1})ₘ₂-R^{4′}-]ₘ₅-(L^{Q1})ₘ₁-, and
-(L^{Q2})ₘ₁[(L^{Q1})ₘ₂-R^{4′}]ₘ₃-co-[(L^{Q2})ₘ₂-R^{4′}]ₘ₄-co-[(L^{Q3})ₘ₂-R^{4′}]ₘ₅-(L^{Q1})ₘ₁-, wherein
L^{Q′} is about or less than 40'000 g/mol, and
m1 is an integer from 0 to 15,
m2 is an integer from 3 to 200, and
m3, m4 and m5 are each independently integers from 0 to 10, with the proviso that at least one of m3 to m5 is not 0;
MC is an alkali or earth alkali metal ion;
and wherein
the polysiloxane material comprises MC from 0.005 to 20 mol MC/mol Si in the polysiloxane material (mol-%);
the polysiloxane material has a viscosity in the range of 2 to 100'000 cP;
the polysiloxane material comprises less than 5 0.5 mol-% silanol groups (Si—OH); and
the degree of polymerization of the Q-type alkoxy-terminated moieties DP_{Q-type} is in the range of 1.3 to 2.7.

18. The polymeric liquid polysiloxane material according to claim 17, further comprising
(iv) mono-organofunctional T-type siloxane moieties selected from the group consisting of: 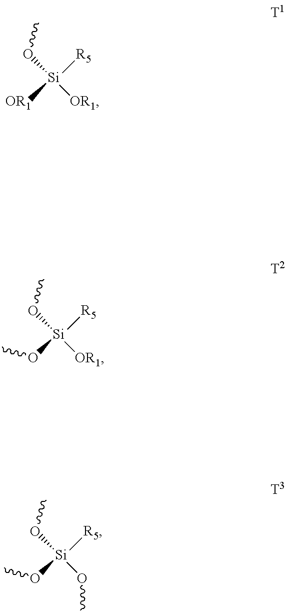
wherein
R⁵ is selected from the group consisting of R^{5N}, R^{5U} and R^{5S},
wherein
R^{5N} is selected from the group consisting of methyl, ethyl, n-propyl, isopropyl, n-butyl, t-butyl, and linear, branched or cyclic C₅₋₁₆ alkyl residues;
R^{5U} is selected from -L-Z¹, -L-Z², and —Z³, wherein
L is an aliphatic linker selected from the group consisting of —CH₂—, —CH₂CH₂—, —CH₂CH₂CH₂—, —C₆H₄—, —C₆H₄—CH₂—, and —CH₂—CH₂—C₆H₄—CH₂—;
Z¹ is a moiety selected from the group consisting of —SH, —NH₂, 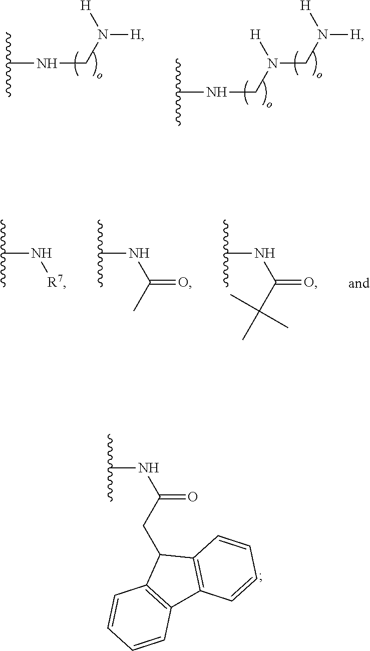
Z² is a moiety selected from the group consisting of 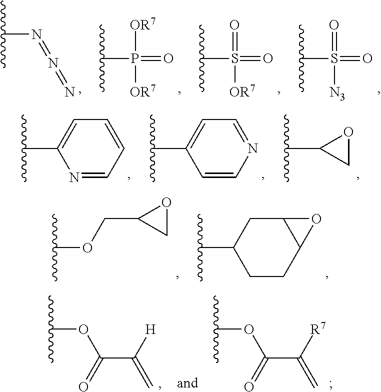
wherein
R⁷ is independently selected from the group consisting of methyl, ethyl, n-propyl and n-butyl and o is an integer from 1 to 3, and
Z³ is selected from vinyl, phenyl, 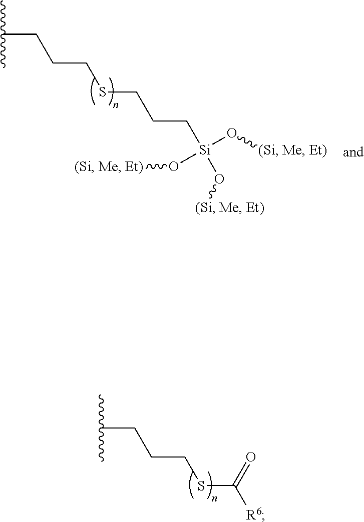
wherein
n is an integer selected from the group consisting of 1, 2, 3, 4, and 5, and
R⁶ is selected from the group consisting of methyl, ethyl, n-butyl, and linear or branched C₅₋₁₄ alkyl residues;
R^{5S} is selected from the group consisting of -L′-Y¹, -L′-Y², and —Y³,
wherein
R⁸ is selected from the group consisting of —Cl, —Br, —I, —F, —CN, —SCN, —N₃, —NO₂, —OH, —SO₂OR⁷, and —O—C(═O)R¹²;
R⁹ is selected from the group consisting of —Cl, —Br, —I, —F, —CN, —COOH, —COOR⁷, phenyl, o-vinylphenyl, m-vinylphenyl, and p-vinylphenyl;
R^{9′} is selected from the group consisting of —COOH and —COOR⁷;
L′ is an aliphatic linker selected from the group consisting of —CH₂—, —CH₂CH₂—, and —CH₂CH₂CH₂—; and
Y¹ is a moiety selected from the group consisting of 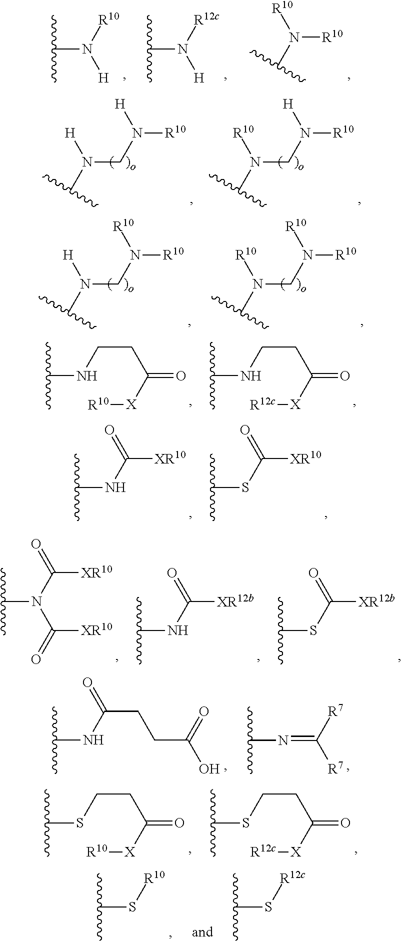
and wherein o is an integer from 1 to 3;
X is absent, —(NH)— or —O—;
Y² is a moiety selected from the group consisting of 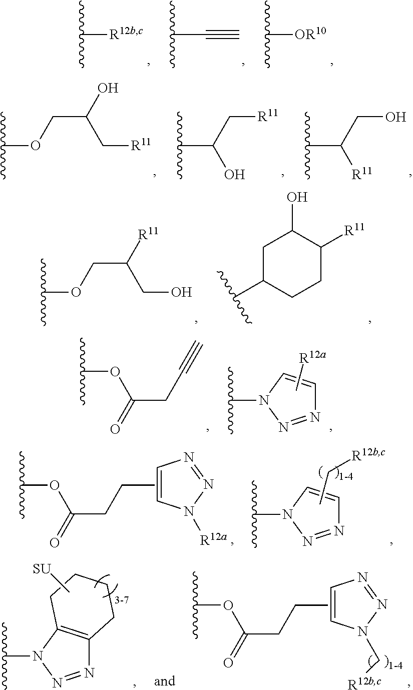
wherein SU indicates substituted or non-substituted;
Y³ is a moiety selected from the group consisting of 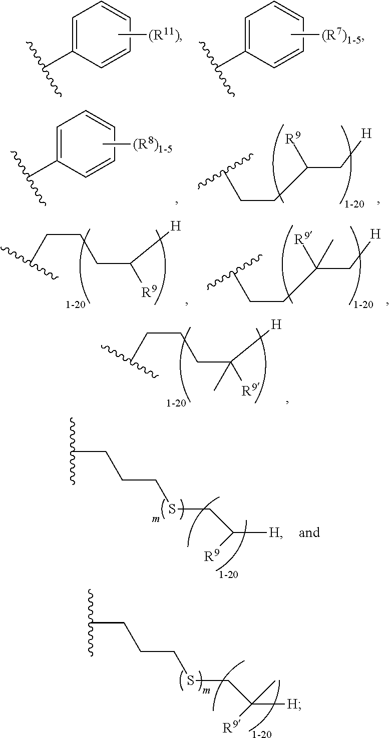
m is an integer selected from the group consisting of 1, 2, 3, and 4;
R¹⁰ is selected from the group consisting of R^{10a}, R^{10b}, R^{10c}, R^{10d}, R^{12a}, and 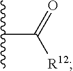
R^{10a} is selected from the group consisting of 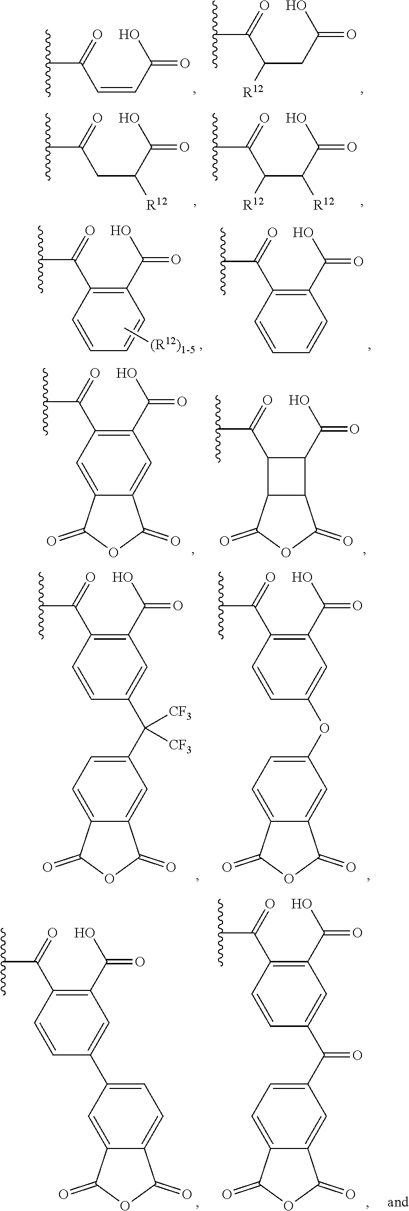 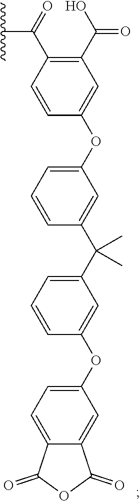 [SMILES: *C(=O)c1ccc(Oc2cccc(C(C)(C)c3cccc(Oc4ccc5c(c4)C(=O)OC5=O)c3)c2)cc1C(=O)O]
R^{10b} is selected from the group consisting of: 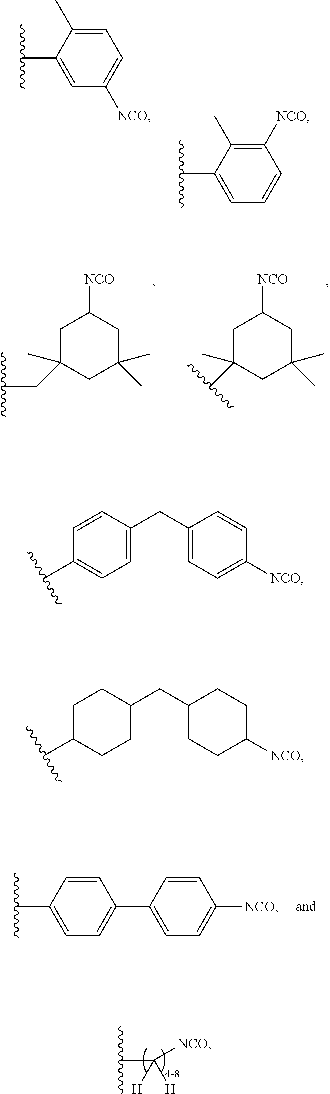
in monomeric, uretdione, biuret and triisocyanurate form;
R^{10c} is selected from the group consisting of: 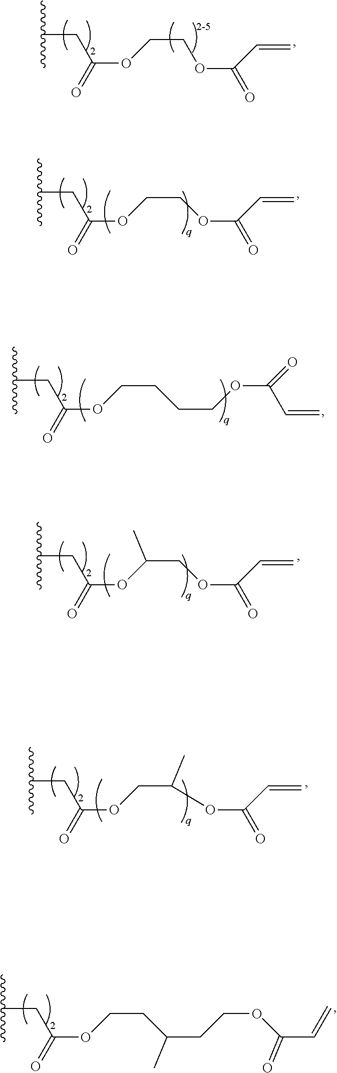
wherein q is an integer from 1 to 25, 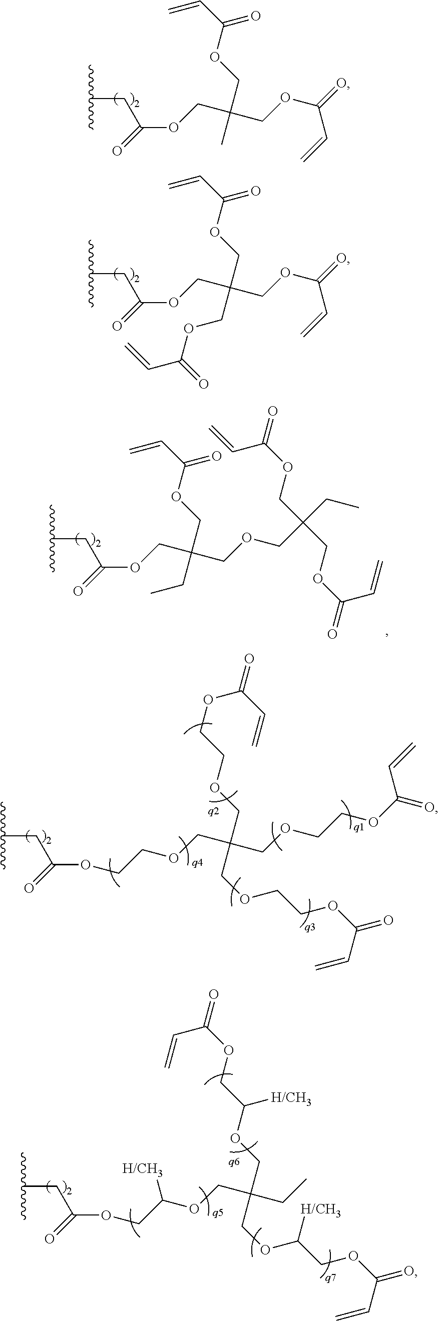 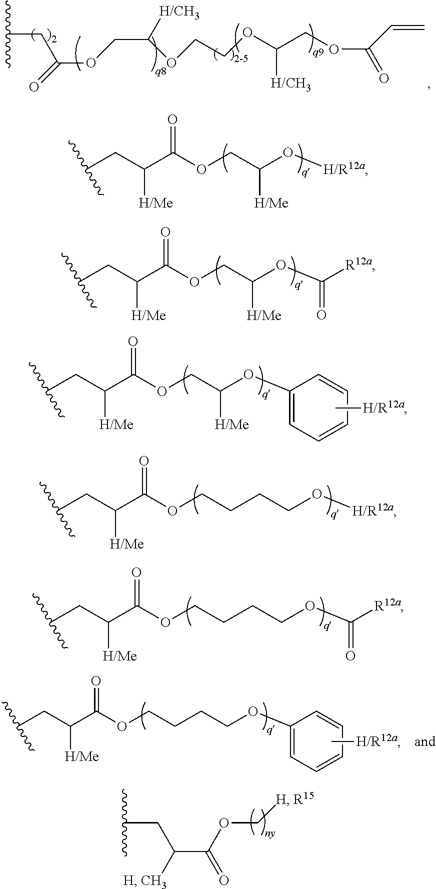
wherein
ny is an integer from 0 to 4,
q′ is an integer from 1 to 10,
each of q1 to q4 are integers independently from 0 to 8 and the sum of (q1+q2+q3+q4) is from 4 to 8,
each of q5 to q7 are integers independently from 0 to 24 and the sum of (q5+q6+q7) is from 3 to 24,
each of q8 and q9 are integers independently from 0 to 6 and the sum of (q8+q9) is from 2 to 6, and
R¹⁵ is selected from the group consisting of 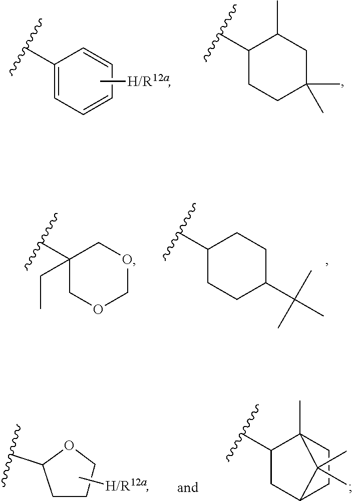
R^{10d} is selected from the group consisting of: 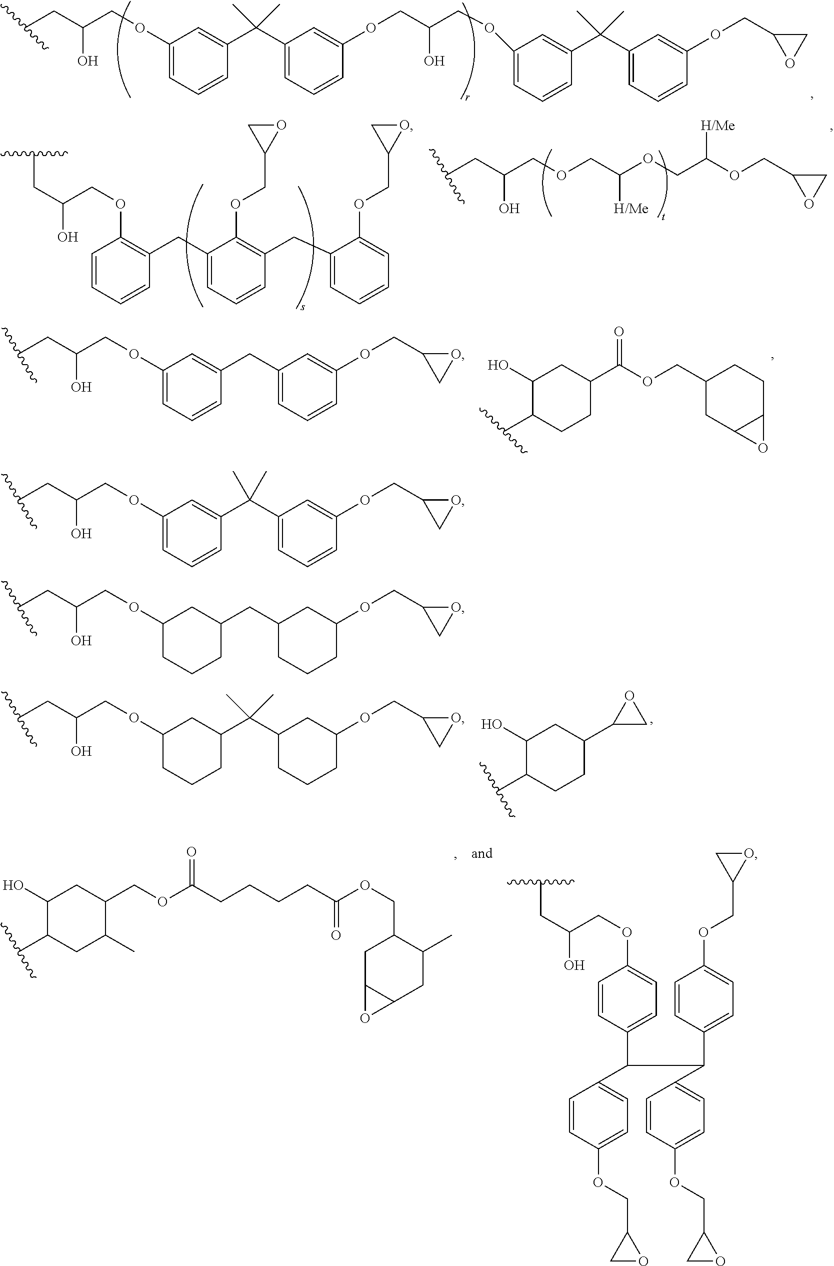
wherein r is an integer from 1 to 100, s is an integer from 1 to 15, and t is an integer from 1 to 10;
R¹¹ is selected from the group consisting of R⁸, —X—R⁷, R^{12c}, and for Y², R¹¹ is further selected from 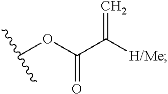
and
R¹² is selected from the group consisting of R^{12a}, R^{12b}, and R^{12c}, wherein
R^{12a} is selected from the group consisting of linear or branched, substituted or non-substituted C₁₋₁₈ alkyl, linear or branched, substituted or non-substituted C₂₋₁₈ alkenyl, and linear or branched, substituted or non-substituted C₂₋₁₈ alkynyl, cyclic, substituted or non-substituted C₃₋₁₈ alkyl, cyclic, substituted or non-substituted C₅₋₁₈ alkenyl, and cyclic, substituted or non-substituted C₈₋₁₈ alkynyl;
R^{12b} is selected from the group consisting of
linear or branched, substituted or non-substituted alkyl ether, linear or branched, substituted or non-substituted alkenyl ether, linear or branched, substituted or non-substituted alkynyl ether, cyclic, substituted or non-substituted alkyl ether and cyclic, substituted or non-substituted alkenyl ether, each up to a molecular weight of 5000 g/mol;
unsubstituted polydimethylsiloxane and unsubstituted polydivinylsiloxane; and
polysaccharides and oligosaccharides up to a molecular weight of 5000 g/mol; and
R^{12c} is selected from the group consisting of
amino acids, oligo-peptides, and poly-peptides up to a molecular weight of 5000 g/mol; and
C₁₂₋₂₄ fatty acids,
with the proviso that R^{5S} is not 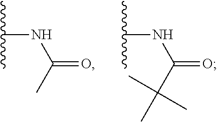
wherein
the degree of polymerization of the T-type alkoxy-terminated siloxane moieties DP_{T-type} is in the range of 1.1 to 2.7; and
the degree of polymerization of the Q-type alkoxy-terminated siloxane moieties DP_{Q-type} is in the range of 1.1 to 2.7.

19. The polymeric liquid polysiloxane material according to claim 18, wherein
when the sum of all R¹ residues in the material being MC, R^{1′}, or both, is ≥0.5 mol-%, the degree of polymerization of the Q-type alkoxy-terminated moieties DP_{Q-type} is in the range of 1.25 to 2.45.

20. The polymeric liquid polysiloxane material according to claim 18, wherein
when at least 65 mol-% of all R⁵ residues of the T-type siloxane moieties in the polysiloxane material are R^{5N}, the degree of polymerization of the Q-type alkoxy-terminated moieties DP_{Q-type} is in the range of 1.65 to 2.35, and the atomic ratio of T-species to Q-species in the material is in the range of 0.05:1 to 0.45:1;
when the sum of all -L-Z¹ and -L′-Y¹ residues amounts to at least 80 mol-% of all R⁵ residues of the T-type siloxane moieties in the polysiloxane material, the degree of polymerization of the Q-type alkoxy-terminated moieties DP_{Q-type} is in the range of 1.75 to 2.25, and the atomic ratio of T-species to Q-species in the material is in the range of 0.02:1 to 0.3:1;
when the sum of all (i) Z³ and Y³, (ii) the sum of all -L-Z² and -L′-Y², or (iii) a combination thereof, amounts to at least 50 mol-% of all R⁵ residues of the T-type siloxane moieties in the polysiloxane material, the degree of polymerization of the Q-type alkoxy-terminated moieties DP_{Q-type} is in the range of 1.85 to 2.2, and the atomic ratio of T-species to Q-species in the material is in the range of 0.02:1 to 0.3:1;
when the sum of all -L-Z¹, -L′-Y¹, and R^{5N} amounts to at least 90 mol-% of all R⁵ residues of the T-type siloxane moieties in the polysiloxane material, the degree of polymerization of the Q-type alkoxy-terminated moieties DP_{Q-type} is in the range of 1.8 to 2.4, and the atomic ratio of T-species to Q-species in the material is in the range of 0.05:1 to 0.4:1; and
when the sum of all R^{5N}, Z³, Y³, -L′-Y², and -L-Z² amounts to at least 90 mol-% of all R⁵ residues of the T-type siloxane moieties in the polysiloxane material, the degree of polymerization of the Q-type alkoxy-terminated moieties DP_{Q-type} is in the range of 1.7 to 2.25, and the atomic ratio of T-species to Q-species in the material is in the range of 0.05:1 to 0.25:1.

21. The polymeric liquid polysiloxane material according to claim 18, wherein
R^{5N} is selected from the group consisting of methyl, ethyl, n-propyl, isopropyl, n-butyl, t-butyl, and linear, branched or cyclic C₅₋₁₆ alkyl residues;
Z¹ is a moiety selected from the group consisting of —SH, 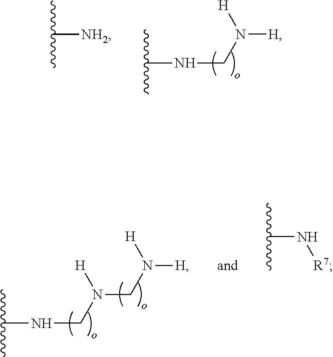
R⁸ is selected from the group consisting of —Cl, —Br, —I, —CN, —SCN, and —N₃;
Y¹ is selected from the group consisting of 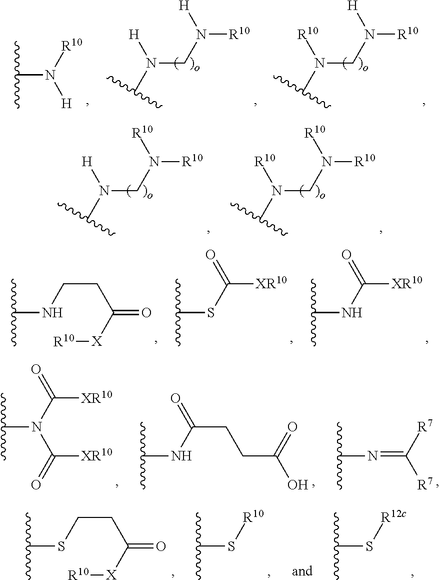
wherein o is an integer from 1 to 3;
Y² is a moiety selected from the group consisting of 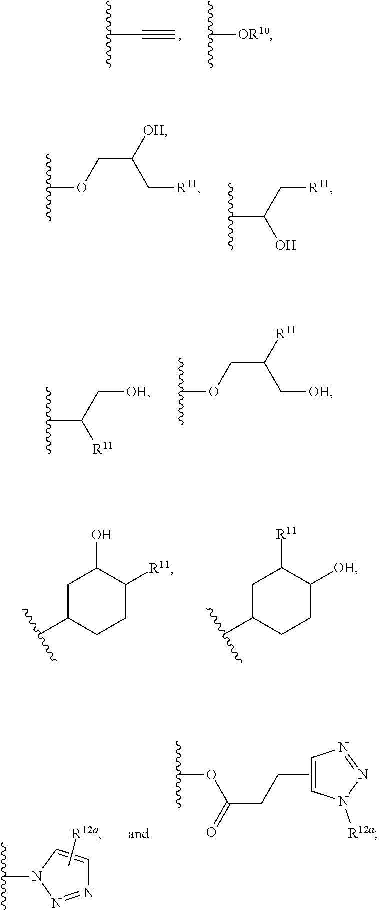
Y³ is a moiety selected from the group consisting of 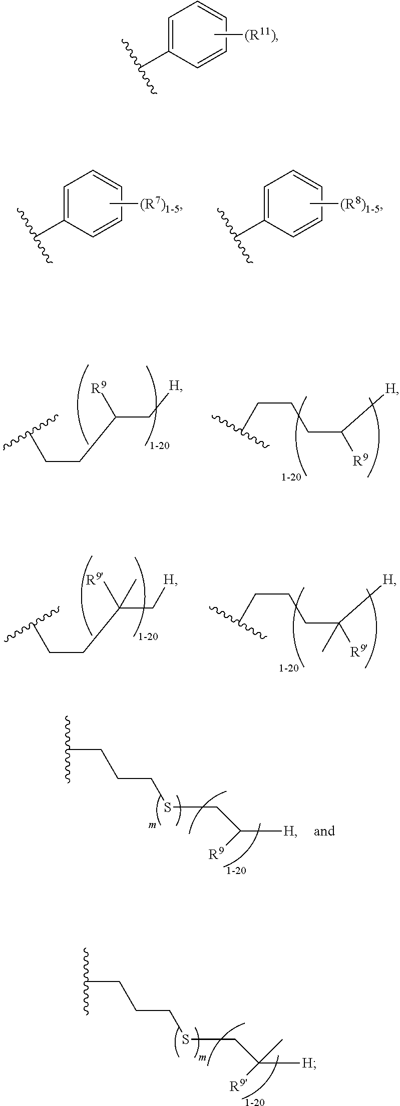
X is absent, —(NH)—, or —O—;
R¹⁰ is selected from the group consisting of R^{10a}, R^{10b}, R^{10c}, R^{10d}, and R^{12a};
R^{10a} is selected from the group consisting of 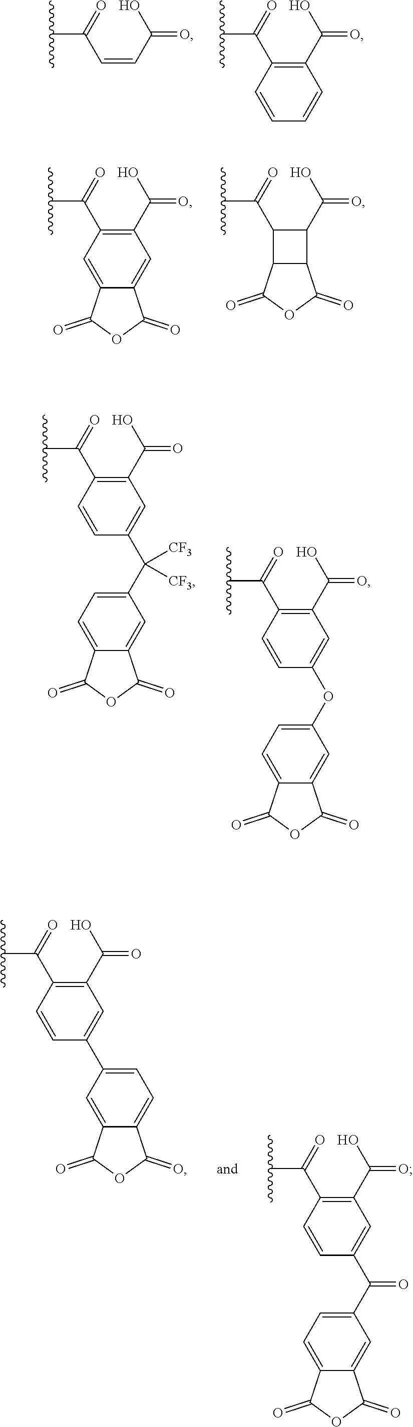
R^{10b} is selected from the group consisting of 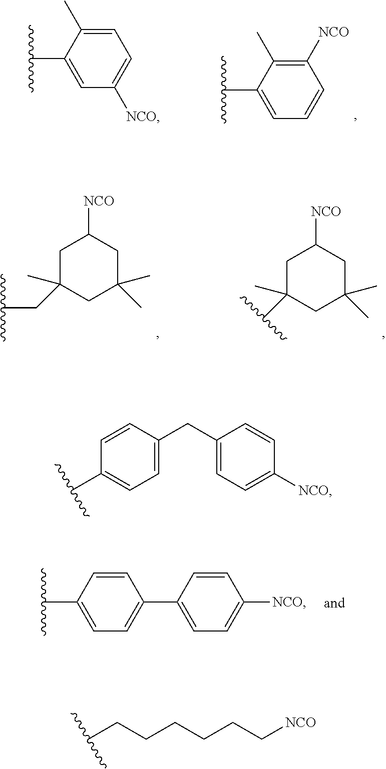
and in monomeric, uretdione, biuret and triisocyanurate form;
R^{10c} is selected from the group consisting of 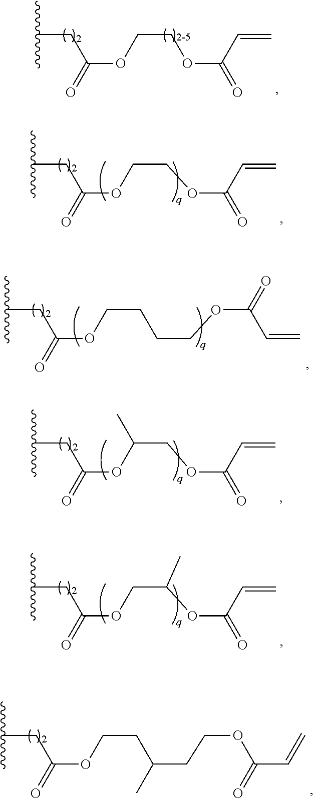
wherein q is an integer from 1 to 10, 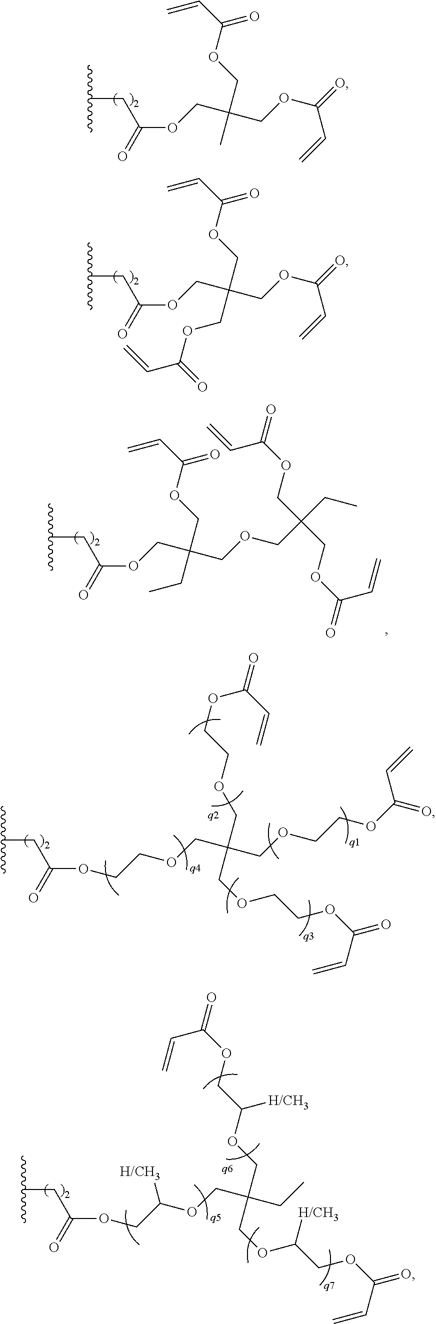 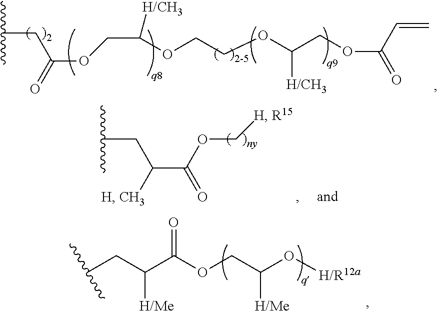
wherein
ny is an integer from 0 to 4,
q′ is as defined above,
each of q1 to q4 are integers from 0 to 8 and the sum of (q1+q2+q3+q4) is from 4 to 8,
each of q5 to q7 are integers from 0 to 24 and the sum of (q5+q6+q7) is from 3 to 24,
each of q8 and q9 are integers from 0 to 6 and the sum of (q8+q9) is from 2 to 6, and
R¹⁵ is selected from the group consisting of 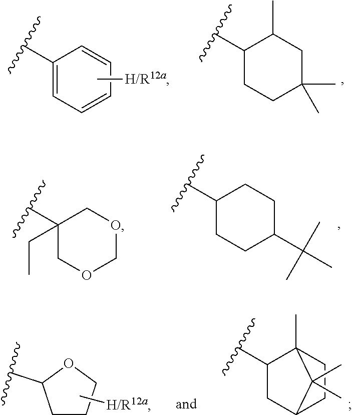
R^{10d} is selected from the group consisting of 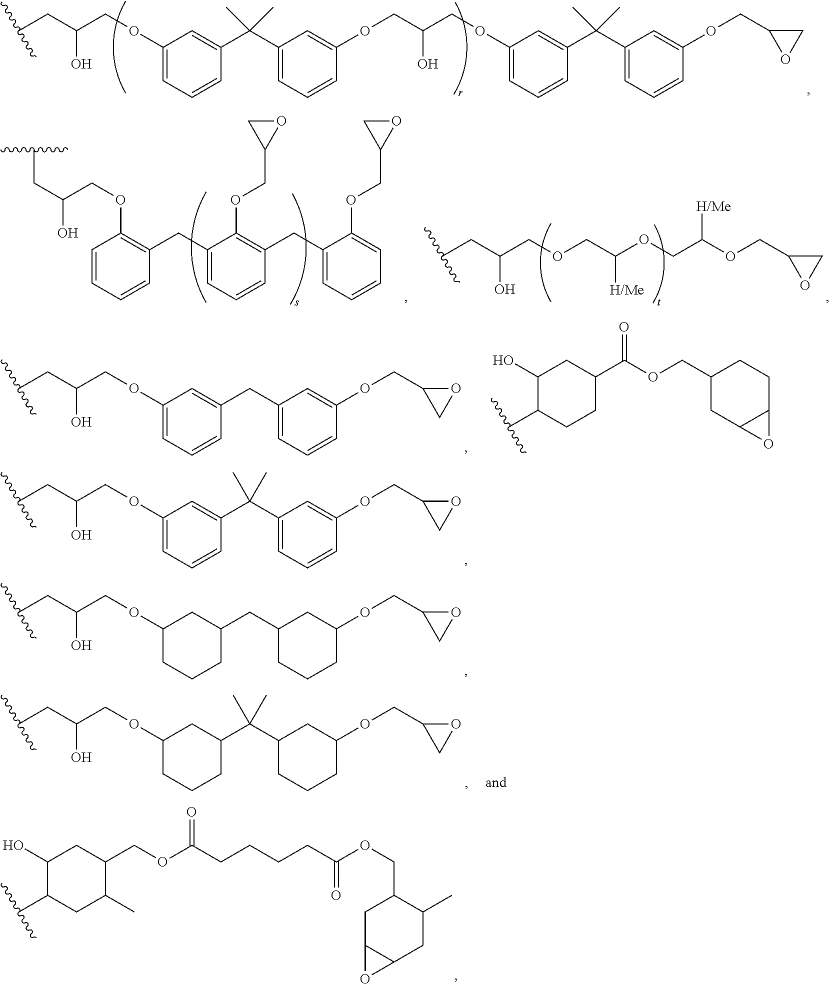
wherein r is an integer from 1 to 25, s is an integer from 1 to 10, and t is an integer from 1 to 10;
R¹¹ is selected from R⁸ and optionally R^{12c}, and for Y², R¹¹ is further selected from 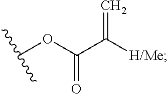
and
R¹² is selected from the group consisting of R^{12a}, R^{12b}, and R^{12c}, wherein
R^{12a} is selected from the group consisting of linear or branched, substituted or non-substituted C₁₋₁₈ alkyl and linear or branched, substituted or non-substituted C₂₋₁₈ alkenyl;
R^{12c} is selected from the group consisting of
amino acids or oligopeptides up to a molecular weight of 2000 g/mol, or polypeptides up to a molecular weight of 2000 g/mol; and
C₁₂₋₂₄ fatty acids.

22. The polymeric liquid hyperbranched polysiloxane material according to claim 18, wherein
R¹ is selected from the group consisting of MC, methyl, ethyl, and propyl;
R^{5N} is selected from the group consisting of methyl, ethyl, n-propyl, isopropyl, n-butyl, t-butyl, and linear, branched or cyclic C₅₋₁₆ alkyl residues;
L is an aliphatic linker selected from the group consisting of —CH₂—, —CH₂CH₂—, —CH₂CH₂CH₂—, and —C₆H₄—;
Z¹ is a moiety selected from the group consisting of —SH, 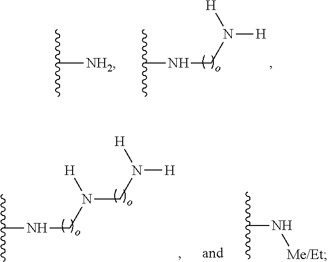
Z² is a moiety selected from the group consisting of 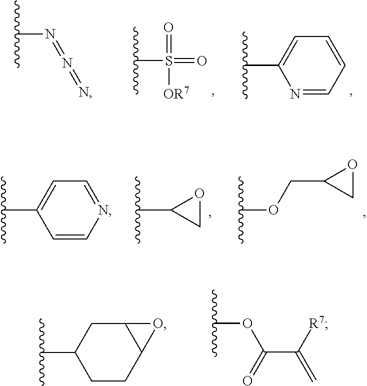
wherein R⁷ is independently selected from the group consisting of methyl and ethyl;
Z³ is selected from vinyl and phenyl;
R⁸ is selected from the group consisting of —Cl, —Br, —I, —CN, and —N₃;
R⁹ is selected from the group consisting of —Cl, —CN, —COOH, —COOR⁷, and phenyl;
Y¹ is selected from the group consisting of 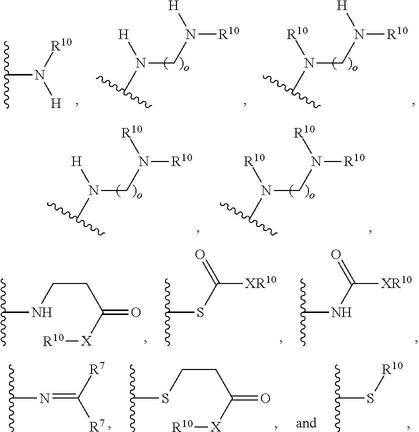
wherein o is an integer from 2 to 3;
Y² is a moiety selected from the group consisting of 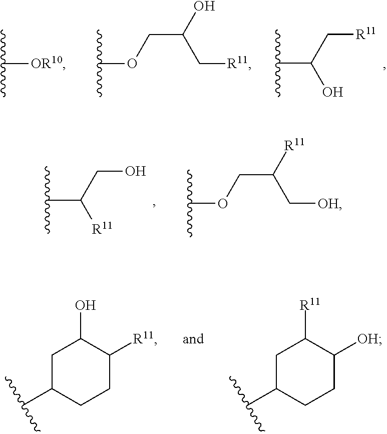
Y³ is a moiety selected from the group consisting of 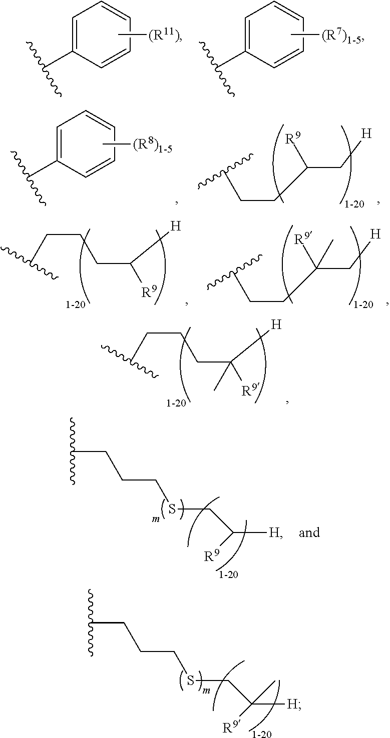
wherein
X is absent, —(NH)—, or —O—;
R¹⁰ is selected from the group consisting of R^{10a}, R^{10b}, R^{10c}, and R^{10d};
R^{10a} is selected from the group consisting of 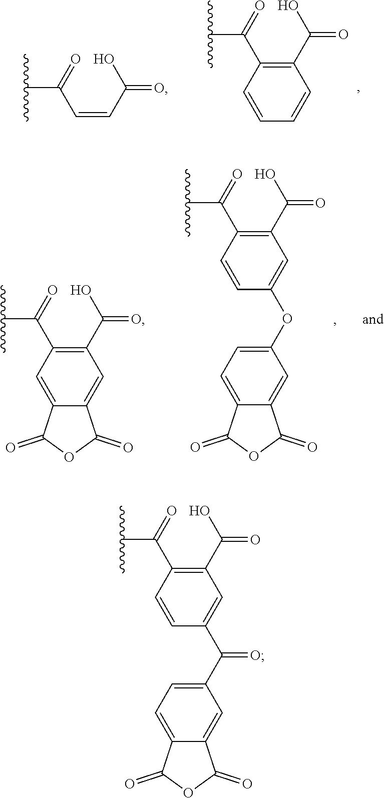 [SMILES: *C(=O)/C=C\C(=O)O ; *C(=O)c1ccccc1C(=O)O ; *C(=O)c1cc2c(cc1C(=O)O)C(=O)OC2=O ; *C(=O)c1ccc(Oc2ccc3c(c2)C(=O)OC3=O)cc1C(=O)O ; *C(=O)c1ccc(C(=O)c2ccc3c(c2)C(=O)OC3=O)cc1C(=O)O]
R^{10b} is selected from the group consisting of 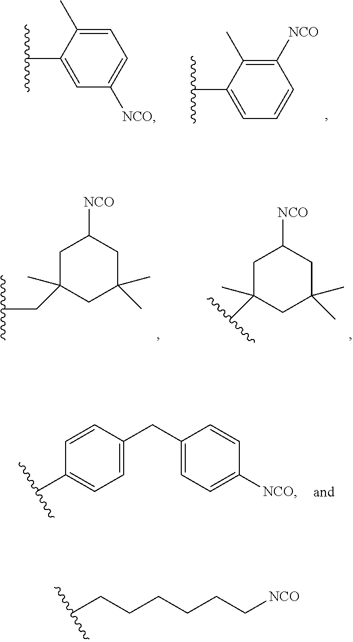
in monomeric, uretdione, biuret and triisocyanurate form;
R^{10c} is selected from the group consisting of 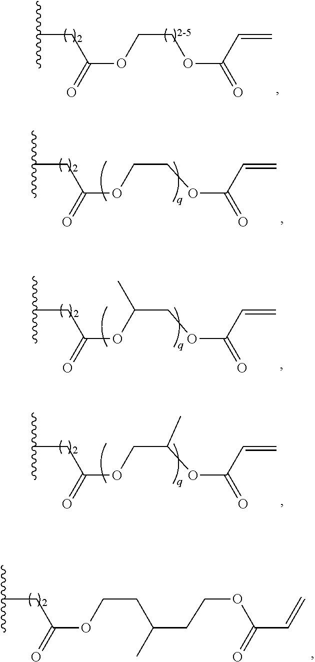
wherein q is an integer from 1 to 6, 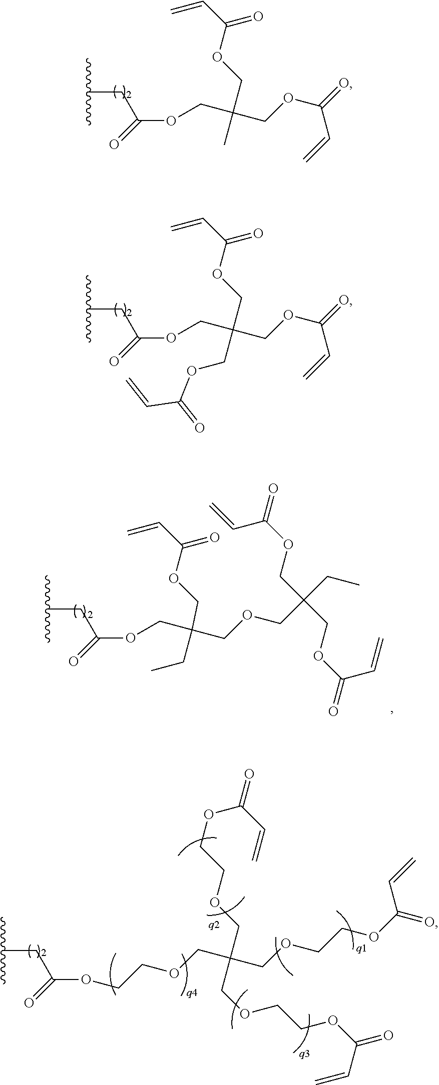 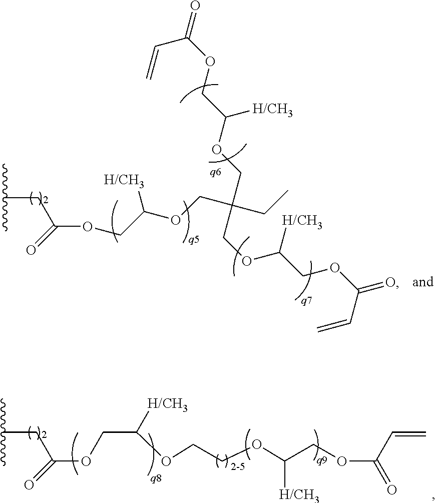
wherein
each of q1 to q4 are integers independently from 0 to 8 and the sum of (q1+q2+q3+q4) is from 4 to 8,
each of q5 to q7 are integers independently from 0 to 8 and the sum of (q5+q6+q7) is from 3 to 12, and
each of q8 and q9 are integers independently from 0 to 4 and the sum of (q8+q9) is from 2 to 4; and
R^{10d} is selected from the group consisting of 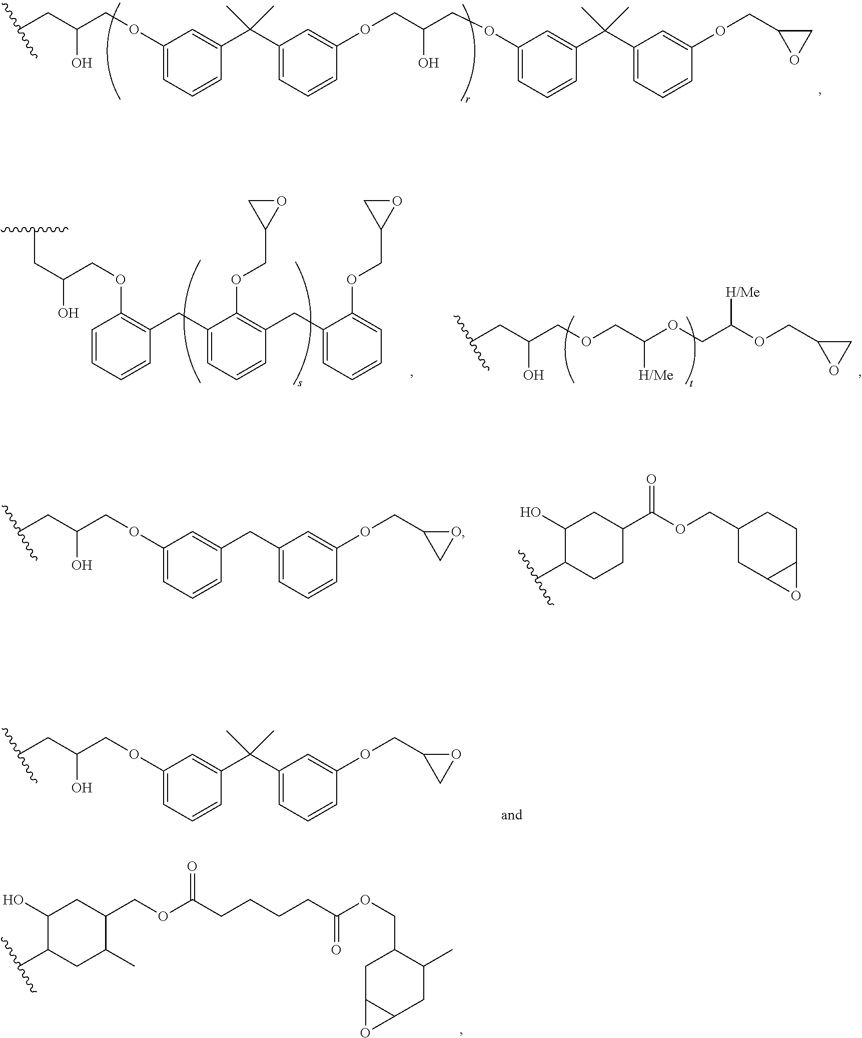
wherein r is an integer from 1 to 20, s is an integer from 1 to 8 and t is an integer from 1 to 10;
R¹¹ is selected from R⁸ and R^{12c}, and for Y², R¹¹ is further selected from 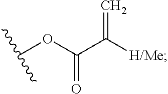
and
R^{12c} is selected from the group consisting of
amino acids, oligopeptides up to a molecular weight of 1000 g/mol, or polypeptides up to a molecular weight of 1000 g/mol; and
C₁₂₋₂₄ fatty acids.

23. The polymeric liquid polysiloxane material according to claim 18, wherein the material comprises at least one of
at least two non-identically R⁵-substituted mono-organofunctional T-type alkoxy-terminated siloxane populations, each population making up at least 3 mol-% of all mono-organofunctional T-type moieties in the material;
chiral mono-organofunctional T¹-type moieties in an amount of at least 3 mol-% relative to all mono-organofunctional T-type moieties in the material; or
a combination thereof.

24. The polymeric liquid polysiloxane material according to claim 18, wherein at least one of
the degree of polymerization of the Q-type alkoxy-terminated moieties DP_{Q-type} is in the range of 1.6 to 2.4 and the atomic ratio of T-species to Q-species in the material is in the range of 0.02:1 to 0.4:1;
if the material comprises about or more than 5 mol-% M-type moieties, the degree of polymerization of the Q-type alkoxy-terminated moieties DP_{Q-type} is in the range of 1.7 to 2.5 and the atomic ratio of T-species to Q-species in the material is in the range of 0.02:1 to 0.4:1;
the degree of polymerization of the T-type alkoxy-terminated siloxane moieties DP_{T-type} is in the range of 1.3 to 2.2; and a combination thereof; or
a combination thereof.

25. The polymeric liquid polysiloxane material according to claim 17, wherein at least one of:
L^{Q} is selected from the group consisting of 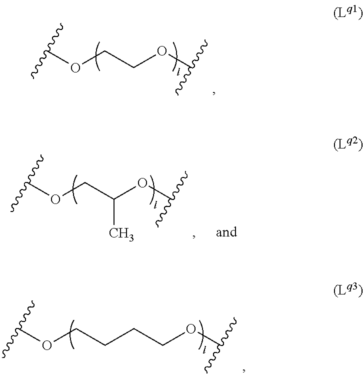
wherein I is an integer from 4 to 600;
R^{Q1′} is selected from the group consisting of low molecular linear or branched polyol, low molecular linear or branched polyether polyol, low molecular linear or branched polyester polyol, low molecular linear or branched acrylic polyol, low molecular linear or branched polycarbonate polyol, and low molecular linear or branched natural oil based polyol;
MC is selected from the group consisting of Li, Na, K, Rb, Cs, Be, Mg, Ca, Sr, and Ba; or
a combination thereof.

26. The polymeric liquid polysiloxane material according to claim 17, wherein at least one of:
the polysiloxane material comprises less than 45 mol-% four-membered combined Q^{2r}-type and Q^{3s,d}-type siloxane ring species relative to the total Q-type siloxane species;
the polysiloxane material comprises less than 70 mol-% four-membered combined Q^{3s,3d}-type siloxane ring species relative to all Q³-type siloxane species;
the polysiloxane material comprises less than 4.5 mol-% double four-membered Q^{3d}-type siloxane ring species relative to the total Q-type siloxane species;
the polysiloxane material comprises less than 25 mol-% double four-membered Q^{3d}-type siloxane ring species relative to all Q³-type siloxane species; or
a combination thereof.

27. The polymeric liquid polysiloxane material according to claim 18, wherein at least one of:
R^{5N} is selected from the group consisting of linear or branched hexyl, linear or branched octyl, 2,4,4-trimethylpentyl, linear or branched dodecyl, linear or branched hexadecyl, (3,3,3-trifluoro)propyl, (1H,1H, 2H, 2H-perfluoro)octyl, cyclohexyl, cyclopentadienyl, cyclopentyl, (1H,1H, 2H, 2H-perfluoro)dodecyl, and (1H,1H, 2H, 2H-perfluoro)hexadecyl;
R⁶ is selected from the group consisting of —(CH₂)₅CH₃, —(CH₂)₆CH₃, —(CH₂)₇CH₃, —(CH₂)₈CH₃, —(CH₂)₉CH₃, —(CH₂)₁₁CH₃, and —(CH₂)₁₃CH₃;
R^{12b} is selected from the group consisting of substituted or unsubstituted poly(ethylene oxide), substituted or unsubstituted poly(propylene oxide) polytetrahydrofuran, substituted or unsubstituted poly D-glucose, substituted or unsubstituted oligo-D-glucose, substituted or unsubstituted chitosan, substituted or unsubstituted deacetylated oligo-chitin, substituted or unsubstituted oligo-beta-D-galactopyranuronic acid, substituted or unsubstituted poly alginic acid, substituted or unsubstituted oligo-alginic acid, substituted or unsubstituted poly amylose, substituted or unsubstituted oligo amylose, substituted or unsubstituted poly-galactose, and substituted or unsubstituted oligo-galactose, each with a molecular weight up to 5000 g/mol;
R^{12c} is selected from the group consisting of oligopeptides and polypeptides, each made of naturally occurring amino acids up to a molecular weight of 5000 g/mol, naturally occurring unsaturated fatty acids, C₁₂₋₂₄ naturally occurring unsaturated fatty acids with 1 to 3 double bonds, epoxidized fatty acids, epoxidized castor oil, soybean oil, sunflower oil, ring opened epoxidized fatty acid based polyols, natural oil based polyols (NOPs), castor oil, soybean oil, and sunflower oil triglycerides;
R^{12c} is selected from the group consisting of oligopeptides and polypeptides, each made of naturally occurring amino acids up to a molecular weight of 2000 g/mol or up to a molecular weight of 1000 g/mol; or
a combination thereof.

28. The polymeric liquid polysiloxane material according to claim 18, wherein at least one of:
when (i) the sum of all Z³ and Y³, (ii) the sum of all -L-Z² and -L′-Y², or (iii) a combination thereof, amounts to at least 50 mol-% of all R⁵ residues of the T-type siloxane moieties in the polysiloxane material, and the material further comprises R⁵ residues being -L-Z¹, the sum of R⁵ residues being -L′-Y¹ and -L-Z¹ being less than 20 mol-%, the degree of polymerization of the Q-type alkoxy-terminated moieties DP_{Q-type} is in the range of 1.85 to 2.2, and the atomic ratio of T-species to Q-species in the material is in the range of 0.02:1 to 0.3:1;
when the sum of all -L-Z¹, -L′-Y¹, and R^{5N} amounts to at least 90 mol-% of all R⁵ residues of the T-type siloxane moieties in the polysiloxane material, at least 30 mol-% of the R⁵ residues of the material being -L-Z¹, -L′-Y¹, or a combination thereof, and at least 10 mol-% of the R⁵ residues of the material being R^{5N}, the degree of polymerization of the Q-type alkoxy-terminated moieties DP_{Q-type} is in the range of 1.8 to 2.4, and the atomic ratio of T- to Q-species in the material is in the range of 0.05:1 to 0.4:1;
when the sum of all R^{5N}, Z³, Y³, -L′-Y², and -L-Z² amounts to at least 90 mol-% of all R⁵ residues of the T-type siloxane moieties in the polysiloxane material, the sum of all Z³, Y³, -L′-Y², and -L-Z² amounts to at least 20 mol-% of the R⁵ residues of the material, the degree of polymerization of the Q-type alkoxy-terminated moieties DP_{Q-type} is in the range of 1.7 to 2.25, and the atomic ratio of T-species to Q-species in the material is in the range of 0.05:1 to 0.25:1;
when the sum of all R^{5N}, Z³, Y³, -L′-Y², and -L-Z² amounts to at least 90 mol-% of all R⁵ residues of the T-type siloxane moieties in the polysiloxane material, the sum of all Z³, Y³, -L′-Y², and -L-Z² amounts to at least 20 mol-% of the R⁵ residues of the material, at least 20 mol-% of the R⁵ residues of the material being R^{5N}, the degree of polymerization of the Q-type alkoxy-terminated moieties DP_{Q}-t_{yp}e is in the range of 1.7 to 2.25, and the atomic ratio of T-species to Q-species in the material is in the range of 0.05:1 to 0.25:1; or
a combination thereof.

29. A hydrolysate or emulsion precursor comprising at least one polymeric liquid material according to claim 1.

30. A hydrolysate or emulsion precursor according to claim 29, further comprising at least one of an acid, a base, a buffer an oil, a co-emulsifier, or a combination thereof.

31. A hydrolysis or emulsion product produced by reacting the at least one polymeric liquid material of claim 29 with a predetermined amount of water or with a predetermined amount of a water-solvent mixture.

32. A glass fiber sizing formulation comprising
the polymeric liquid polysiloxane material according to claim 18, and
at least one of a silane hydrolysate, a lubricant, a polymer resin, a biopolymer, a film former, an emulsifier, or a combination thereof.

33. The glass fiber sizing formulation according to claim 32, wherein the polymeric liquid polysiloxane material is in the form of a hydrolysate or emulsion precursor comprising at least one polymeric liquid material or in the form of a hydrolysis or emulsion obtainable by reacting the at least one polymeric liquid material of claim 30 with a predetermined amount of water or with a predetermined amount of a water-solvent mixture.

34. The glass fiber sizing formulation according to claim 32, wherein the material comprises at least one of:
T-type siloxane moieties, with R⁵ being R^{5U}, ^{R5N}, or a combination thereof;
T-type siloxane moieties, with R⁵ being R^{5U}, R^{5N}, or a combination thereof, wherein at least 10 mol %, or at least an amount between 10 to 75 mol-%, of all R⁵ in the material are R^{5U}, R^{5N}, or a combination thereof;
T-type siloxane moieties, with R⁵ being R^{5U}, R^{5N}, or a combination thereof, wherein at least 10 mol %, or at least an amount between 10 to 75 mol-%, of all R⁵ in the material are R^{5U}, R^{5N}, or a combination thereof, and, wherein the material comprises Q-type siloxane moieties, T-type siloxane moieties, or a combination thereof, with R¹ being R^{1′}; or T-siloxane moieties with R⁵ being R^{5U}, R^{5N}, or a combination thereof, wherein at least 10 mol %, or at least an amount between 10 to 75 mol-%, of all R⁵ in the material are R^{5U}, R^{5N}, or a combination thereof, and, wherein the material comprises Q-type siloxane moieties, T-type siloxane moieties, or a combination thereof, with R¹ being R^{1′}, wherein at least 0.1 mol %, or at least an amount between 0.1 to 3.0 mol-%, of all R¹ of the material are R^{1′}.

35. A 2K curable epoxy resin formulation comprising at least one resin, one hardener and at least one polymeric liquid polysiloxanes material of claim 18, as defined in (I.), (II.), (IV.) and (V.) below,
wherein the hardener is selected from:
(I.) the polymeric liquid polysiloxane material,
(II.) the polymeric liquid polysiloxane material, wherein at least 1 mol-% of all R⁵ of the material are R^{5S} with R^{5S}=L′-Y¹; and
(III.) an amine hardener, a mercapto hardener, an amide hardener, and amidoamine hardener, a carboxylic hardener, or an anhydride hardener.
wherein the resin comprises:
(IV.) the polymeric liquid polysiloxane material, wherein at least 1 mol-% of all R⁵ of the material are R^{5U} being 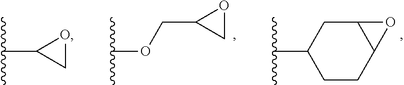
or a combination thereof,
(V.) the polymeric liquid polysiloxane material, wherein at least 50 or 80 mol-% of all R⁵ of the material are R^{5S} being L′-Y¹, wherein Y¹ comprises R^{10d} functionalization, wherein R^{10d} is bonded through a nitrogen or a sulfur atom to Y, or
(VI.) an epoxy resin.

36. The 2K curable epoxy resin formulation according to claim 35, wherein at least one of:
at least 1 mol-% of all R⁵ of the material are R^{5U} with R^{5U}=L-Z¹;
Y¹ is functionalized by R^{10a};
at least 30 mol-% R^{10d} functionalization;
the formulation further comprises a catalyst, a filler, or a combination thereof; or
a combination thereof.

37. A humidity curing formulation comprising
the polymeric liquid polysiloxane material according to claim 17.

38. A humidity curing formulation comprising the polymeric liquid polysiloxane material according to claim 18, wherein at least one of:
the polymeric liquid polysiloxane material comprises Q-type siloxane moieties, T-type siloxane moieties, or a combination thereof, with R¹ being R^{1′};
the polymeric liquid polysiloxane material comprises Q-type siloxane moieties, T-type siloxane moieties, or a combination thereof, with R¹ being R^{1′}, wherein at least 0.1 mol %, or at least an amount between 0.1 to 3.0 mol-%, of all R¹ of the material are R^{1′};
the humidity curing formulation further comprises at least one of an aminosilane curing catalyst, an organometallic curing catalyst, an amine-based curing catalyst, a water scavenger, a plasticizer or softener, a filler, a stabilizer, a silane terminated polymer (STP) resin, or a combination thereof; or
a combination thereof.

39. A binder, adhesive, sealant, elastomer, or coating comprising the polymeric liquid polysiloxane material according to claim 17.

40. A binder, adhesive, sealant, elastomer, or coating comprising the polymeric liquid polysiloxane material according to claim 17, and at least one type of R^{5N}-functionality, R^{5U}-functionality, R^{5S}-functionality, R^{1′}-functionality, or a combination thereof.

41. A cosmetics, personal care, or (protective) coating formulation comprising the polymeric liquid polysiloxane material according to claim 17.

42. A cosmetics, personal care, or (protective) coating formulation comprising the polymeric liquid polysiloxane material according to claim 18, and at least one type of R^{5N}-functionality, R^{5U}-functionality, R^{5S}-functionality, R^{1′}-functionality, or a combination thereof, wherein at least one of:
the polymeric liquid polysiloxane material is in the form of a hydrolysis or emulsion product produced by reacting the at least one polymeric liquid material with a predetermined amount of water or with a predetermined amount of a water-solvent mixture;
the cosmetics, personal care, or (protective) coating formulation comprises the polymeric liquid polysiloxane material in the form of a hydrolysis or emulsion product produced by reacting the at least one polymeric liquid material with a predetermined amount of water or with a predetermined amount of a water-solvent mixture, wherein the material comprises T-type siloxane moieties with R⁵ being R^{5U} and/or ^{R5N}; or
the cosmetics, personal care, or (protective) coating formulation comprises the polymeric liquid polysiloxane material in the form of a hydrolysis or emulsion product produced by reacting the at least one polymeric liquid material with a predetermined amount of water or with a predetermined amount of a water-solvent mixture, wherein the material comprises T-type siloxane moieties with R⁵ being R^{5U} and/or ^{R5N} and wherein the material comprises Q-type siloxane moieties, T-type siloxane moieties, or a combination thereof, with R¹ being R^{1′}.

43. A silicone elastomer formulation comprising
the polymeric liquid polysiloxane material according to claim 17, and
a silicone OH fluid, a silicone vinyl fluid a silicone hydrido fluid, or a combination thereof.

44. A silicone elastomer formulation comprising the polymeric liquid polysiloxane material according to claim 18, and a silicone OH fluid, a silicone vinyl fluid a silicone hydrido fluid, or a combination thereof, wherein at least one of:
the material comprises T-type siloxane moieties with R⁵ being R^{5U}, R^{5N}, or a combination thereof;
the material comprises T-type siloxane moieties with R⁵ being R^{5U}, R^{5N}, or a combination thereof, wherein at least 10 mol %, or an amount between 10 to 75 mol-%, of all R⁵ in the material are R^{5U}, R^{5N}, or a combination thereof;
the material comprises T-type siloxane moieties with R⁵ being R^{5U}, R^{5N}, or a combination thereof, wherein at least 10 mol %, or an amount between 10 to 75 mol-%, of all R⁵ in the material are R^{5U}, R^{5N}, or a combination thereof, and, wherein the material comprises Q-type siloxane moieties, T-type siloxane moieties, or a combination thereof, with R¹ being R^{1′};
the material comprises T-type siloxane moieties with R⁵ being R^{5U}, R^{5N}, or a combination thereof, wherein at least 10 mol %, or an amount between 10 to 75 mol-%, of all R⁵ in the material are R^{5U}, R^{5N}, or a combination thereof, and, wherein the material comprises Q-type siloxane moieties, T-type siloxane moieties, or a combination thereof, with R¹ being R^{1′}, wherein at least 0.1 mol %, or at least an amount between 0.1 to 3.0 mol-%, of all R¹ of the material are R^{1′}; or
a combination thereof.
